(19) United States
(12) Patent Application Publication
(10) Pub. No.: US 2017/0215201 A1
(43) Pub. Date: Jul. 27, 2017

(54) METHOD AND APPARATUS FOR TRANSMITTING UPLINK DATA IN WIRELESS COMMUNICATION SYSTEM

(71) Applicant: LG ELECTRONICS INC., Seoul (KR)

(72) Inventors: Kitae KIM, Seoul (KR); Eunjong LEE, Seoul (KR); Giwon PARK, Seoul (KR); Jaehoon CHUNG, Seoul (KR); Jiwon KANG, Seoul (KR); Hyeyoung CHOI, Seoul (KR)

(73) Assignee: LG ELECTRONICS INC., Seoul (JP)

(21) Appl. No.: 15/328,840

(22) PCT Filed: Mar. 10, 2015
(86) PCT No.: PCT/KR2015/002277

§ 371 Date: Jan. 24, 2017

Related U.S. Application Data
(60) Provisional application No. 62/028,323, filed on Jul. 24, 2014.

(51) Int. Cl. H04W 72/12; H04W 72/14; H04L 1/18; H04L 5/00

(52) U.S. Cl. CPC H04W 72/1268; H04L 5/0051; H04W 72/14; H04L 5/0055; H04L 1/1812

(57) ABSTRACT

Disclosed herein are a method and apparatus for transmitting uplink data in a wireless communication system. More specifically, a method of transmitting uplink data in a wireless communication system may include mapping, by user equipment (UE), uplink data to a Segmented Physical Resource Block (SPRB), mapping, by the UE, a Demodulation Reference Signal (DMRS) related to the SPRB to a Physical Resource Block (PRB) to which the SPRB belongs, and transmitting, by the UE, the uplink data and the DMRS to a eNB. The SPRB may be defined as a set of resource elements segmented from a pair of the PRBs in a time domain, and the DMRS may be generated using a cyclic shift value predetermined corresponding to the SPRB.

### TECHNICAL FIELD

The present invention relates to a wireless communication system and, more particularly, to a method for sending, by user equipment, uplink data to a eNB and an apparatus for supporting the same.

### BACKGROUND ART

Mobile communication systems have been developed to provide voice services, while guaranteeing user activity. Service coverage of mobile communication systems, however, has extended even to data services, as well as voice services, and currently, an explosive increase in traffic has resulted in shortage of resource and user demand for a high speed services, requiring advanced mobile communication systems. The requirements of the next-generation mobile communication system may include supporting huge data traffic, a remarkable increase in the transfer rate of each user, the accommodation of a significantly increased number of connection devices, very low end-to-end latency, and high energy efficiency. To this end, various techniques, such as small cell enhancement, dual connectivity, massive Multiple Input Multiple Output (MIMO), in-band full duplex, non-orthogonal multiple access (NOMA), supporting super-wide band, and device networking, have been researched.

### DISCLOSURE

### [Technical Problem]

In mobile communication systems, in order to maximize resource utilization, a method of transmitting and receiving data through a resource allocation procedure based on base station scheduling. However, this causes to increase latency in uplink data transmission of a user equipment.

An object of the present invention is to propose a method for defining contention-based segmented radio resources in order to minimize the latency of UE in a wireless communication system.

Another object of the present invention is to propose a method for sending a demodulation reference signal for UL data transmitted through contention-based segmented radio resources by UE.

Yet another object of the present invention is to propose method for sending the acknowledge/non-acknowledge of UL data transmitted through contention-based segmented radio resources.

The technical problems solved by the present invention are not limited to the above technical problems and those skilled in the art may understand other technical problems from the following description.

### [Technical Solution]

In an aspect of the present invention, a method of transmitting uplink data in a wireless communication system may include mapping, by user equipment (UE), uplink data to a Segmented Physical Resource Block (SPRB), mapping, by the UE, a Demodulation Reference Signal (DMRS) related to the SPRB to a Physical Resource Block (PRB) to which the SPRB belongs, and transmitting, by the UE, the uplink data and the DMRS to a eNB. The SPRB may be defined as a set of resource elements segmented from a pair of the PRBs in a time domain, and the DMRS may be generated using a cyclic shift value predetermined corresponding the SPRB.

In another aspect of the present invention, user equipment requesting scheduling for transmitting uplink data in a wireless communication system may include a Radio Frequency (RF) unit for transmitting and receiving radio signals and a processor. The processor may be configured to map uplink data to a Segmented Physical Resource Block (SPRB), map a Demodulation Reference Signal (DMRS) related to the SPRB to a Physical Resource Block (PRB) to which the SPRB belongs, and transmit the uplink data and the DMRS to a base station. The SPRB may be defined as a set of resource elements segmented from a pair of the PRBs in a time domain. The DMRS sequence may be generated using a cyclic shift value predetermined corresponding the SPRB.

The PRB may include a Contention-based Physical Resource Block (CPRB) in which the UE is able to transmit the uplink data without the uplink grant of the eNB.

The DMRS may be multiplexed in a symbol identical with the symbol of a DMRS related to another SPRB belonging to the pair of PRBs.

The cyclic shift value may be set identically with the index of the SPRB.

The cyclic shift value may be set according to a predetermined pattern.

A DMRS field value of the DMRS may be set identically with the index of the SPRB, and the cyclic shift value may be determined based on the DMRS field value.

A DMRS field value of the DMRS may be set according to a predetermined pattern, and the cyclic shift value may be determined based on the DMRS field value.

The method may further include receiving, by the UE, acknowledge (ACK) or non-acknowledge (NACK) information about the uplink data from the eNB through a physical HARQ indicator channel (PHICH).

The DMRS field value of the DMRS may be set identically with the index of the SPRB, and the PHICH resource may be determined based on the DMRS field value.

The DMRS field value of the DMRS may be set according to a predetermined pattern, and the cyclic shift value may be determined based on the DMRS field value.

### [Advantageous Effects]

In accordance with an embodiment of the present invention, latency attributable to the transmission of UL data can be minimized because the UL data is transmitted through contention-based segmented radio resources.

Furthermore, in accordance with an embodiment of the present invention, the demodulation of UL data can be smoothly performed because the orthogonality of a demodulation reference signal for UL data transmitted through contention-based segmented radio resources is maintained.

Furthermore, in accordance with an embodiment of the present invention, a collision between radio resources for sending the acknowledge/non-acknowledge of UL data transmitted through contention-based segmented radio resources can be prevented.

The effects of the present invention are not limited to the above-described effects and other effects which are not described herein will become apparent to those skilled in the art from the following description.

### DESCRIPTION OF DRAWINGS

The accompanying drawings, which are included to provide a further understanding of the invention and are incorporated in and constitute a part of this application, illustrate embodiment(s) of the invention and together with the description serve to explain the principle of the invention.

FIG. 1 illustrates a schematic structure a network structure of an evolved universal mobile telecommunication system (E-UMTS) to which the present invention can be applied.

FIG. 2 illustrates the configurations of a control plane and a user plane of a radio interface protocol between the E-UTRAN and a UE in the wireless communication system to which the present invention can be applied.

FIG. 3 illustrates physical channels and a view showing physical channels used for in the 3GPP LTE/LTE-A system to which the present invention can be applied.

FIG. 4 is a diagram showing the structure of a radio frame used in a 3GPP LTE system to which the present invention can be applied.

FIG. 5 shows an example of a resource grid for one downlink slot in the wireless communication system to which the present invention can be applied.

FIG. 6 shows a structure of a downlink subframe in the wireless communication system to which the present invention can be applied.

FIG. 7 shows a structure of an uplink subframe in the wireless communication system to which the present invention can be applied.

FIG. 8 illustrates a structure of DCI format 0 in the wireless communication system to which the present invention can be applied.

FIG. 9 illustrates an example of a formation that PUCCH formats are mapped to the PUCCH regions of the UL physical resource blocks in the wireless communication system to which the present application can be applied.

FIG. 10 shows a structure of CQI channel in case of a normal CP in the wireless communication system to which the present invention can be applied.

FIG. 11 shows a structure of ACK/NACK in case of a normal CP in the wireless communication system to which the present invention can be applied.

FIG. 12 illustrates a method for multiplexing the ACK/NACK and the SR in the wireless communication system to which the present invention can be applied.

FIG. 13 is another diagram illustrating the structure of an uplink subframe in a wireless communication system to which an embodiment of the present invention may be applied.

FIG. 14 is a diagram illustrating a MAC PDU used in a MAC entity in a wireless communication system to which an embodiment of the present invention may be applied.

FIGS. 15 and 16 illustrate the sub-headers of MAC PDUs in a wireless communication system to which an embodiment of the present invention may be applied.

FIG. 17 is a diagram illustrating the format of an MAC control element for a buffer status report in a wireless communication system to which an embodiment of the present invention may be applied.

FIG. 18 illustrates the configuration of a MIMO communication system in a wireless communication system to which an embodiment of the present invention may be applied.

FIG. 19 is a diagram illustrating channels from a plurality of transmission antennas to a single reception antenna in a wireless communication system to which an embodiment of the present invention may be applied.

FIG. 20 illustrates an example of the merge of component carriers and carriers in a wireless communication system to which an embodiment of the present invention may be applied.

FIG. 21 is a diagram illustrating a process of assigning uplink resources to UE in a wireless communication system to which an embodiment of the present invention may be applied.

FIG. 22 is a diagram illustrating latency in a C plane required in 3GPP LTE-A to which an embodiment of the present invention may be applied.

FIG. 23 is a diagram illustrating the time when synchronized UE required in 3GPP LTE-A to which an embodiment of the present invention may be applied shifts a dormant state to an active state.

FIG. 24 is a diagram illustrating an example in which contention-based radio resources are configured in accordance with an embodiment of the present invention.

FIG. 25 is a diagram illustrating a method for sending UL data in accordance with an embodiment of the present invention.

FIGS. 26 to 33 are diagrams illustrating SPRBs in accordance with embodiments of the present invention.

FIG. 34 is a diagram illustrating a method for sending UL data in accordance with an embodiment of the present invention.

FIG. 35 is a block diagram illustrating the configuration of a wireless communication apparatus in accordance with an embodiment of the present invention.

### MODE FOR INVENTION

Reference will now be made in detail to the preferred embodiments of the present invention, examples of which are illustrated in the accompanying drawings. The detailed description set forth below in connection with the appended drawings is a description of exemplary embodiments and is not intended to represent the only embodiments through which the concepts explained in these embodiments can be practiced. The detailed description includes details for the purpose of providing an understanding of the present invention. However, it will be apparent to those skilled in the art that these teachings may be implemented and practiced without these specific details.

In some instances, known structures and devices are omitted, or are shown in block diagram form focusing on important features of the structures and devices, so as not to obscure the concept of the present invention.

In the embodiments of the present invention, the enhanced Node B (eNode B or eNB) may be a terminal node of a network, which directly communicates with the terminal. In some cases, a specific operation described as performed by the eNB may be performed by an upper node of the eNB. Namely, it is apparent that, in a network comprised of a plurality of network nodes including an eNB, various operations performed for communication with a terminal may be performed by the eNB, or network nodes other than the eNB. The term ‘eNB’ may be replaced with the term ‘fixed station’, ‘base station (BS)’, ‘Node B’, ‘base transceiver system (BTS),’, ‘access point (AP)’, etc. The term ‘user equipment (UE)’ may be replaced with the term ‘terminal’, ‘mobile station (MS)’, ‘user terminal (UT)’, ‘mobile subscriber station (MSS)’, ‘subscriber station (SS)’, ‘Advanced Mobile Station (AMS)’, ‘Wireless terminal (WT)’, ‘Machine-Type Communication (MTC) device’, ‘Machine-to-Machine (M2M) device’, ‘Device-to-Device(D2D) device’, wireless device, etc. In the embodiments of the present invention, “downlink (DL)” refers to communication from the eNB to the UE, and “uplink (UL)” refers to communication from the UE to the eNB. In the downlink, transmitter may be a part of eNB, and receiver may be part of UE. In the uplink, transmitter may be a part of UE, and receiver may be part of eNB.

Specific terms used for the embodiments of the present invention are provided to aid in understanding of the present invention. These specific terms may be replaced with other terms within the scope and spirit of the present invention.

The embodiments of the present invention can be supported by standard documents disclosed for at least one of wireless access systems, Institute of Electrical and Electronics Engineers (IEEE) 802, 3rd Generation Partnership Project (3GPP), 3GPP Long Term Evolution (3GPP LTE), LTE-Advanced (LTE-A), and 3GPP2. Steps or parts that are not described to clarify the technical features of the present invention can be supported by those documents. Further, all terms as set forth herein can be explained by the standard documents.

Techniques described herein can be used in various wireless access systems such as Code Division Multiple Access (CDMA), Frequency Division Multiple Access (FDMA), Time Division Multiple Access (TDMA), Orthogonal Frequency Division Multiple Access (OFDMA), Single Carrier-Frequency Division Multiple Access (SC-FDMA), ‘non-orthogonal multiple access (NOMA)’, etc. CDMA may be implemented as a radio technology such as Universal Terrestrial Radio Access (UTRA) or CDMA2000. TDMA may be implemented as a radio technology such as Global System for Mobile communications (GSM)/General Packet Radio Service (GPRS)/Enhanced Data Rates for GSM Evolution (EDGE). OFDMA may be implemented as a radio technology such as IEEE 802.11 (Wi-Fi), IEEE 802.16 (WiMAX), IEEE 802.20, Evolved-UTRA (E-UTRA) etc. UTRA is a part of Universal Mobile Telecommunication System (UMTS). 3GPP LTE is a part of Evolved UMTS (E-UMTS) using E-UTRA. 3GPP LTE employs OFDMA for downlink and SC-FDMA for uplink. LTE-A is an evolution of 3GPP LTE. For clarity, this application focuses on the 3GPP LTE/LTE-A system. However, the technical features of the present invention are not limited thereto.

### General System to Which the Present Invention may be Applied

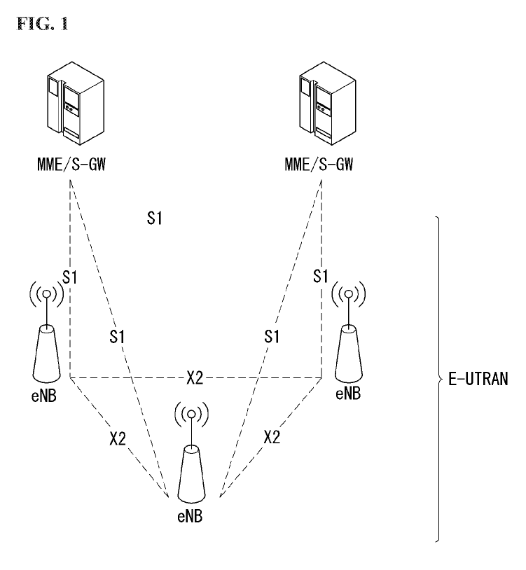

FIG. 1 illustrates a schematic structure a network structure of an evolved universal mobile telecommunication system (E-UMTS) to which the present invention can be applied.

An E-UMTS system is an evolved version of the UMTS system. For example, the E-UMTS may be also referred to as an LTE/LTE-A system. The E-UMTS is also referred to as a Long Term Evolution (LTE) system.

The E-UTRAN consists of eNBs, providing the E-UTRA user plane and control plane protocol terminations towards the UE. The eNBs are interconnected with each other by means of the X2 interface. The X2 user plane interface (X2-U) is defined between eNBs. The X2-U interface provides non guaranteed delivery of user plane packet data units (PDUs). The X2 control plane interface (X2-CP) is defined between two neighbour eNBs. The X2-CP performs following functions: context transfer between eNBs, control of user plane tunnels between source eNB and target eNB, transfer of handover related messages, uplink load management and the like. Each eNB is connected to User Equipments (UEs) through a radio interface and is connected to an Evolved Packet Core (EPC) through an S1 interface. The S1 user plane interface (S1-U) is defined between the eNB and the serving gateway (S-GW). The S1-U interface provides non guaranteed delivery of user plane PDUs between the eNB and the S-GW. The S1 control plane interface (S1-MME) is defined between the eNB and the MME (Mobility Management Entity). The S1 interface performs following functions: EPS (Enhanced Packet System) Bearer Service Management function, NAS (Non-Access Stratum) Signaling Transport function, Network Sharing Function, MME Load balancing Function and the like. The S1 interface supports a many-to-many relation between MMEs/S-GWs and eNBs.

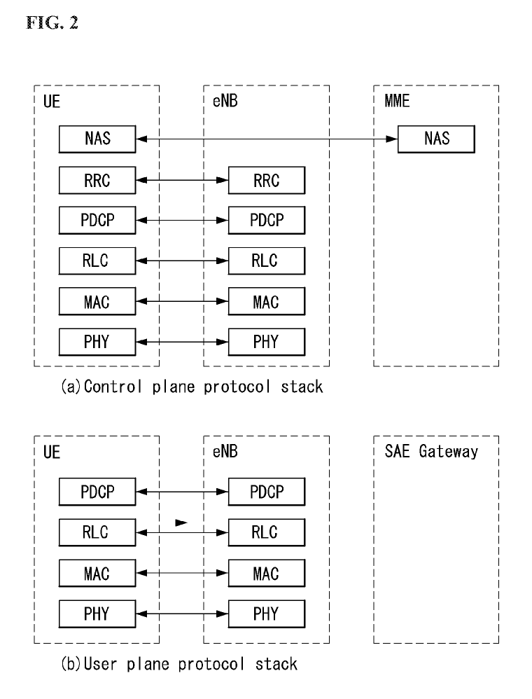

FIG. 2 illustrates the configurations of a control plane and a user plane of a radio interface protocol between the E-UTRAN and a UE in the wireless communication system to which the present invention can be applied.

FIG. 2(a) shows the respective layers of the radio protocol control plane, and FIG. 2(b) shows the respective layers of the radio protocol user plane.

Referring to the FIG. 2, the protocol layers of a radio interface protocol between the E-UTRAN and a UE can be divided into an L1 layer (first layer), an L2 layer (second layer), and an L3 layer (third layer) based on the lower three layers of the Open System Interconnection (OSI) reference model widely known in communication systems. The radio interface protocol is divided horizontally into a physical layer, a data link layer, and a network layer, and vertically into a user plane for data transmission and a control plane for signaling.

The control plane is a passage through which control messages that a UE and a network use in order to manage calls are transmitted. The user plane is a passage through which data (e.g., voice data or Internet packet data) generated at an application layer is transmitted. The following is a detailed description of the layers of the control and user planes in a radio interface protocol.

The control plane is a passage through which control messages that a UE and a network use in order to manage calls are transmitted. The user plane is a passage through which data (e.g., voice data or Internet packet data) generated at an application layer is transmitted. The following is a detailed description of the layers of the control and user planes in a radio interface protocol.

The MAC layer of the second layer provides a service to a Radio Link Control (RLC) layer, located above the MAC layer, through a logical channel. The MAC layer plays a role in mapping various logical channels to various transport channels. And, the MAC layer also plays a role as logical channel multiplexing in mapping several logical channels to one transport channel.

The RLC layer of the second layer supports reliable data transmission. The RLC layer performs segmentation and concatenation on data received from an upper layer to play a role in adjusting a size of the data to be suitable for a lower layer to transfer the data to a radio section. And, the RLC layer provides three kinds of RLC modes including a transparent mode (TM), an unacknowledged mode (UM) and an acknowledged mode (AM) to secure various kinds of QoS demanded by each radio bearer (RB). In particular, the AM RLC performs a retransmission function through automatic repeat and request (ARQ) for the reliable data transfer. The functions of the RLC layer may also be implemented through internal functional blocks of the MAC layer. In this case, the RLC layer need not be present.

A packet data convergence protocol (PDCP) layer of the second layer performs a header compression function for reducing a size of an IP packet header containing relatively large and unnecessary control information to efficiently transmit such an IP packet as IPv4 and IPv6 in a radio section having a small bandwidth. This enables a header part of data to carry mandatory information only to play a role in increasing transmission efficiency of the radio section. Moreover, in the LTE/LTE-A system, the PDCP layer performs a security function as well. This consists of ciphering for preventing data interception conducted by a third party and integrity protection for preventing data manipulation conducted by a third party.

A Radio Resource Control (RRC) layer located at the bottom of the third layer is defined only in the control plane and is responsible for control of logical, transport, and physical channels in association with configuration, re-configuration, and release of Radio Bearers (RBs). The RB is a logical path that the second layer provides for data communication between the UE and the E-UTRAN. To accomplish this, the RRC layer of the UE and the RRC layer of the network exchange RRC messages. To Configure of Radio Bearers means that the radio protocol layer and the characteristic of channels are defined for certain service and that each of specific parameters and operating method are configured for certain service. The radio bearer can be divided signaling radio bearer (SRB) and data radio bearer (DRB). The SRB is used as a path for transmission RRC messages in the control plane, and the DRB is used as a path for transmission user data in the user plane. A Non-Access Stratum (NAS) layer located above the RRC layer performs functions such as session management and mobility management.

One cell of the eNB is set to use a bandwidth such as 1.25, 2.5, 5, 10 or 20 MHz to provide a downlink or uplink transmission service to UEs. Here, different cells may be set to use different bandwidths.

Downlink transport channels for transmission of data from the network to the UE include a Broadcast Channel (BCH) for transmission of system information, a Paging Channel (PCH) for transmission of paging messages, and a downlink Shared Channel (DL-SCH) for transmission of user traffic or control messages. User traffic or control messages of a downlink multicast or broadcast service may be transmitted through DL-SCH and may also be transmitted through a downlink multicast channel (MCH). Uplink transport channels for transmission of data from the UE to the network include a Random Access Channel (RACH) for transmission of initial control messages and an uplink SCH (UL-SCH) for transmission of user traffic or control messages.

Logical channels, which are located above the transport channels and are mapped to the transport channels, include a Broadcast Control Channel (BCCH), a Paging Control Channel (PCCH), a Common Control Channel (CCCH), a dedicated control channel (DCCH), a Multicast Control Channel (MCCH), a dedicated traffic channel (DTCH), and a Multicast Traffic Channel (MTCH).

As an downlink physical channel for transmitting information forwarded on an downlink transport channel to a radio section between a network and a user equipment, there is a physical downlink shared channel (PDSCH) for transmitting information of DL-SCH, a physical control format indicator channel (PDFICH) for indicating the number of OFDM symbols used for transmitting a physical downlink control channel (PDCCH), a physical HARQ (hybrid automatic repeat request) indicator channel (PHICH) for transmitting HARQ ACK (Acknowledge)/NACK (Non-acknowledge) as response to UL transmission or a PDCCH for transmitting such control information, as DL grant indicating resource allocation for transmitting a Paging Channel (PCH) and DL-SCH, information related to HARQ, UL grant indicating resource allocation for transmitting a UL-SCH and like that. As an uplink physical channel for transmitting information forwarded on an uplink transport channel to a radio section between a network and a user equipment, there is a physical uplink shared channel (PUSCH) for transmitting information of UL-SCH, a physical random access channel (PRACH) for transmitting RACH information or a physical uplink control channel (PUCCH) for transmitting such control information, which is provided by first and second layers, as HARQ ACK/NACK (Non-acknowledge), scheduling request (SR), channel quality indicator (CQI) report and the like.

The NAS state model is based on a two-dimensional model which consists of EPS Mobility Management (EMM) states and of EPS Connection Management (ECM) states. The EMM states describe the mobility management states that result from the mobility management procedures e.g., Attach and Tracking Area Update procedures. The ECM states describe the signaling connectivity between the UE and the EPC.

In detail, in order to manage mobility of a UE in NAS layers positioned in control planes of the UE and an MME, an EPS mobility management REGISTERED (EMM-REGISTERED) state and an EMM-DEREGISTERED state may be defined. The EMM-REGISTERED state and the EMM-DEREGISTERED state may be applied to the UE and the MME.

The UE is in the EMM deregistered state, like a state in which power of the UE is first turned on, and in order for the UE to access a network, a process of registering in the corresponding network is performed through an initial access procedure. When the access procedure is successfully performed, the UE and the MME transition to an EMM-REGISTERED state.

Also, in order to manage signaling connection between the UE and the network, an EPS connection management CONNECTED (ECM-CONNECTED) state and an ECM-IDLE state may be defined. The ECM-CONNECTED state and the ECM-IDLE state may also be applied to the UE and the MME. The ECM connection may include an RRC connection established between the UE and a BS and an S1 signaling connection established between the BS and the MME. The RRC state indicates whether an RRC layer of the UE and an RRC layer of the BS are logically connected. That is, when the RRC layer of the UE and the RRC layer of the BS are connected, the UE may be in an RRC_CONNECTED state. When the RRC layer of the UE and the RRC layer of the BS are not connected, the UE in an RRC_IDLE state.

Here, the ECM and EMM states are independent of each other and when the UE is in EMM-REGISTERED state this does not imply that the user plane (radio and S1 bearers) is established

In E-UTRAN RRC_CONNECTED state, network-controlled UE-assisted handovers are performed and various DRX cycles are supported. In E-UTRAN RRC_IDLE state, cell reselections are performed and DRX is supported.

The network may recognize the presence of the UE in the ECM-CONNECTED state by the cell and effectively control the UE. That is, when the UE is in the ECM-CONNECTED state, mobility of the UE is managed by a command from the network. In the ECM-CONNECTED state, the network knows about a cell to which the UE belongs. Thus, the network may transmit and/or receive data to or from the UE, control mobility such as handover of the UE, and perform cell measurement on a neighbor cell.

Meanwhile, the network cannot recognize the presence of the UE in the ECM-idle state and a core network (CN) manages the UE by the tracking area, a unit greater than cell. When the UE is in the ECM-idle state, the UE performs discontinuous reception (DRX) set by the NAS using an ID uniquely assigned in a tracking region. That is, the UE may monitor a paging signal at a particular paging opportunity in every UE-specific paging DRX cycle to receive broadcast of system information and paging information. Also, when the UE is in the ECM-idle state, the network does not have context information of the UE.

Thus, the UE in the ECM-idle state may perform a UE-based mobility-related procedure such as cell selection or cell reselection without having to receive a command from the network. When a location of the UE in the ECM-idle state is changed from that known by the network, the UE may inform the network about a location thereof through a tracking area update (TAU) procedure.

As described above, in order for the UE to receive a general mobile communication service such as voice or data, the UE needs to transition to an ECM-CONNECTED state. The UE is in the ECM-IDLE state like the case in which power of the UE is first turned on. When the UE is successfully registered in the corresponding network through an initial attach procedure, the UE and the MME transition to an ECM-CONNECTED state. Also, in a case in which the UE is registered in the network but traffic is deactivated so radio resource is not allocated, the UE is in an ECM-IDLE state, and when uplink or downlink new traffic is generated in the corresponding UE, the UE and the MME transition to an ECM-CONNECTED state through a service request procedure.

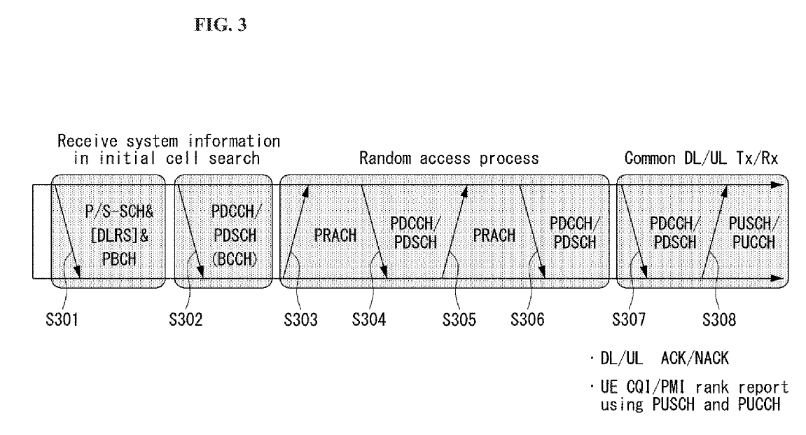

FIG. 3 illustrates physical channels and a view showing physical channels used for in the 3GPP LTE/LTE-A system to which the present invention can be applied.

When a UE is powered on or when the UE newly enters a cell, the UE performs an initial cell search operation such as synchronization with a BS in step S301. For the initial cell search operation, the UE may receive a Primary Synchronization Channel (P-SCH) and a Secondary Synchronization Channel (S-SCH) from the BS so as to perform synchronization with the BS, and acquire information such as a cell ID.

Thereafter, the UE may receive a physical broadcast channel (PBCH) from the BS and acquire broadcast information in the cell. Meanwhile, the UE may receive a Downlink Reference signal (DL RS) in the initial cell search step and confirm a downlink channel state.

The UE which completes the initial cell search may receive a Physical Downlink Control Channel (PDCCH) and a Physical Downlink Shared Channel (PDSCH) corresponding to the PDCCH, and acquire more detailed system information in step S302.

Thereafter, the UE may perform a random access procedure in steps S303 to S306, in order to complete the access to the BS. For the random access procedure, the UE may transmit a preamble via a Physical Random Access Channel (PRACH) (S303), and may receive a message in response to the preamble via the PDCCH and the PDSCH corresponding thereto (S304). In contention-based random access, a contention resolution procedure including the transmission of an additional PRACH (S305) and the reception of the PDCCH and the PDSCH corresponding thereto (S306) may be performed.

The UE which performs the above-described procedure may then receive the PDCCH/PDSCH (S307) and transmit a Physical Uplink Shared Channel (PUSCH)/Physical Uplink Control Channel (PUCCH) (S308), as a general uplink/downlink signal transmission procedure.

Control information transmitted from the UE to the BS is collectively referred to as uplink control information (UCI). The UCI includes hybrid automatic repeat and request acknowledgement/negative-acknowledgement (HARQ ACK/NACK), scheduling request (SR), channel quality information (CQI), precoding matrix indicator (PMI), rank indication (RI), etc. In the embodiments of the present invention, CQI and/or PMI are also referred to as channel quality control information.

In general, although a UCI is periodically transmitted via a PUCCH in the LTE system, this may be transmitted through a PUSCH if control information and traffic data are simultaneously transmitted. In addition, a UCI may be aperiodically transmitted via a PUSCH according to a network request/instruction.

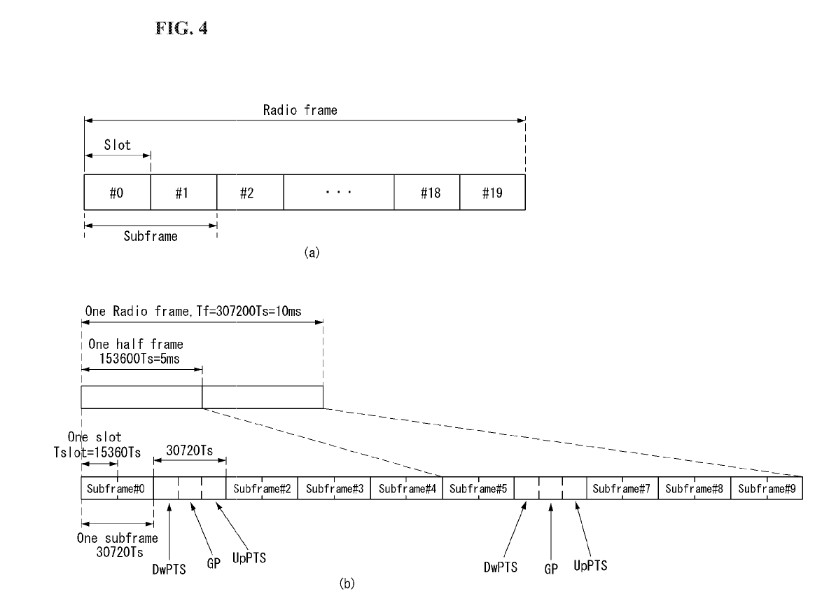

FIG. 4 is a diagram showing the structure of a radio frame used in a 3GPP LTE system to which the present invention can be applied.

In a cellular OFDM radio packet communication system, uplink/downlink data packet transmission is performed in subframe units and one subframe is defined as a predetermined duration including a plurality of OFDM symbols. The 3GPP LTE standard supports a type-1 radio frame structure applicable to frequency division duplex (FDD) and a type-2 radio frame structure applicable to time division duplex (TDD). According to the FDD scheme, the UL transmission and the DL transmission are performed by occupying different frequency bandwidths. According to the TDD scheme, the UL transmission and the DL transmission are performed on respective times different from each other while occupying the same frequency bandwidth. The channel response in the TDD scheme is substantially reciprocal. This signifies that the DL channel response and the UL channel response are about the same in a given frequency domain. Accordingly, there is a merit that the DL channel response can be obtained from the UL channel response in wireless communication systems based on the TDD. In the TDD scheme, since entire frequency bandwidth is timely divided in the UL transmission and the DL transmission, the DL transmission by an eNB and the UL transmission by a UE may not be performed simultaneously. In the TDD system in which the UL transmission and the DL transmission are distinguished by a unit of subframe, the UL transmission and the DL transmission are performed in different subframes.

FIG. 4(a) shows the structure of the type-1 radio frame. A downlink radio frame includes 10 subframes and one subframe includes two slots in a time domain. A time required to transmit one subframe is referred to as a transmission time interval (TTI). For example, one subframe has a length of 1 ms and one slot has a length of 0.5 ms. One slot includes a plurality of OFDM symbols in a time domain and includes a plurality of resource blocks (RBs) in a frequency domain. In the 3GPP LTE system, since OFDMA is used in the downlink, an OFDM symbol indicates one symbol period. The OFDM symbol may be referred to as an SC-FDMA symbol or symbol period. A RB as a resource allocation unit may include a plurality of consecutive subcarriers in one slot.

The number of OFDM symbols included in one slot may be changed according to the configuration of cyclic prefix (CP). CP includes an extended CP and a normal CP. For example, if OFDM symbols are configured by the normal CP, the number of OFDM symbols included in one slot may be 7. If OFDM symbols are configured by the extended CP, since the length of one OFDM symbol is increased, the number of OFDM symbols included in one slot is less than the number of OFDM symbols in case of the normal CP. In case of the extended CP, for example, the number of OFDM symbols included in one slot may be 6. In the case where a channel state is unstable, such as the case where a UE moves at a high speed, the extended CP may be used in order to further reduce inter-symbol interference.

In case of using the normal CP, since one slot includes seven OFDM symbols, one subframe includes 14 OFDM symbols. At this time, a maximum of three first OFDM symbols of each subframe may be allocated to a physical downlink control channel (PDCCH) and the remaining OFDM symbols may be allocated to a physical downlink shared channel (PDSCH).

FIG. 4(b) shows the structure of the type-2 radio frame. The type-2 radio frame includes two half frames and each half frame includes five subframes, a downlink pilot time slot (DwPTS), a guard period (GP) and an uplink pilot time slot (UpPTS). From among these, one subframe includes two slots. The DwPTS is used for initial cell search, synchronization or channel estimation of a UE. The UpPTS is used for channel estimation of a BS and uplink transmission synchronization of a UE. The GP is used to eliminate interference generated in the uplink due to multi-path delay of a downlink signal between the uplink and the downlink.

The structure of the radio frame is only exemplary and the number of subframes included in the radio frame, the number of slots included in the subframe, or the number of symbols included in the slot may be variously changed.

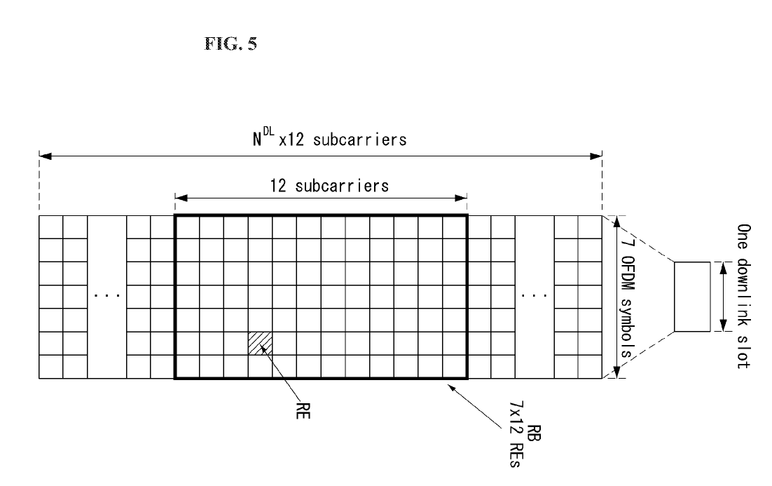

FIG. 5 shows an example of a resource grid for one downlink slot in the wireless communication system to which the present invention can be applied.

Referring to the FIG. 5, the downlink slot includes a plurality of OFDM symbols in a time domain. It is described herein that one downlink slot includes 7 OFDMA symbols and one resource block includes 12 subcarriers for exemplary purposes only, and the present invention is not limited thereto.

Each element on the resource grid is referred to as a resource element, and one resource block includes 12×7 resource elements. The resource element on the resource grid may be identified by an index pair (k, 1) in the slot. Here, k (k=0, . . . , NRB×12-1) denotes an index of subcarrier in the frequency domain, and 1(1=0, . . . , 6) denotes an index of symbol in the time domain. The number NDL of resource blocks included in the downlink slot depends on a downlink transmission bandwidth determined in a cell.

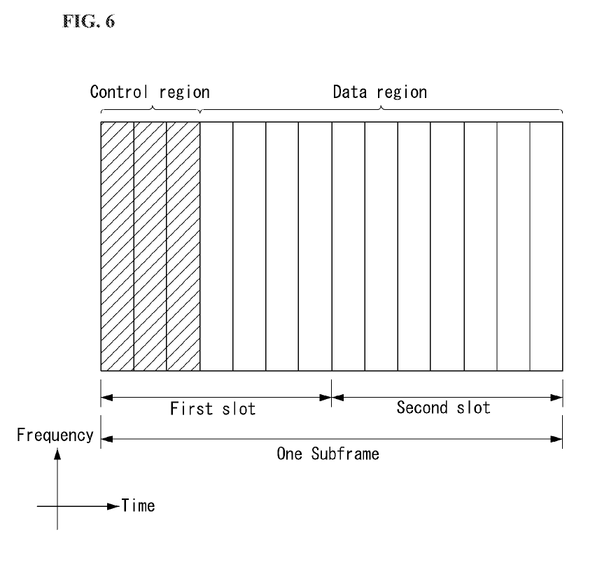

FIG. 6 shows a structure of a downlink subframe in the wireless communication system to which the present invention can be applied.

Referring to the FIG. 6, a maximum of three OFDM symbols located in a front portion of a first slot in a subframe correspond to a control region to be assigned with control channels. The remaining OFDM symbols correspond to a data region to be assigned with physical downlink shared channels (PDSCHs).

Examples of downlink control channels used in the 3GPP LTE include a physical control format indicator channel (PCFICH), a physical downlink control channel (PDCCH), a physical hybrid-ARQ indicator channel (PHICH), etc. The PCFICH transmitted in a 1st OFDM symbol of a subframe carries information regarding the number of OFDM symbols (i.e., a size of a control region) used for transmission of control channels in the subframe. Control information transmitted over the PDCCH is referred to as downlink control information (DCI). The DCI transmits uplink resource assignment information, downlink resource assignment information, an uplink transmit power control (TPC) command for any UE groups, etc. The PHICH carries an acknowledgement (ACK)/not-acknowledgement (NACK) signal for an uplink hybrid automatic repeat request (HARQ). That is, the ACK/NACK signal for uplink data transmitted by a UE is transmitted over the PHICH.

ABS determines a PDCCH format according to DCI to be transmitted to a UE, and attaches a cyclic redundancy check (CRC) to control information. The CRC is masked with a unique identifier (referred to as a radio network temporary identifier (RNTI)) according to an owner or usage of the PDCCH. If the PDCCH is for a specific UE, a unique identifier (e.g., cell-RNTI (C-RNTI)) of the UE may be masked to the CRC. Alternatively, if the PDCCH is for a paging message, a paging indication identifier (e.g., paging-RNTI (P-RNTI)) may be masked to the CRC. If the PDCCH is for system information, a system information identifier (e.g., system information-RNTI (SI-RNTI)) may be masked to the CRC. To indicate a random access response that is a response for transmission of a random access preamble of the UE, a random access-RNTI (RA-RNTI) may be masked to the CRC.

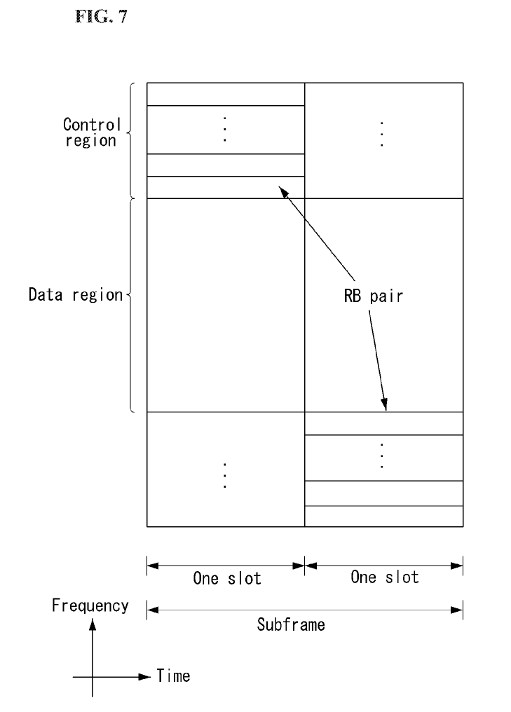

FIG. 7 shows a structure of an uplink subframe in the wireless communication system to which the present invention can be applied.

Referring to the FIG. 7, the uplink subframe can be divided in a frequency domain into a control region and a data region. The control region is allocated with a physical uplink control channel (PUCCH) for carrying uplink control information. The data region is allocated with a physical uplink shared channel (PUSCH) for carrying user data. In case of being indicated from higher layer, UE can simultaneously transmit the PUCCH and the PUSCH.

The PUCCH for one UE is allocated to an RB pair in a subframe. RBs belonging to the RB pair occupy different subcarriers in respective two slots. This is called that the RB pair allocated to the PUCCH is frequency-hopped in a slot boundary.

### Physical Downlink Control Channel (PDCCH)

The control information transmitted through the PDCCH is referred to as a downlink control indicator (DCI). In the PDCCH, a size and use of the control information are different according to a DCI format. In addition, a size of the control information may be changed according to a coding rate.

Table 1 represents the DCI according to the DCI format.

TABLE 1

| DCI | |
|---|---|
| format | Objectives |
| 0 | Scheduling of PUSCH |
| 1 | Scheduling of one PDSCH codeword |
| 1A | Compact scheduling of one PDSCH codeword |
| 1B | Closed-loop single-rank transmission |
| 1C | Paging, RACH response and dynamic BCCH |
| 1D | MU-MIMO |
| 2 | Scheduling of rank-adapted closed-loop |
| | spatial multiplexing mode |
| 2A | Scheduling of rank-adapted open-loop |
| | spatial multiplexing mode |
| 3 | TPC commands for PUCCH and |
| | PUSCH with 2 bit power adjustments |
| 3A | TPC commands for PUCCH and PUSCH |
| | with single bit power adjustments |
| 4 | the scheduling of PUSCH in one UL cell |
| | with multi-antenna port transmission mode |

Referring to Table 1, the DCI format includes format 0 for the PUSCH scheduling, format 1 for scheduling of one PDSCH codeword, format 1A for compact scheduling of one PDSCH codeword, format 1C for very compact scheduling of the DL-SCH, format 2 for PDSCH scheduling in a closed-loop spatial multiplexing mode, format 2A for PDSCH scheduling in an open-loop spatial multiplexing mode, formats 3 and 3A for transmitting a transmission power control (TPC) command for a UL channel, and format 4 for PUSCH scheduling within one UL cell in a multiple antenna port transmission mode. DCI format 1A may be used for PDSCH scheduling whichever transmission mode is configured to a UE.

Such DCI formats may be independently applied to each UE, and the PDCCHs of several UEs may be simultaneously multiplexed in one subframe. The PDCCH is comprised of an aggregation of one or a few continuous control channel elements (CCEs). The CCE is a logical allocation unit used for providing a coding rate according to a state of radio channel to the PDCCH. The CCE is referred to as a unit that corresponds to nine sets of resource element group (REG) which is comprised of four resource elements. An eNB may use {1, 2, 4, 8} CCEs for constructing one PDCCH signal, and this {1, 2, 4, 8} is called a CCE aggregation level. The number of CCE used for transmitting a specific PDCCH is determined by the eNB according to the channel state. The PDCCH configured according to each UE is mapped with being interleaved to a control channel region of each subframe by a CCE-to-RE mapping rule. A location of the PDCCH may be changed according to the number of OFDM symbols for the control channel, the number of PHICH group, a transmission antenna, a frequency shift, etc.

As described above, a channel coding is independently performed for the PDCCH of each multiplexed UE, and the cyclic redundancy check (CRC) is applied. By masking each UE ID to CRC, the UE may receive its PDCCH. However, in the control region allocated in a subframe, the eNB does not provide information on where the PDCCH that corresponds to the UE is. Since the UE is unable to know on which position its PDCCH is transmitted with which CCE aggregation level and DCI format in order to receive the control channel transmitted from the eNB, the UE finds its own PDCCH by monitoring a set of PDCCH candidates in a subframe. This is called a blind decoding (BD). The blind decoding may also be called a blind detection or a blind search. The blind decoding signifies a method of verifying whether the corresponding PDCCH is its control channel by checking CRC errors, after the UE de-masks its UE ID in CRC part.

Hereinafter, the information transmitted through DCI format 0 will be described.

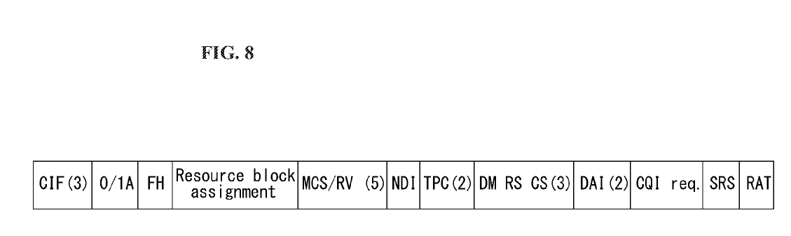

FIG. 8 illustrates a structure of DCI format 0 in the wireless communication system to which the present invention can be applied.

DCI format 0 is used for scheduling the PUSCH in one UL cell.

Table 2 represents information transmitted via DCI format 0.

TABLE 2

| Format 0 | Format 0 |
|---|---|
| (Release 8) | (Release 10) |
| | Carrier Indicator (CIF) |
| Flag for format 0/ | Flag for format 0/ |
| format 1A differentiation | format 1A differentiation |
| Hopping flag (FH) | Hopping flag (FH) |
| Resource block | Resource block |
| assignment (RIV) | assignment (RIV) |
| MCS and RV | MCS and RV |
| NDI (New Data Indicator) | NDI (New Data Indicator) |
| TPC for PUSCH | TPC for PUSCH |
| Cyclic shift for DM RS | Cyclic shift for DM RS |
| UL index (TDD only) | UL index (TDD only) |
| Downlink Assignment | Downlink Assignment |
| Index (DAI) | Index (DAI) |
| CSI request (1 bit) | CSI request (1 or |
| | 2 bits: 2 bit is for |
| | multi carrier) |
| | SRS request |
| | Resource allocation |
| | type (RAT) |

Referring to FIG. 8 and Table 2, the information transmitted via DCI format 0 is as follows.
1) Carrier indicator Includes 0 or 3 bits.
2) Flag for DCI format 0/1A differentiation—Includes 1 bit, a value of 0 indicates DCI format 0 and a value of 1 indicates DCI format 1A.
3) Frequency hopping flag—Includes 1 bit. In this field, a most significant bit (MSB) of resource allocation may be used for multi-cluster allocation.
4) Resource block assignment and hopping resource assignment—Includes ┌log₂ (N_{RB}^{DL} (N_{RB}^{DL}+1)/2)┐ bits.

Herein, in case of PUSCH hopping in single-cluster allocation, in order to acquire a value of ñ_{PRB}(i) NUL_hop MSBs are used. (┌log₂ (N_{RB}^{UL} (N_{RB}^{UL}+1)/2)┐−N_{UL}_{_}ₕₒₚ) bits provide resource allocation of a first slot within an uplink subframe. In addition, if PUSCH hopping is not present in single-cluster allocation, (┌log₂(N_{RB}^{UL} (N_{RB}^{UL}+1)/2)┐) bits provide resource allocation within an uplink subframe. In addition, if PUSCH hopping is not present in multi-cluster allocation, resource allocation information is obtained from concatenation between the frequency hopping flag field and resource block assignment and hopping resource assignment field and

$$⌈ {log}_{2} ( ( \begin{matrix}⌈ {N}_{RB}^{UL} / P + 1 ⌉ \\ 4\end{matrix} ) ) ⌉$$

bits provide resource allocation within an uplink subframe. At this time, the P value is determined by the number of downlink resource blocks.
5) Modulation and coding scheme (MCS)—Includes 5 bits.
6) New data indicator—Includes 1 bit.
7) Transmit power control (TPC) command for PUSCH—Includes 2 bits.
8) Index of orthogonal cover/orthogonal cover code (OC/OCC) and cyclic shift for demodulation reference signal (DMRS)—Includes 3 bits.
9) Uplink Index—Includes 2 bits. This field is present only in TDD operation according to uplink-downlink configuration 0.
10) Downlink assignment index (DAI)—Includes 2 bits. This field is present only in TDD operation according to uplink-downlink configurations 1 to 6.
11) Channel state information (CSI) request—Includes 1 or 2 bits. Herein, a 2-bit field is only applied to the case in which the DCI is mapped to the UE, for which one or more downlink cells are configured, by the C-RNTI in a UE-specific manner.
12) Sounding reference signal (SRS) request—Includes 0 or 1 bit. This field is present only in the case in which a scheduled PUSCH is mapped in a UE-specific manner by the C-RNTI.
13) Multi-cluster flag—Includes 1 bit.

If the number of information bits in DCI format 0 is less than the payload size (including added padding bits) of DCI format 1A, 0 is appended to DCI format 0 such that the number of information bits becomes equal to the payload size of DCI format 1A.

### PUCCH(Physical Uplink Control Channel)

The PUCCH carries various sorts of uplink control information (UCI) according to format as follows.
SR (Scheduling Request): This is information used for requesting the UL-SCH resource. This information is transmitted using an on-off keying (OOK) method.
HARQ ACK/NACK: This is a response signal for DL data packet on a PDSCH. This information represents whether the DL data packet is successfully received. One bit of ACK/NACK is transmitted in response to a single DL codeword and two bits of ACK/NACK are transmitted in response to two DL codewords.
CSI (Channel State Information): This is feedback information for a DL channel. The

CSI may include at least one of a channel quality indicator (CQI), a rank indicator (RI), a precoding matrix indicator (PMI) and a precoding type indicator (PTI). Hereinafter, this will be referred to ‘CQI’ as a common term for the convenience of description.

The PUCCH may be modulated by using a binary phase shift keying (BPSK) technique and a quadrature phase shift keying (QPSK) technique. Control information for a plurality of UEs may be transmitted through the PDCCH. In case of performing code division multiplexing (CDM) to distinguish signal of each of the UEs, constant amplitude zero autocorrelation (CAZAC) sequence is mostly used. Since the CAZAC sequence has characteristics of maintaining a fixed amplitude in a time domain and a frequency domain, the CAZAC has characteristics proper to increase coverage by lowering a peak-to-average power ratio (PAPR) or a cubic metric (CM) of a UE. In addition, the ACK/NACK information for DL data transmission transmitted through the PDCCH is covered by using an orthogonal sequence or an orthogonal cover (OC).

Additionally, control information transmitted on the PUCCH may be distinguished by using a cyclically shifted sequence that has different cyclic shift (CS) values. The cyclically shifted sequence may be generated by shifting cyclically a base sequence by as much as a predetermined cyclic shift amount. The cyclic shift amount is indicated by a CS index. The number of available cyclic shift may be changed according to delay spread of a channel. Various sorts of sequence may be used as the basic sequence, and the CAZAC sequence described above is an example.

In addition, the quantity of control information that can be transmitted by a UE in a subframe may be determined depending on the number of SC-FDMA symbols (i.e., signifies SC-FDMA symbols other than SC-FDMA symbols used for reference signal (RS) transmission for detecting coherent detection of the PUCCH, but except for the last SC-FDMA symbol in a subframe in which a sounding reference signal (SRS) is configured). The PUCCH may be defined by seven sorts of different formats depending on the control information, a modulation technique, a quantity of the control information, etc. which is transmitted, and the property of uplink control information (UCI) transmitted according to each of the PUCCH formats may be summarized as Table 1 below.

TABLE 3

| PUCCH Format | Uplink Control Information(UCI) |
|---|---|
| Format 1 | Scheduling Request(SR)(unmodulated waveform) |
| Format 1a | 1-bit HARQ ACK/NACK with/without SR |
| Format 1b | 2-bit HARQ ACK/NACK with/without SR |
| Format 2 | CQI (20 coded bits) |
| Format 2 | CQI and 1- or 2-bit HARQ ACK/NACK (20 bits) for |
| | extended CP only |
| Format 2a | CQI and 1-bit HARQ ACK/NACK (20+1 coded bits) |
| Format 2b | CQI and 2-bit HARQ ACK/NACK (20+1 coded bits) |
| Format 3 | HARQ ACK/NACK, SR, CSI (48 coded bits) |

Referring to Table 3, PUCCH format 1 is used for a single transmission of a scheduling request (SR). Wave forms which are not modulated are applied to the single transmission of SR, and this will be described below in detail.

PUCCH format 1a or 1b is used for transmitting HARQ acknowledgement/non-acknowledgement (ACK/NACK). When the HARQ ACK/NACK is solely transmitted in an arbitrary subframe, PUCCH format la or lb may be used. Or, the HARQ ACK/NACK and the SR may be transmitted in a same subframe by using PUCCH format 1a or 1b.

PUCCH format 2 is used for transmitting the CQI, and PUCCH format 2a or 2b is used for transmitting the CQI and the HARQ ACK/NACK. In case of an extended CP, PUCCH format 2 may also be used for transmitting the CQI and the HARQ ACK/NACK.

PUCCH format 3 is used for carrying an encoded UCI of 48 bits. PUCCH format 3 may carry the HARQ ACK/NACK for a plurality of serving cells, the SR (if existed) and the CSI report for a serving cell.

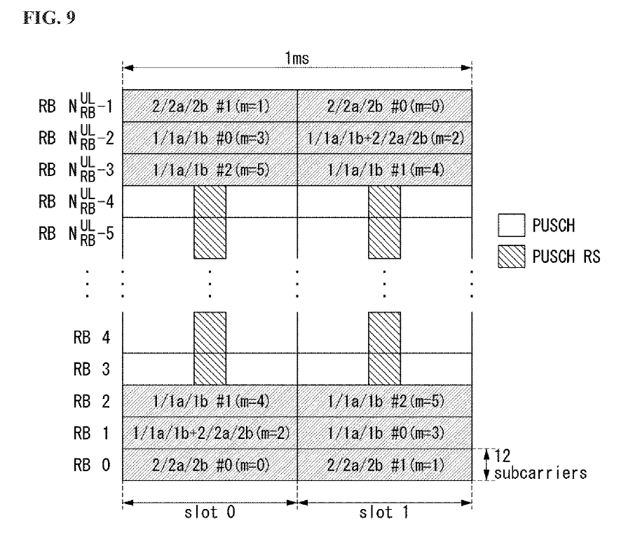

FIG. 9 illustrates an example of a formation that PUCCH formats are mapped to the PUCCH regions of the UL physical resource blocks in the wireless communication system to which the present application can be applied.

A PUCCH for a UE is allocated to an RB pair in a subframe. The RBs belonging to the RB pair occupy different subcarriers in each of a first slot and a second slot. A frequency occupied by RBs belonged in the RB pair allocated to the PUCCH is changed based on a slot boundary. This is expressed that the RB pair allocated to the PUCCH is frequency-hopped in the slot boundary. A UE transmits UL control information through different subcarriers according to time, thereby obtaining a frequency diversity gain.

In FIG. 9, N_{RB}^{UL} represents the number of resource block in UL, and 0, 1, . . . , N_{RB}^{UL}−1 signifies given number of the physical resource block. Basically, the PUCCH is mapped to both edges of the UL frequency blocks. As shown in FIG. 9, PUCCH formats 2/2a/2b are mapped to the respective PUCCH regions marked by m=0 and 1, and this may be represented as PUCCH formats 2/2a/2b are mapped to the resource blocks located at band edges. In addition, PUCCH formats 2/2a/2b and PUCCH formats 1/1a/1b are mixedly mapped to the PUCCH region marked by m=2. Next, PUCCH formats 1/1a/1b may be) mapped to the PUCCH regions marked by m=3, 4 and 5. The number N_{RB}⁽²⁾ of PUCCH RBs usable by PUCCH formats 2/2a/2b may be indicated by the UEs within a cell by broadcasting signaling.

Table 4 represents modulation schemes according to the PUCCH format and number of bits per subframe. In Table 4, PUCCH formats 2a and 2b correspond to the case of normal cyclic shift.

TABLE 4

| PUCCH format | Modulation scheme | Number of bits per subframe, M_{bit} |
|---|---|---|
| 1 | N/A | N/A |
| 1a | BPSK | 1 |
| 1b | QPSK | 2 |
| 2 | QPSK | 20 |
| 2a | QPSK + BPSK | 21 |
| 2b | QPSK + QPSK | 22 |
| 3 | QPSK | 48 |

Table 5 represents the number of symbols of PUCCH demodulation reference signal per slot according to the PUCCH format.

TABLE 5

| PUCCH format | Normal cyclic prefix | Extended cyclic prefix |
|---|---|---|
| 1, 1a, 1b | 3 | 2 |
| 2, 3 | 2 | 1 |
| 2a, 2b | 2 | N/A |

Table 6 represents SC-FDMA symbol location of the PUCCH demodulation reference signal according to the PUCH format. In Table 6, l represents a symbol index.

TABLE 6

| | Set of values for ^{l} | |
|---|---|---|
| PUCCH format | Normal cyclic prefix | Extended cyclic prefix |
| 1, 1a, 1b | 2, 3, 4 | 2, 3 |
| 2, 3 | 1, 5 | 3 |
| 2a, 2b | 1, 5 | N/A |

Hereinafter, PUCCH formats 2/2a/2b will be described.

PUCCH formats 2/2a/2b are used for CQI feedback (or ACK/NACK transmission together with the CQI feedback) for DL transmission. In order for the CQI to be transmitted with the ACK/NACK may be transmitted with being embedded in the CQI RS (in case of a normal CP), or transmitted with the CQI and the ACK/NACK being joint coded (in case of an extended CP).

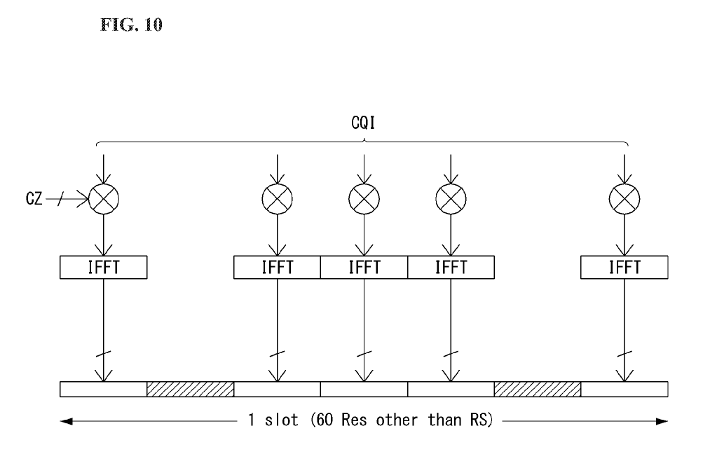

FIG. 10 shows a structure of CQI channel in case of a normal CP in the wireless communication system to which the present invention can be applied. Among SC-FDMA symbols 0 to 6 in a slot, SC-FDMA symbols 1 to 5 (a second and a sixth symbols) are used for transmitting demodulation reference signal (DMRS), and the CQI information may be transmitted in the remainder SC-FDMA symbols. Meanwhile, in case of the extended CP, one SC-FDMA symbol (SC-FDMA symbol 3) is used for transmitting the DMRS.

In PUCCH formats 2/2a/2b, the modulation by the CAZAC sequence is supported, and the QPSK modulated symbol is multiplied by the CAZAC sequence of length 12. The cyclic shift (CS) of sequence may be changed between symbols and slots. An orthogonal covering is used for the DMRS.

In two SC-FDMA symbols which are three SC-FDMA symbol intervals from seven SC-FDMA symbols included in a slot, the reference signal (DMRS) is carried, and in the remainder five SC-FDMA symbols, the CQI information is carried. In order to support a high speed UE, two RSs are used in a slot. In addition, the respective UEs are distinguished by using the cyclic shift (CS) sequence. The CQI information symbols are transmitted with being modulated to whole SC-FDMA symbol, and the SC-FDMA symbol includes one sequence. That is, the UE transmits the CQI with being modulated to each sequence.

The number of symbols which may be transmitted to one TTI is 10, and the modulation of the CQI information is also defined to the QPSK. Front five symbols are transmitted in a first slot, and the remainder five symbols are transmitted in a second slot. Since the CQI value of 2 bits may be carried in case of using the QPSK mapping for the SC-FDMA symbol, the CQI value of 10 bits may be carried in one slot. Accordingly, the CQI value of maximum 20 bits may be carried in one subframe. In order to spread the CQI information in a frequency domain, a frequency domain spread code is used.

As the frequency domain spread code, the CAZAC sequence of length 12 (e.g., ZC sequence) may be used. Each control channel may be distinguished by applying the CAZAC sequence that has different cyclic shift values. An inverse fast Fourier transform is performed for the CQI information which is spread in the frequency domain.

By the cyclic shifts that have twelve equivalent intervals, twelve different UEs may be orthogonally multiplexed on the same PUCCH RB. In case of a normal CP, the DMRS sequence on SC-FDMA symbol 1 and 5 (on SC-FDMA symbol 3 in case of an extended CP) is similar to the CQI signal sequence on the frequency domain, but the modulation similar to that of the CQI information is not applied.

A UE may be semi-statically configured to report different CQI, PMI and RI types periodically on the PUCCH resources indicated by the PUCCH resource indexes n_{PUCCH}^{(1,\tilde{p})}, n_{PUCCH}^{(2,\tilde{p})}, n_{PUCCH}^{(3,\tilde{p})} by a higher layer signaling. Herein, the PUCCH resource index n_{PUCCH}^{(2,\tilde{p})} is information that indicates the PUCCH region used for transmitting PUCCH formats 2/2a/2b and cyclic shift (CS) to be used.

Table 7 represents an orthogonal sequence (OC) [w̅^{(p)}(0) . . . w̅^{(p)} (N_{RS}^{PUCCH}−1)] for RS in PUCCH formats 2/2a/2b/3.

TABLE 7

| Normal cyclic prefix | Extended cyclic prefix |
|---|---|
| [1 1] | [1] |

Next, PUCCH formats 1/1a/1b will be described below.

FIG. 11 shows a structure of ACK/NACK in case of a normal CP in the wireless communication system to which the present invention can be applied.

A confirmation response information (in a state of not scrambled) of 1 bit or 2 bits may be represented as a HARQ ACK/NACK modulation symbol using the BPSK and QPSK modulation techniques, respectively. An affirmative confirmation response (ACK) may be encoded as ‘1’, and a negative confirmation response (NACK) may be encoded as ‘0’. When transmitting a control signal in an allocated bandwidth, two dimensional spread is applied in order to increase a multiplexing capacity. That is, a spread in frequency domain and a spread in time domain are simultaneously applied in order to increase the number of UE or the number of control channel that can be multiplexed.

In order to spread an ACK/NACK signal in frequency domain, a frequency domain sequence is used as a basic sequence. As the frequency domain sequence, Zadoff-Chu (ZC) sequence which is one of constant amplitude zero autocorrelation waveform sequences may be used.

That is, in PUCCH format 1a/1b, the symbol modulated using the BPSK or the QPSK modulation scheme is multiplied by the CAZAC sequence (e.g., the ZC sequence) of length 12. For example, the result of the CAZAC sequence r(n) (n=0, 1, 2, . . . , N−1) of length N modulated to modulation symbol d(0) is y(0), y(1), y(2), . . . , y(N−1). The symbols y(0), y(1), y(2), . . . , y(N−1) may be referred to as block of symbols.

Like this, different cyclic shifts (CS) are applied to the Zadoff Chu (ZC) sequence which is a basic sequence, and multiplexing of different UEs or different control channels may be applied. The number of CS resources supported by SC-FDMA symbol which is for PUCCH RBs in the HARQ ACK/NACK transmission is setup by a cell-specific higher layer signaling parameter(Δ_{shift}^{PUCCH}).

After multiplying the CAZAC sequence to the modulation symbol, the block-wise spread using an orthogonal sequence is applied. That is, the ACK/NACK signal spread in a frequency domain is spread in a time domain by using an orthogonal spreading code. As for the orthogonal spreading code (or the orthogonal cover sequence or an orthogonal cover code (OCC)), a Walsh-Hadamard sequence or a Discrete Fourier Transform (DFT) sequence may be used. For example, the ACK/NACK signal may be spread by using the orthogonal sequence (w0, w1, w2, w3) of length 4 for four symbols. In addition, an RS is also spread through the orthogonal sequence of length 3 or length 2. This is referred to as an orthogonal covering (OC).

As for the CDM of ACK/NACK information or demodulation reference signal, an orthogonal covering such as a Walsh code, a DFT matrix, etc. may be used.

The DFT matrix is comprised of square matrixes, and constructed as a size of N×N (N is a natural number).

The DFT matrix may be defined as Equation 1.

$$W = {( \frac{{ω}^{jk}}{\sqrt{N}} )}_{j , k = 0 , … , N - 1} \qquad [ Equation 1 ]$$

Also, the DFT matrix may be represented as a matrix of Equation 2 below which is equivalent to Equation 1.

$$W = \frac{1}{\sqrt{N}} [ \begin{matrix}1 & 1 & 1 & 1 & ⋯ & 1 \\ 1 & ω & {ω}^{2} & {ω}^{3} & ⋯ & {ω}^{N - 1} \\ 1 & {ω}^{2} & {ω}^{4} & {ω}^{6} & ⋯ & {ω}^{2 ( N - 1 )} \\ 1 & {ω}^{3} & {ω}^{6} & {ω}^{9} & ⋯ & {ω}^{3 ( N - 1 )} \\ ⋮ & ⋮ & ⋮ & ⋮ & ⋱ & ⋮ \\ 1 & {ω}^{N - 1} & {ω}^{2 ( N - 1 )} & {ω}^{3 ( N - 1 )} & ⋯ & {ω}^{( N - 1 ) ( N - 1 )}\end{matrix} ] , \qquad [ Equation 2 ]$$

In Equation 2,

$$ω = {e}^{- \frac{2 π i}{N}}$$

signifies a primitive Nth root of unity.

The DFT matrix of 2 points, 4 points and 8 points correspond to Equations 3, 4 and 5 below.

$$\begin{matrix}\frac{1}{\sqrt{2}} [ \begin{matrix}1 & 1 \\ 1 & - 1\end{matrix} ] & [ Equation 3 ] \\ W = \frac{1}{\sqrt{4}} [ \begin{matrix}1 & 1 & 1 & 1 \\ 1 & - i & - 1 & i \\ 1 & - 1 & 1 & - 1 \\ 1 & i & - 1 & - i\end{matrix} ] & [ Equation 4 ] \\ W = \frac{1}{\sqrt{8}} [ \begin{matrix}{ω}^{0} & {ω}^{0} & {ω}^{0} & … & {ω}^{0} \\ {ω}^{0} & {ω}^{1} & {ω}^{2} & … & {ω}^{7} \\ {ω}^{0} & {ω}^{2} & {ω}^{4} & … & {ω}^{14} \\ {ω}^{0} & {ω}^{3} & {ω}^{6} & … & {ω}^{21} \\ {ω}^{0} & {ω}^{4} & {ω}^{8} & … & {ω}^{28} \\ {ω}^{0} & {ω}^{5} & {ω}^{10} & … & {ω}^{35} \\ ⋮ & ⋮ & ⋮ & ⋱ & ⋮ \\ {ω}^{0} & {ω}^{7} & {ω}^{14} & … & {ω}^{49}\end{matrix} ] & [ Equation 5 ]\end{matrix}$$

In case of a normal CP, in SC-FDMA symbols that are series of 3 middle parts out of 7 SC-FDMA symbols included in a slot, the reference signal (RS) is carried, and in the rest 4 SC-FDMA symbols, the ACK/NACK signal is carried. Meanwhile, in case of an extended CP, the RS may be carried in two consecutive symbols of the middle parts. The number and location of symbols used for the RS may be changed according to a control channel, and the number and location of symbols used for the ACK/NACK signal related may be changed according to the control channel as well.

For normal ACK/NACK information, the Walsh-Hadamard sequence having length 4 is used, and for shortened ACK/NACK information and the reference signal, a DFT of length 3 is used.

For the reference signal of an extended CP case, the Walsh-Hadamard sequence having length 2 is used.

Table 8 represents an orthogonal sequence of length 4 [w(0) . . . w(N_{SF}^{PUCCH}−1)] for PUCCH format 1a/1b.

TABLE 8

| Sequence index n_{oc}⁽\tilde{^{p}}⁾(nₛ) | Orthogonal sequence [w(0) . . . w(N_{SF}^{PUCCH} −1)] |
|---|---|
| 0 | [+1 +1 +1 +1] |
| 1 | [+1 −1 +1 −1] |
| 2 | [+1 −1 −1 +1] |

Table 9 represents an orthogonal sequence of length 3 [w(0) . . . w(N_{SF}^{PUCCH}−1)] for PUCCH format 1a/1b.

TABLE 9

| Sequence index n_{oc}⁽\tilde{^{p}}⁾(nₛ) | Orthogonal sequence [w(0) . . . w(N_{SF}^{PUCCH} −1)] |
|---|---|
| 0 | [1 1 1] |
| 1 | [1 e^{j2π/3} e^{j4π/3}] |
| 2 | [1 e^{j4π/3} e^{j2π/3}] |

Table 10 represents an orthogonal sequence [w̅^{(\tilde{p})}(0) . . . w̅^{(\tilde{p})}(N_{RS}^{PUCCH}−1)] for the RS in PUCCH format 1/1a/1b.

| Sequence index n̅_{oc}⁽\tilde{^{p}}⁾(nₛ) | Normal cyclic prefix | Extended cyclic prefix |
|---|---|---|
| 0 | [1 1 1] | [1 1] |
| 1 | [1 e^{j2π/3} e^{j4π/3}] | [1 −1] |
| 2 | [1 e^{j4π/3} e^{j2π/3}] | N/A |

As described above, by using the CS resource in the frequency domain and the OC resource in the time domain, numerous UEs may be multiplexed in a code division multiplexing (CDM) method. That is, the ACK/NACK information and the RS of a great number of UEs may be multiplexed on the same PUCCH RB.

For the time domain spreading CDM like this, the number of extended codes that are supported for the ACK/NACK information is limited by the number of RS symbols. That is, since the number of SC-FDMA symbols in the RS transmission is less than the number of SC-FDMA symbols in the ACK/NACK information transmission, the multiplexing capacity of RS is smaller than the multiplexing capacity of ACK/NACK information.

For example, in case of a normal CP, the ACK/NACK information may be transmitted in four symbols. In case of an extended CP, three orthogonal spreading codes, not four, may be used. This is because the number of RS transmission symbols is limited to three, and three orthogonal spreading codes only may be used for the RS.

In case that three symbols in one slot are used for the RS transmission and four symbols are used for the ACK/NACK information transmission in the subframe of a normal CP, for example, if six cyclic shifts (CSs) can be used in the frequency domain and three orthogonal covering (OC) resources can be used in the time domain, the HARQ confirmation response from total 18 different UEs may be multiplexed in one PUCCH RB. If two symbols in one slot of a subframe of the extended CP are used for the RS transmission and four symbols are used for the ACK/NACK information transmission, for example, if six cyclic shifts (CSs) can be used in the frequency domain and two orthogonal covering (OC) resources can be used in the time domain, the HARQ confirmation response from total 12 different UEs may be multiplexed in the PUCCH RB.

Subsequently, PUCCH format 1 will be described. The schedule request (SR) is transmitted in a way of a UE being requested to be scheduled or a way of not being requested. The SR channel reuses the ACK/NACK channel structure in PUCCH format 1a/1b, and is configured in on-off keying (OOK) method based on an ACK/NACK channel design. In the SR, the reference signal is not transmitted. Accordingly, in the normal CP, the sequence of length 7 is used, and in the extended CP, the sequence of length 6 is used. For the SR and the ACK/NACK, different cyclic shifts or orthogonal covers may be allocated.

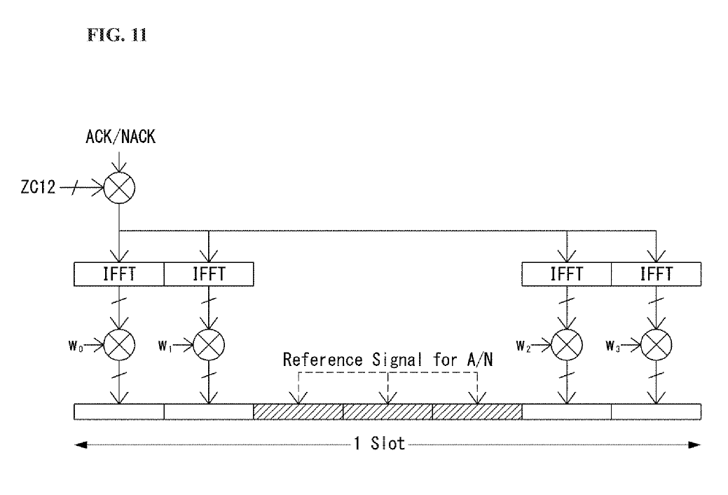

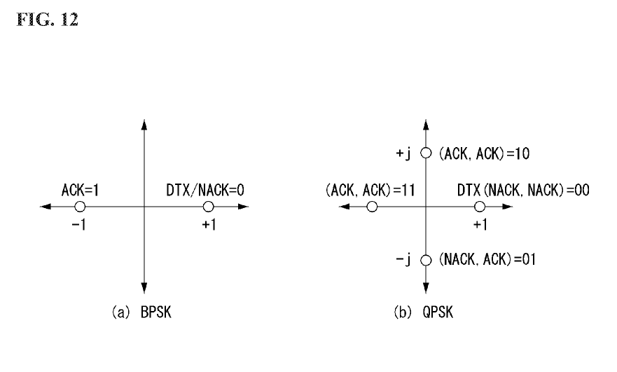

FIG. 12 illustrates a method for multiplexing the ACK/NACK and the SR in the wireless communication system to which the present invention can be applied.

The structure of SR PUCCH format 1 is identical to the structure of ACK/NACK PUCCH format 1a/1b illustrated in FIG. 12.

The SR is transmitted by using the on-off keying (KOO) method. Particularly, the UE transmits the SR having a modulation symbol d(0)=1 to request the PUSCH resource (a positive SR), and in case of not requesting the scheduling (a negative SR), nothing is transmitted. As the PUCCH structure for the ACK/NACK is reused for the SR, different PUCCH resource index (that is, a combination of different CS and orthogonal code) within a same PUCCH region may be allocated to the SR (PUCCH format 1) or to the HARQ ACK/NACK (PUCCH format 1a/1b). The PUCCH resource index that is going to be used by the UE for the SR transmission may be set by the UE-specific higher layer signaling.

In case that the UE is required to transmit the positive SR in the subframe in which the CQI transmission is scheduled, CQI is dropped and the SR only may be transmitted. Similarly, if a case is occurred that the SR and the SRS should be transmitted at the same time, the UE drops the CQI rather may transmit the SR only.

In case that the SR and the ACK/NACK are occurred in the same subframe, the UE transmits the ACK/NACK on the SR PUCCH resource that is allocated for the positive SR.

In the meantime, in case of the negative SR, the UE transmits the ACK/NACK on the allocated ACK/NACK resource.

FIG. 12 illustrates a property mapping for the simultaneous transmission of the ACK/NACK and the SR. In particular, it illustrates that the NACK (or, in case of 2 MIMO codewords, NACK, NACK) is modulated to map to +1. Accordingly, it is processed as NACK when a discontinuous transmission (DTX) is occurred.

For the SR and persistent scheduling, the ACK/NACK resource consisting of a CS, an OC, and a physical resource block (PRB) may be allocated to the UE through the radio resource control (RRC). Meanwhile, for the dynamic ACK/NACK transmission and non-persistent scheduling, the ACK/NACK resource may be allocated to the UE implicitly through the lowest CCE index of the PDCCH corresponding to the PDSCH.

In case of requiring resources for the UL data transmission, the UE may transmit the SR. That is, the SR transmission is triggered by an event.

The SR PUCCH resource is configured by a higher layer signaling except a case that the SR is transmitted with the HARQ ACK/NACK by using PUCCH format 3. That is, it is configured by a SchedulingRequestConfig information element that is transmitted through the radio resource control (RRC) message (for example, RRC connection reconfiguration message).

Table 11 exemplifies the SchedulingRequestConfig information element.

TABLE 11
-- ASN1START

| SchedulingRequestConfig ::= | CHOICE { | |
|---|---|---|
| release | | NULL, |

```
  setup
  SEQUENCE {
    sr-PUCCH-ResourceIndex
  INTEGER (0..2047),
    sr-ConfigIndex
  INTEGER (0..157),
    dsr-TransMax
  ENUMERATED {
      n4, n8, n16, n32, n64, spare3, spare2, spare 1}
  }
}
```

| SchedulingRequestConfig-v1020 ::= | SEQUENCE { | |
|---|---|---|
| sr-PUCCH-ResourceIndexP1-r10 | | INTEGER (0..2047) |

| | |
|---|---|
| OPTIONAL | --Need OR |

}
-- ASN1STOP

Table 12 represents a field that is included in the SchedulingRequestConfig information element.

TABLE 12
SchedulingRequestConfig field descriptions

dsr-TransMax
Parameter for the SR transmission. Value n4 represents 4 transmissions,
value n8 represents 8 transmissions, and the rest is the same as above.
sr-ConfigIndex
Parameter(^{I}_{SR}). Values 156 and 157 are not applied to release 8.
sr-PUCCH-ResourceIndex, sr-PUCCH-ResourceIndexP1
Parameter(n^{(1, p)}_{PUCCH,SRI}) for the respective antenna port P0 and P1.
E-UTRAN is configured the sr-PUCCH-ResourceIndexP1 only in case
that the sr-PUCCHResourceIndex is set.

Referring to Table 12, the UE receives sr-PUCCH-ResourceIndex parameter and sr-ConfigIndex parameter (I_{SR})indicating the SR configuration index through the RRC message for the SR transmission. By the sr-ConfigIndex parameter, SR_{PERIODICITY} indicating the periodicity when the SR is transmitted and N_{OFFSET,SR} indicating the subframe where the SR is transmitted may be configured. That is, the SR is transmitted from a specific subframe that is periodically repeated according to I_{SR} that is given by a higher layer. Also, the subframe resource and CDM/frequency division multiplexing (FDM) resource may be allocated to the resource for the SR.

Table 13 represents the SR transmission periodicity according to the SR configuring index and the SR subframe offset.

TABLE 13

| SR configuration Index | SR periodicity (ms) | SR subframe offset |
|---|---|---|
| I_{SR} | SR_{PERIODICITY} | N_{OFFSET, SR} |
| 0-4 | 5 | I_{SR} |
| 5-14 | 10 | I_{SR}-5 |
| 15-34 | 20 | I_{SR}-15 |
| 35-74 | 40 | I_{SR}-35 |
| 75-154 | 80 | I_{SR}-75 |
| 155-156 | 2 | I_{SR}-155 |
| 157 | 1 | I_{SR}-157 |

### Uplink Reference Signal

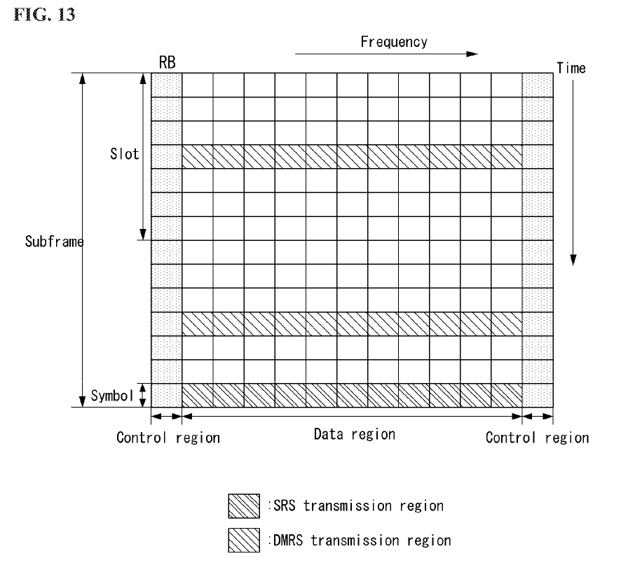

FIG. 13 is another diagram illustrating the structure of an uplink subframe in a wireless communication system to which an embodiment of the present invention may be applied. Referring to FIG. 13, a Sounding Reference Signal (SRS) may be periodically or aperiodically transmitted by UE in order to estimate the channel of an uplink band (or sub band) other than a band in which a PUSCH is transmitted or to obtain information about a channel corresponding to a total uplink band (wide band).

If the SRS is periodically transmitted, the period of the SRS is determined through a high layer signal. If the SRS is aperiodically transmitted, a BS may indicate such aperiodical transmission using the “SRS request” field of a PDCCH UL/DL DCI format or may send a triggering message.

As in the example of FIG. 13, a region in which an SRS may be transmitted in one subframe is a section in which an SC-FDMA symbol placed at the last in a time axis is present in the one subframe. The SRSs of several pieces of UE transmitted in the last SC-FDMA of the same subframe may be segmented based on the frequency location. Unlike in a PUSCH, an SRS is transmitted without performing Discrete Fourier Transform (DFT) operation for conversion into SC-FDMA on the SRS and without using a precoding matrix used in a PUSCH.

Furthermore, a region that belongs to one subframe and in which a demodulation-Reference Signal (DMRS) for a PUSCH is transmitted is the section in which an SC-FDMA symbol placed at the center of each slot in a time axis is present. Likewise, a DMRS is transmitted through a data transmission band in a frequency. For example, as in the example of FIG. 13, in a subframe to which a normal CP is applied, a DMRS is transmitted in a fourth SC-FDMA symbol and an eleventh SC-FDMA symbol. In contrast, in a subframe to which an extended CP is applied, a DMRS is transmitted through third and ninth SC-FDMA symbols.

A DMRS may be combined with the transmission of a PUSCH or PUCCH. An SRS is a reference signal transmitted from UE to a BS for uplink scheduling. A BS estimates an UL channel through a received SRS and uses the estimated UL channel in uplink scheduling. An SRS is not combined with the transmission of a PUSCH or PUCCH.

The same type of base sequence may be used for a DMRS and an SRS. In uplink multiple antenna transmission, precoding applied to a DMRS may be the same as precoding applied to a PUSCH.

A DMRS for a PUSCH is described in more detail below.

A reference signal sequence r_{u,v}^{(α)}(n) may be defined as in Equation 6 using the cyclic shift α of a base sequence r̅_{u,v}(n).

[Equation 6]

r_{u,v}^{(α)}(n)=e^{jαn}r̅_{u,v} (n),

In Equation 6, the length of the reference signal sequence is M_{sc}^{RS}=nM_{sc}^{RB}. In this case, N_{sc}^{RB} means the size of a resource block in a frequency domain, and is expressed by the number of subcarriers. Furthermore, m is 1≦m≦N_{RB}^{max,UL}.

Multiple reference signal sequences may be defined based on a single base sequence through different cyclic shifts values α.

The base sequences r̅_{u,v}(n) are classified into groups. In this case, u ∈ {0,1, . . . 29} denotes a group number, and v denotes a base sequence number within each group.

Each group includes one base sequence ν=0 having a length of M_{sc}^{RD}=mN_{sc}^{RB} (1≦m≦5) and two base sequences ν=0,1 each having a length of M_{sc}^{RS}=mN_{sc}^{RB} (6≦m≦N_{RB}^{max,UL}).

The base sequence r̅_{u,v} (0), . . . , r̅_{u,v} (M_{sc}^{RB}=1) is differently defined depending on the sequence length M_{sc}^{RS}.
1) If the length of the base sequence is equal to or greater than 3N_{sc}^{RB} (M_{sc}^{RS}≧3N_{sc}^{RB}), the base sequence r̅_{u,v} (0), . . . , r̅_{u,v} (M_{sc}^{RS}−1) may be defined as in Equation 7 below.

[Equation 7]

r̅_{u,v} (n)=x_{q} (n mod N_{ZC}^{RS}), 0≦n<M_{sc}^{RS}

In Equation 7, the length N_{ZC}^{RS} of a Zadoff-Chu (ZC) sequence may be defined as a maximum prime number that satisfies N_{ZC}^{RS}<M_{sc}^{RS}.

A qth root Zadoff-Chu (ZC) sequence may be defined as in Equation 8 below.

$${x}_{q} ( m ) = {e}^{- j \frac{π qm ( m + 1 )}{{N}_{ZC}^{RS}}} , 0 \leq m \leq {N}_{ZC}^{RS} - 1 \\ q = ⌊ \overline{q} + 1 \text{/} 2 ⌋ + v \cdot {( - 1 )}^{⌊ 2 \overline{q} ⌋} \\ \overline{q} = {N}_{ZC}^{RS} \cdot ( u + 1 ) / 31 \qquad [ Equation 8 ]$$

2) If the length of the base sequence is smaller than 3N_{sc}^{RB} (M_{sc}^{RS}=N_{sc}^{RB} or M_{sc}^{RS}=2N_{sc}^{RB}), the base sequence may be defined as in Equation 9 below.

[Equation 9]

r̅_{u,v} (n)=e^{jφ(n)π/4}, 0≦n≦M_{sc}^{RS}−1

In the case of M_{sc}^{RS}=N_{sc}^{RB}, φ(n) in Equation 9 may be defined as in Table 14 below for each base sequence group.

TABLE 14

| u | φ(0), . . . , φ(11) | | | | | | | | | | | |
|---|---|---|---|---|---|---|---|---|---|---|---|---|
| 0 | −1 | 1 | 3 | −3 | 3 | 3 | 1 | 1 | 3 | 1 | −3 | 3 |
| 1 | 1 | 1 | 3 | 3 | 3 | −1 | 1 | −3 | −3 | 1 | −3 | 3 |
| 2 | 1 | 1 | −3 | −3 | −3 | −1 | −3 | −3 | 1 | −3 | 1 | −1 |
| 3 | −1 | 1 | 1 | 1 | 1 | −1 | −3 | −3 | 1 | −3 | 3 | −1 |
| 4 | −1 | 3 | 1 | −1 | 1 | −1 | −3 | −1 | 1 | −1 | 1 | 3 |
| 5 | 1 | −3 | 3 | −1 | −1 | 1 | 1 | −1 | −1 | 3 | −3 | 1 |
| 6 | −1 | 3 | −3 | −3 | −3 | 3 | 1 | −1 | 3 | 3 | −3 | 1 |
| 7 | −3 | −1 | −1 | −1 | 1 | −3 | 3 | −1 | 1 | −3 | 3 | 1 |
| 8 | 1 | −3 | 3 | 1 | −1 | −1 | −1 | 1 | 1 | 3 | −1 | 1 |
| 9 | 1 | −3 | −1 | 3 | 3 | −1 | −3 | 1 | 1 | 1 | 1 | 1 |
| 10 | −1 | 3 | −1 | 1 | 1 | −3 | −3 | −1 | −3 | −3 | 3 | −1 |
| 11 | 3 | 1 | −1 | −1 | 3 | 3 | −3 | 1 | 3 | 1 | 3 | 3 |
| 12 | 1 | −3 | 1 | 1 | −3 | 1 | 1 | 1 | −3 | −3 | −3 | 1 |
| 13 | 3 | 3 | −3 | 3 | −3 | 1 | 1 | 3 | −1 | −3 | 3 | 3 |
| 14 | −3 | 1 | −1 | −3 | −1 | 3 | 1 | 3 | 3 | 3 | −1 | 1 |
| 15 | 3 | −1 | 1 | −3 | −1 | −1 | 1 | 1 | 3 | 1 | −1 | −3 |
| 16 | 1 | 3 | 1 | −1 | 1 | 3 | 3 | 3 | −1 | −1 | 3 | −1 |
| 17 | −3 | 1 | 1 | 3 | −3 | 3 | −3 | −3 | 3 | 1 | 3 | −1 |
| 18 | −3 | 3 | 1 | 1 | −3 | 1 | −3 | −3 | −1 | −1 | 1 | −3 |
| 19 | −1 | 3 | 1 | 3 | 1 | −1 | −1 | 3 | −3 | −1 | −3 | −1 |
| 20 | −1 | −3 | 1 | 1 | 1 | 1 | 3 | 1 | −1 | 1 | −3 | −1 |
| 21 | −1 | 3 | −1 | 1 | −3 | −3 | −3 | −3 | −3 | 1 | −1 | −3 |
| 22 | 1 | 1 | −3 | −3 | −3 | −3 | −1 | 3 | −3 | 1 | −3 | 3 |
| 23 | 1 | 1 | −1 | −3 | −1 | −3 | 1 | −1 | 1 | 3 | −1 | 1 |
| 24 | 1 | 1 | 3 | 1 | 3 | 3 | −1 | 1 | −1 | −3 | −3 | 1 |
| 25 | 1 | −3 | 3 | 3 | 1 | 3 | 3 | 1 | −3 | −1 | −1 | 3 |
| 26 | 1 | 3 | −3 | −3 | 3 | −3 | 1 | −1 | −1 | 3 | −1 | −3 |
| 27 | −3 | −1 | −3 | −1 | −3 | 3 | 1 | −1 | 1 | 3 | −3 | −3 |
| 28 | −1 | 3 | −3 | 3 | −1 | 3 | 3 | −3 | 3 | 3 | −1 | −1 |
| 29 | 3 | −3 | −3 | −1 | −1 | −3 | −1 | 3 | −3 | 3 | 1 | −1 |

In the case of M_{sc}^{RS}=2N_{sc}^{RB}, φ(n) in Equation 9 may be defined as in Table 15 below for each base sequence group.

TABLE 15

| u | φ(0), . . . , φ(23) | | | | | | | | | | | | | | | | | | | | | | | |
|---|---|---|---|---|---|---|---|---|---|---|---|---|---|---|---|---|---|---|---|---|---|---|---|---|
| 0 | −1 | 3 | 1 | −3 | 3 | −1 | 1 | 3 | −3 | 3 | 1 | 3 | −3 | 3 | 1 | 1 | −1 | 1 | 3 | −3 | 3 | −3 | −1 | −3 |
| 1 | −3 | 3 | −3 | −3 | −3 | 1 | −3 | −3 | 3 | −1 | 1 | 1 | 1 | 3 | 1 | −1 | 3 | −3 | −3 | 1 | 3 | 1 | 1 | −3 |
| 2 | 3 | −1 | 3 | 3 | 1 | 1 | −3 | 3 | 3 | 3 | 3 | 1 | −1 | 3 | −1 | 1 | 1 | −1 | −3 | −1 | −1 | 1 | 3 | 3 |
| 3 | −1 | −3 | 1 | 1 | 3 | −3 | 1 | 1 | −3 | −1 | −1 | 1 | 3 | 1 | 3 | 1 | −1 | 3 | 1 | 1 | −3 | −1 | −3 | −1 |
| 4 | −1 | −1 | −1 | −3 | −3 | −1 | 1 | 1 | 3 | 3 | −1 | 3 | −1 | 1 | −1 | −3 | 1 | −1 | −3 | −3 | 1 | −3 | −1 | −1 |
| 5 | −3 | 1 | 1 | 3 | −1 | 1 | 3 | 1 | −3 | 1 | −3 | 1 | 1 | −1 | −1 | 1 | −1 | −3 | 3 | −3 | −3 | −3 | 1 | 1 |
| 6 | 1 | 1 | −1 | −1 | 3 | −3 | −3 | 3 | −3 | 1 | −1 | −1 | 1 | −1 | 1 | 1 | −1 | −3 | −1 | 1 | −1 | 3 | −1 | −3 |
| 7 | −3 | 3 | 3 | −1 | −1 | −3 | −1 | 3 | 1 | 3 | 1 | 3 | 1 | 1 | −1 | 3 | 1 | −1 | 1 | 3 | −3 | −1 | −1 | 1 |
| 8 | −3 | 1 | 3 | −3 | 1 | −1 | −3 | 3 | −3 | 3 | −1 | −1 | −1 | −1 | 1 | −3 | −3 | −3 | 1 | −3 | −3 | −3 | 1 | −3 |
| 9 | 1 | 1 | −3 | 3 | 3 | −1 | −3 | −1 | 3 | −3 | 3 | 3 | 3 | −1 | 1 | 1 | −3 | 1 | −1 | 1 | 1 | −3 | 1 | 1 |
| 10 | −1 | 1 | −3 | −3 | 3 | −1 | 3 | −1 | −1 | −3 | −3 | −3 | −1 | −3 | −3 | 1 | −1 | 1 | 3 | 3 | −1 | 1 | −1 | 3 |
| 11 | 1 | 3 | 3 | −3 | −3 | 1 | 3 | 1 | −1 | −3 | −3 | −3 | 3 | 3 | −3 | 3 | 3 | −1 | −3 | 3 | −1 | 1 | −3 | 1 |
| 12 | 1 | 3 | 3 | 1 | 1 | 1 | −1 | −1 | 1 | −3 | 3 | −1 | 1 | 1 | −3 | 3 | 3 | −1 | −3 | 3 | −3 | −1 | −3 | −1 |
| 13 | 3 | −1 | −1 | −1 | −1 | −3 | −1 | 3 | 3 | 1 | −1 | 1 | 3 | 3 | 3 | −1 | 1 | 1 | −3 | 1 | 3 | −1 | −3 | 3 |
| 14 | −3 | −3 | 3 | 1 | 3 | 1 | −3 | 3 | 1 | 3 | 1 | 1 | 3 | 3 | −1 | −1 | −3 | 1 | −3 | −1 | 3 | 1 | 1 | 3 |
| 15 | −1 | −1 | 1 | −3 | 1 | 3 | −3 | 1 | −1 | −3 | −1 | 3 | 1 | 3 | 1 | −1 | −3 | −3 | −1 | −1 | −3 | −3 | −3 | −1 |
| 16 | −1 | −3 | 3 | −1 | −1 | −1 | −1 | 1 | 1 | −3 | 3 | 1 | 3 | 3 | 1 | −1 | 1 | −3 | 1 | −3 | 1 | 1 | −3 | −1 |
| 17 | 1 | 3 | −1 | 3 | 3 | −1 | −3 | 1 | −1 | −3 | 3 | 3 | 3 | −1 | 1 | 1 | 3 | −1 | −3 | −1 | 3 | −1 | −1 | −1 |
| 18 | 1 | 1 | 1 | 1 | 1 | −1 | 3 | −1 | −3 | 1 | 1 | 3 | −3 | 1 | −3 | −1 | 1 | 1 | −3 | −3 | 3 | 1 | 1 | −3 |
| 19 | 1 | 3 | 3 | 1 | −1 | −3 | 3 | −1 | 3 | 3 | 3 | −3 | 1 | −1 | 1 | −1 | −3 | −1 | 1 | 3 | −1 | 3 | −3 | −3 |
| 20 | −1 | −3 | 3 | −3 | −3 | −3 | −1 | −1 | −3 | −1 | −3 | 3 | 1 | 3 | −3 | −1 | 3 | −1 | 1 | −1 | 3 | −3 | 1 | −1 |
| 21 | −3 | −3 | 1 | 1 | −1 | 1 | −1 | 1 | −1 | 3 | 1 | −3 | −1 | 1 | −1 | 1 | −1 | −1 | 3 | 3 | −3 | −1 | 1 | −3 |
| 22 | −3 | −1 | −3 | 3 | 1 | −1 | −3 | −1 | −3 | −3 | 3 | −3 | 3 | −3 | −1 | 1 | 3 | 1 | −3 | 1 | 3 | 3 | −1 | −3 |
| 23 | −1 | −1 | −1 | −1 | 3 | 3 | 3 | 1 | 3 | 3 | −3 | 1 | 3 | −1 | 3 | −1 | 3 | 3 | −3 | 3 | 1 | −1 | 3 | 3 |
| 24 | 1 | −1 | 3 | 3 | −1 | −3 | 3 | −3 | −1 | −1 | 3 | −1 | 3 | −1 | −1 | 1 | 1 | 1 | 1 | −1 | −1 | −3 | −1 | 3 |
| 25 | 1 | −1 | 1 | −1 | 3 | −1 | 3 | 1 | 1 | −1 | −1 | −3 | 1 | 1 | −3 | 1 | 3 | −3 | 1 | 1 | −3 | −3 | −1 | −1 |
| 26 | −3 | −1 | 1 | 3 | 1 | 1 | −3 | −1 | −1 | −3 | 3 | −3 | 3 | 1 | −3 | 3 | −3 | 1 | −1 | 1 | −3 | 1 | 1 | 1 |
| 27 | −1 | −3 | 3 | 3 | 1 | 1 | 3 | −1 | −3 | −1 | −1 | −1 | 3 | 1 | −3 | −3 | −1 | 3 | −3 | −1 | −3 | −1 | −3 | −1 |
| 28 | −1 | −3 | −1 | −1 | 1 | −3 | −1 | −1 | 1 | −1 | −3 | 1 | 1 | −3 | 1 | −3 | −3 | 3 | 1 | 1 | −1 | 3 | −1 | −1 |
| 29 | 1 | 1 | −1 | −1 | −3 | −1 | 3 | −1 | 3 | −1 | 1 | 3 | 1 | −1 | 3 | 1 | 3 | −3 | −3 | 1 | −1 | −1 | 1 | 3 |

A PUSCH demodulation reference signal sequence r_{PUSCH}^{(λ)} (·) related to a layer index λ ∈ {0,1, . . . , ν−1} may be defined as in Equation 10.

[Equation 10]

r_{PUSCH}^{(λ)} (m·M_{sc}^{RS}+n)=w^{(λ)} (m)r_{u,v}^{(α}_{λ}) (n)

m=0,1

n=0, . . . , M_{sc}^{RS}−1

M_{sc}^{RS}=M_{sc}^{PUSCH}

In Equation 10,M_{sc}^{PUSCH} means a bandwidth scheduled for uplink transmission, and is expressed by the number of subcarriers.

As described above, r_{u,v}^{(α}^{_{λ}}⁾ (0), . . . , r_{u,v}^{(α}^{_{λ}}⁾ (M_{sc}^{RS}−1) denotes a reference signal sequence in which a cyclic shift value α_{λ} has been applied to the base sequence r̅_{u,v}(n).

An orthogonal sequence w^{(λ)}(m) is set like [w^{λ}(0) w^{λ}(1)]=[1 1] in the DCI format 0 if a high layer parameter “Activate-DMRS-with OCC” has not been set or a temporary C-RNTI is used to send the most recent uplink-related DCI for a transport block related to the transmission of a corresponding PUSCH.

If not, the orthogonal sequence w^{(λ)}(m) may be set as in Table 17 below based on a “cyclic shift field” included in the most recent uplink-related DCI for a transport block related to the transmission of a corresponding PUSCH.

In [w^{(λ)}(0) w^{(λ)} (1)], w^{(λ}(0) is a value applied to the first slot of a layer index λ, and w^{(λ)} (1) is a value applied to the second slot of the layer index λ.

IN a slot number nₛ, a cyclic shift value α_{λ} may be defined as in Equation 11 below.

[Equation 11]

α_{λ}=2πn_{cs,λ}/12

In Equation 11, n_{cs,λ} may be defined like Equation 12 below.

[Equation 12]

n_{cs,λ}=(n_{DMRS}⁽¹⁾+n_{DMRS,λ}⁽²⁾+n_{PN}(nₛ))mod 12

In Equation 12, a value n_{DMRS}⁽¹⁾ is indicated by a high layer parameter “cyclicShift.” The high layer parameter “cyclicShift” is transmitted through a high layer message (e.g., an RRC connection setup message).

Table 16 illustrates a corresponding relationship between parameter values “cyclicShift” and values n_{DMRS}⁽¹⁾.

TABLE 16

| cyclicShift | n⁽¹⁾_{DMRS} |
|---|---|
| 0 | 0 |
| 1 | 2 |
| 2 | 3 |
| 3 | 4 |
| 4 | 6 |
| 5 | 8 |
| 6 | 9 |
| 7 | 10 |

In Equation 12, n_{DMRS,λ}⁽²⁾ is defined by the three bits of a cyclic shift for a DMRS field transferred within the most recent uplink-related DCI for a transport block related to the transmission of a corresponding PUSCH, and the value n_{DMRS,λ}⁽²⁾ is defined as in Table 17. Table 17 illustrates a corresponding relationship between cyclic shift fields within an uplink-related DCI, n_{DMRS,80} ⁽²⁾, and [w^{(μ)} (0) w^{(λ)} (1)].

TABLE 17

| Cyclic shift | | | | | | | | |
|---|---|---|---|---|---|---|---|---|
| field in | | | | | | | | |
| uplink- | | | | | | | | |
| related DCI | n_{DMRS, λ}⁽²⁾ | | | | [w^{(λ)}(0) w^{(λ)}(1)] | | | |
| format | λ = 0 | λ = 1 | λ = 2 | λ = 3 | λ = 0 | λ = 1 | λ = 2 | λ = 3 |
| 000 | 0 | 6 | 3 | 9 | [1 1] | [1 1] | [1 −1] | [1 −1] |
| 001 | 6 | 0 | 9 | 3 | [1 −1] | [1 −1] | [1 1] | [1 1] |
| 010 | 3 | 9 | 6 | 0 | [1 −1] | [1 −1] | [1 1] | [1 1] |
| 011 | 4 | 10 | 7 | 1 | [1 1] | [1 1] | [1 1] | [1 1] |

The first column in Table 17 may be used as the values n_{DMRS,0} ⁽²⁾ and w^{(λ)} (m) if there is no uplink-related DCI for the same transport block related to the transmission of a corresponding PUSCH and in the case of the following cases.
If the first PUSCH for the same transport block has been semi-persistently scheduled, or
If the first PUSCH for the same transport block has been scheduled by a random access response grant,

In Equation 12, the value n_{PN} (nₛ) may be defined as in Equation 13 below.

[Equation 13]

n_{PN} (nₛ)=Σᵢ₌₀⁷ c(8N_{symb}^{UL}·nₛ+i)·2ⁱ

In Equation 13, c(i) is a pseudo-random sequence and a cell-specific value.

### Buffer Status Reporting (BSR)

FIG. 14 illustrates the MAC PDU used in the MAC entity in the wireless communication system to which the present invention can be applied.

Referring to FIG. 14, the MAC PDU includes a MAC header, at least one MAC service data unit (SDU) and at least one control element, additionally may include a padding. In some cases, at least one of the MAC SDUs and the MAC control elements may not be included in the MAC PDU.

As an example of FIG. 14, it is common that the MAC control elements are located ahead of the MAC SDUs. And the size of MAC control elements may be fixed or changeable.

In case that the size of MAC control elements is changeable, it may be determined through an extended bit whether the size of MAC control elements is extended. The size of MAC SDU may be also variable.

The MAC header may include at least one sub-header. In this time, at least one sub-header that is included in the MAC header is respectively corresponding to the MAC SDUs, the MAC control elements and the padding, and the order of the sub-header is same as the arrangement order of the corresponding elements. For example, as an example of FIG. 14, if there are included MAC control element 1, MAC control element 2, a plurality of MAC SDUs and padding in the MAC PDU, in the MAC header, the following may be arranged in order as a sub-header corresponding to the MAC control element 1, a sub-header corresponding to the MAC control element 2, a plurality of sub-headers corresponding to a plurality of MAC SDUs respectively and a sub-header corresponding to the padding.

Sub-headers included in the MAC header, as an example of FIG. 14, six header fields may be included. Particularly, the sub-header may include six header fields of R/R/E/LCID/F/L.

For the sub-header corresponding to the very last one among the sub-header corresponding to the MAC control element of fixed size and data fields included in the MAC PDU, as an example illustrated in FIG. 14, the sub-header that is included four header fields may be used. In case that the sub-header includes four fields like this, the four fields may be R/R/E/LCID.

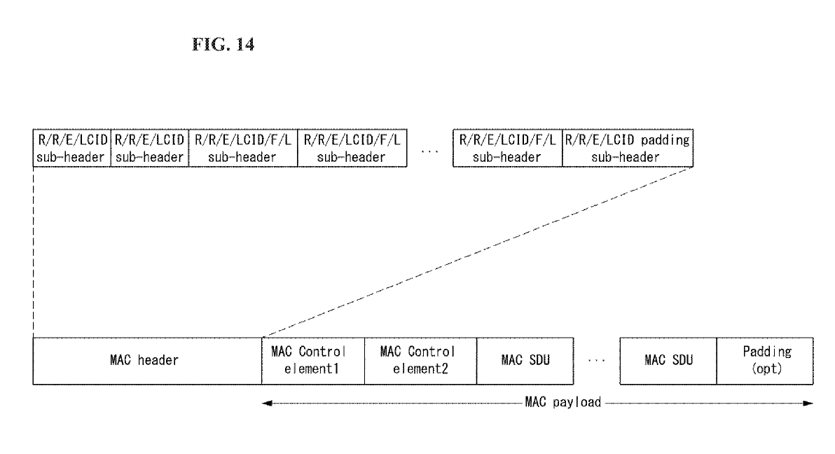

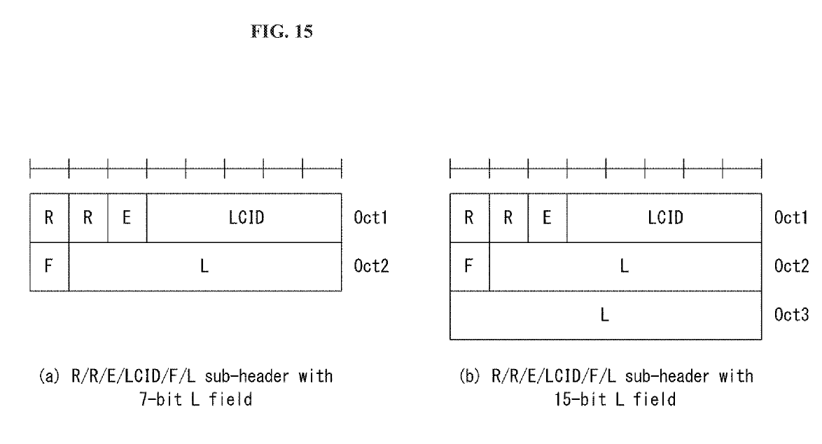

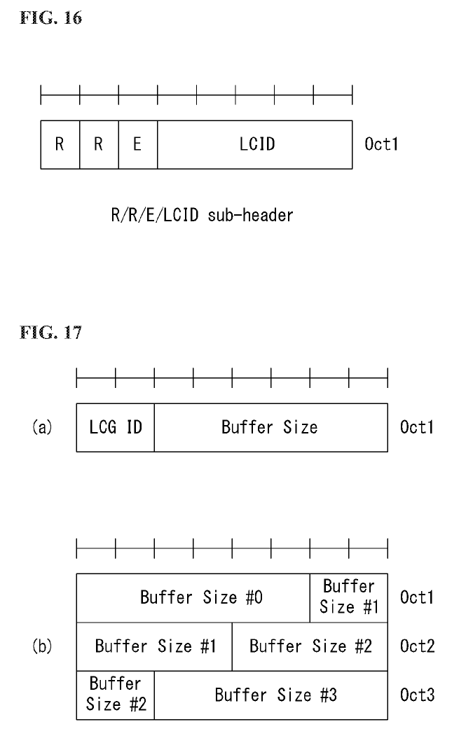

FIG. 15 and FIG. 16 illustrate the sub-header of the MAC PDU in the wireless communication system to which the present invention can be applied.

Each field is described as below with reference to FIG. 15 and FIG. 16.
1) R: Reserved bit, which is not used.
2) E: Extended field, which represents whether the elements corresponding to the sub-header are extended. For example, in case that E field is ‘0’, the element corresponding to the sub-header is terminated without any repeat, and in case that E field is ‘1’, the element corresponding to the sub-header is repeated once more and may be extended by twice in the length.

LCID: Logical channel identification field identifies a logical channel corresponding to the relevant MAC SDU or identifies a type of the relevant MAC control element and padding. If the MAC SDU is associated with the sub-header, it may show which logical channel the MAC SDU is corresponding to, and if the MAC control element is associated with the sub-header, it may show what the MAC control element is.

Table 18 represents the value of LCID for the DL-SCH

TABLE 18

| Index | LCID values |
|---|---|
| 00000 | CCCH |
| 00001-01010 | Identity of the logical channel |
| 01011-11001 | Reserved |
| 11010 | Long DRX Command |
| 11011 | Activation/Deactivation |
| 11100 | UE Contention Resolution Identity |
| 11101 | Timing Advance Command |
| 11110 | DRX Command |
| 11111 | Padding |

Table 19 represents the value of LCID for the UL-SCH

TABLE 19

| Index | LCID values |
|---|---|
| 00000 | CCCH |
| 00001-01010 | Identity of the logical channel |
| 01011-11000 | Reserved |
| 11001 | Extended Power Headroom Report |
| 11010 | Power Headroom Report |
| 11011 | C-RNTI |
| 11100 | Truncated BSR |
| 11101 | Short BSR |
| 11110 | Long BSR |
| 11111 | Padding |

In LTE/LTE-A system, the UE may report the buffer state of its own to the network by configuring one of the index value among truncated BSR, short BSR, and long BSR in the LCID field.

The relationship of mapping between the index and the LCID value illustrated in Table 18 and Table 19 is exemplified for the convenience of the descriptions, but the present invention is not limited thereto.
4) F: Format field, which represents the size of L field.
5) L: Length field, which represents the size of MAC SDU and MAC control element corresponding to the sub-header. If the size of MAC SDU or MAC control element corresponding to the sub-header is equal to or less than 127 bits, the 7-bit L field is used (FIG. 15 (a)), otherwise, the 15-bit L field may be used (FIG. 15 (b)). In case that the size of MAC control element is changeable, the size of MAC control element may be defined by the L field. In case that the size of MAC control element is fixed, the size of MAC control element may be determined without the size of MAC control element being defined by the L field, accordingly the F and L field may be omitted as shown in FIG. 16.

FIG. 17 illustrates formats of the MAC control elements in order to report the buffer state in the wireless communication system to which the present invention can be applied.

In case of the truncated BSR and short BSR being defined in the LCID field of sub-header, the MAC control element corresponding to the sub-header, as shown in FIG. 17 (a), may be configured to include one logical channel group identification (LCG ID) field and one buffer size field indicating the buffer state of the LCG. The LCG ID field is for identifying the logical channel group that is required to report the buffer state, which may have the size of 2 bits.

The buffer size field is used for identifying the total amount of available data from the all logical channels that are included in the LCG. The available data includes all the data that are going to be transmitted from the RLC layer and the PDCP layer, and the amount of data is represented in byte. In this time, the size of RLC header and MAC header may be excluded when calculating the amount of data. The buffer size field may be 6 bits.

In case of the extended BSR being defined in the LCID field of sub-header, the MAC control element corresponding to the sub-header, as shown in FIG. 17 (b), may include four buffer size fields indicating the buffer state of four groups having 0 to 3 LCG IDs. Each of the buffer size fields may be used for identifying the total amount of available data from different logical channel groups.

### Multi-Input Multi-Output (MIMO)

In a MIMO technology, multiple transmission (Tx) antennas and multiple reception (Rx) antennas are used unlike in an existing technology in which a single transmission antenna and a single reception antenna are used. In other words, the MIMO technology is a technology for attempting to increase the capacity or improve performance using MIMO antennas in the transmission stage or reception stage of a wireless communication system. Hereinafter, “MIMO” is called a “MIMO antenna.”

More specifically, in the MIMO antenna technology, in order to receive one total message, total data is completed by collecting a plurality of data pieces received through several antennas without depending on a single antenna path. Consequently, the MIMO antenna technology can increase a data rate in a specific system range and can increase a system range through a specific data rate.

Next-generation mobile communication is expected that it will require an efficiency MIMO antenna technology because it requires a much higher data rate than existing mobile communication. In this situation, the MIMO communication technology is the next-generation mobile communication technology that may be widely used in mobile communication terminals and relays and has been in the spotlight as a technology capable of overcoming a limit to the transfer amount of mobile communication that is different depending on a limit situation due to the expansion of data communication.

The MIMO antenna technology of various transmission efficiency improvement technologies that are now being developed is a method capable of significantly improving a communication capacity and transmission and reception performance without additional frequency assignment or power increase and has been in the most spotlight.

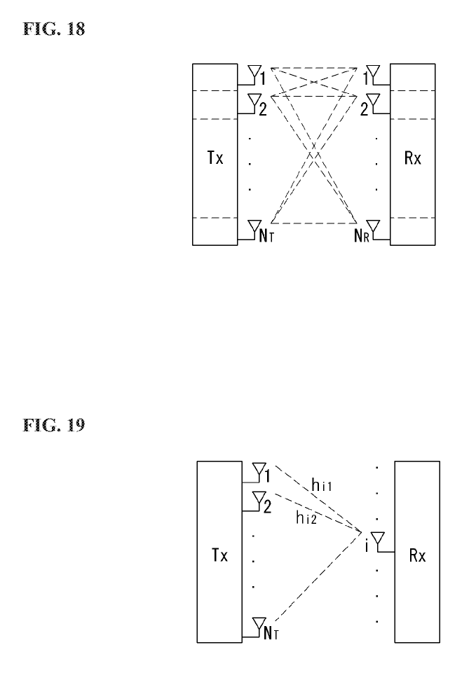

FIG. 18 illustrates the configuration of a MIMO communication system in a wireless communication system to which an embodiment of the present invention may be applied. Referring to FIG. 18, if the number of transmission antennas is increased to NT and the number of reception antennas is increased to NR at the same time, a transfer rate can be improved and frequency efficiency can be significantly improved because a theoretical channel transfer capacity is increased in proportion to the number of antennas unlike in a case where a plurality of antennas is used only in a transmitter or receiver. In this case, the transfer rate according to an increase of the channel transfer capacity can be theoretically increased by the degree in which a maximum transfer rate Ro when one antenna is multiplied by the following rate increase rate Ri.

[Equation 14]

Rᵢ=min(N_{T},N_{R})

That is, for example, in a MIMO communication system using four transmission antennas and four reception antennas, a quadruple transfer rate can be theoretically obtained compared to a single antenna system.

Such a MIMO antenna technology maybe divided into a spatial diversity method for increasing transfer reliability using symbols passing through various channel paths and a spatial multiplexing method for improving a transfer rate by sending a plurality of data symbols at the same time using a plurality of transmission antennas. Furthermore, active research has recently been carried out on methods in order to properly obtain the advantages of the two methods by properly combining the two methods.

Each of the methods is described in more detail below.

First, the spatial diversity method is a spatiotemporal Trelis code series method using spatiotemporal block code series, a diversity gain, and a coding gain at the same time. In general, the Trelis code method is excellent in bit error rate improvement performance and the degree of freedom of code generation, but the spatiotemporal block code is simple in operational complexity. Such a spatial diversity gain may be obtained by an amount corresponding to the product NT x NR of the number of transmission antennas NT and the number of reception antennas NR.

Second, the spatial multiplexing scheme is a method of sending different data streams in respective transmission antennas. In this case, mutual interference is generated in a receiver between data simultaneously transmitted by transmitters. The receiver removes such interference using a proper signal processing scheme and receives the data. A noise cancelling method used in this case may include a Maximum Likelihood Detection (MLD) receiver, a Zero-Forcing (ZF) receiver, a Minimum Mean Square Error (MMSE) receiver, Diagonal-Bell Laboratories Layered Space-Time (D-BLAST), and Vertical-Bell Laboratories Layered Space-Time (V-BLAST). In particular, a Singular Value Decomposition (SVD) method may be used if channel information is known to a transmission stage.

Third, there may be schemes in which spatial diversity and spatial multiplexing are combined. If a spatial diversity gain is to be obtained, a performance improvement gain according to an increase in the dimension of diversity is gradually saturated. If only a spatial multiplexing gain is adopted, transmission reliability in a radio channel is deteriorated. Research has been carried out on methods for obtaining both the gains while solving the problems. The methods may include a spatiotemporal double-STTD method and a spatiotemporal BICM (STBICM) method.

A communication method in a MIMO antenna system, such as that described above, may be mathematically modeled as follows in order to describe the communication method in more detail.

First, as illustrated in FIG. 18, NT transmission antennas and NR reception antennas are assumed to be present.

First, if the NT transmission antennas are present as described above, a maximum number of pieces of information that may be transmitted is NT, which may be expressed by the following vector.

[Equation 15]

s=[s₁, s₂, . . . , s_{N}_{_{T}}]^{T}

Transmission power may be different in each of pieces of transmission information s1, s2, . . . , sNT. In this case, if the pieces of transmission power are assumed to be P1, P2, . . . , PNT, the pieces of transmission information each having controlled transmission power may be expressed by the following vector.

[Equation 16]

ŝ=[ŝ₁, ŝ₂, . . . , ŝ_{N}_{_{T}}]^{T}=[P₁s₁, P₂s₂, . . . , P_{N}_{_{T}} s_{N}_{_{T}}]^{T}

Furthermore, ŝ is the diagonal matrix P of the transmission power and may be expressed as in the diagonal matrix P.

$$\hat{s} = [ \begin{matrix}{P}_{1} & & & 0 \\ & {P}_{2} & & \\ & & ⋱ & \\ 0 & & & {P}_{{N}_{T}}\end{matrix} ] [ \begin{matrix}{s}_{1} \\ {s}_{2} \\ ⋮ \\ {s}_{{N}_{T}}\end{matrix} ] = Ps \qquad [ Equation 17 ]$$

The information vector ŝ having controlled transmission power is multiplied by a weight matrix W, thus forming NT transmission signals x1, x2, . . . , xNT that are actually transmitted. In this case, the weight matrix functions to properly distribute pieces of transmission information to respective antennas according to a transmission channel situation. Those transmission signals x1, x2, . . . , xNT may be expressed as follows using a vector x.

$$x = [ \begin{matrix}{x}_{1} \\ {x}_{2} \\ ⋮ \\ {x}_{i} \\ ⋮ \\ {x}_{{N}_{T}}\end{matrix} ] [ \begin{matrix}{w}_{11} & {w}_{12} & ⋯ & {w}_{1 {N}_{T}} \\ {w}_{21} & {w}_{22} & ⋯ & {w}_{2 {N}_{T}} \\ ⋮ & & ⋱ & \\ {w}_{i 1} & {w}_{i 2} & ⋯ & {w}_{{iN}_{T}} \\ ⋮ & & ⋱ & \\ {w}_{{N}_{T} 1} & {w}_{{N}_{T} 2} & ⋯ & {w}_{{N}_{T} {N}_{T}}\end{matrix} ] [ \begin{matrix}{\hat{s}}_{1} \\ {\hat{s}}_{2} \\ ⋮ \\ {\hat{s}}_{j} \\ ⋮ \\ {\hat{s}}_{{N}_{T}}\end{matrix} ] = W \hat{s} = WPs \qquad [ Equation 18 ]$$

In this case, wij denotes weight between an ith transmission antenna and jth transmission information, and W is the matrix of the weight. Such matrix W is called a weight matrix or precoding matrix.

The transmission signal x, such as that described above, may be considered to be divided into a case where spatial diversity is used and a case where spatial multiplexing is used. If spatial multiplexing is used, all the elements of an information vector “s” have different values because different signals are multiplexed and transmitted. In contrast, if spatial diversity is used, all the elements of an information vector “s” have the same value because the same signal is transmitted through several channel paths.

A method in which spatial multiplexing and spatial diversity are mixed may be taken into consideration. That is, for example, a case where the same signal is transmitted using spatial diversity through three transmission antennas and different signals are subject to spatial multiplexing and transmitted through the remaining antennas.

If NR reception antennas are used, the reception signals y1, y2, . . . , yNR of the respective antennas are expressed by a vector “y” as follows.

[Equation 19]

y=[y₁, y₂, . . . , y_{N}_{_{R}}]^{T}

If channels in a MIMO antenna communication system are to be modeled, the channels may be sorted based on their transmission and reception antenna indices. A channel from a transmission antenna “j” to a reception antenna “i” is expressed by hij. In this case, it is to be noted that in order of the index hij, the index of the reception antenna is the first and the index of the transmission antenna is next.

Some of those channels may be bundled and expressed in a vector and matrix form. For example, the expression of a vector is described as follows.

FIG. 19 is a diagram illustrating channels from a plurality of transmission antennas to a single reception antenna in a wireless communication system to which an embodiment of the present invention may be applied.

As illustrated in FIG. 19, channels from a total of NT transmission antennas to a reception antenna “i” may be expressed as follows.

[Equation 20]

hᵢ^{T}=[hᵢ₁, hᵢ₂, . . . , h_{iN}_{_{R}}]

Furthermore, a case where all the channels from the NT transmission antennas to an NR reception antenna may be expressed as follows through a matrix expression, such as Equation 20.

$$H = [ \begin{matrix}{h}_{1}^{T} \\ {h}_{2}^{T} \\ ⋮ \\ {h}_{i}^{T} \\ ⋮ \\ {h}_{{N}_{R}}^{T}\end{matrix} ] [ \begin{matrix}{h}_{11} & {h}_{12} & ⋯ & {h}_{1 {N}_{T}} \\ {h}_{21} & {h}_{22} & ⋯ & {h}_{2 {N}_{T}} \\ ⋮ & & ⋱ & \\ {h}_{i 1} & {h}_{i 2} & ⋯ & {h}_{{iN}_{T}} \\ ⋮ & & ⋱ & \\ {h}_{{N}_{R} 1} & {h}_{{N}_{R} 2} & ⋯ & {h}_{{N}_{R} {N}_{T}}\end{matrix} ] \qquad [ Equation 21 ]$$

An actual channel experiences the aforementioned channel matrix H and added to Additive White Gaussian Noise (AWGN). Accordingly, AWGNs n1, n2, . . . , nNR added to the respective NR reception antennas may be expressed as follows using a vector.

[Equation 22]

n=[n₁, n₂, . . . , n_{N}_{_{R}}]^{T}

The aforementioned transmission signal, reception signal, channel, and AWGN may be expressed through the following relation in a MIMO antenna communication system through modeling.

$$y = [ \begin{matrix}{y}_{1} \\ {y}_{2} \\ ⋮ \\ {y}_{i} \\ ⋮ \\ {y}_{{N}_{R}}\end{matrix} ] = [ \begin{matrix}{h}_{11} & {h}_{12} & ⋯ & {h}_{1 {N}_{T}} \\ {h}_{21} & {h}_{22} & ⋯ & {h}_{2 {N}_{T}} \\ ⋮ & & ⋱ & \\ {h}_{i 1} & {h}_{i 2} & ⋯ & {h}_{{iN}_{T}} \\ ⋮ & & ⋱ & \\ {h}_{{N}_{R} 1} & {h}_{{N}_{R} 2} & ⋯ & {h}_{{N}_{R} {N}_{T}}\end{matrix} ] [ \begin{matrix}{x}_{1} \\ {x}_{2} \\ ⋮ \\ {x}_{j} \\ ⋮ \\ {x}_{{N}_{T}}\end{matrix} ] + [ \begin{matrix}{n}_{1} \\ {n}_{2} \\ ⋮ \\ {n}_{i} \\ ⋮ \\ {n}_{{N}_{R}}\end{matrix} ] = Hx + n \qquad [ Equation 23 ]$$

The MIMO antenna communication system has been described as being chiefly used by a single user. However, multiuser diversity can be obtained by applying the MIMO antenna communication system to a plurality of users. This is described in brief as follows.

A fading channel is one of well-known major causes that deteriorate performance of a wireless communication system. A channel gain is changed according to time, a frequency, and space, and performance becomes deteriorated as a channel gain value is reduced. Diversity, that is, one of methods for overcoming fading, is based on a probability that all independent channels may have low gains is very small. A variety of diversity methods may be used, and multiuser diversity corresponds to one of the variety of diversity methods.

Assuming that several users are present in a cell, a probability that all the users may have low gains is very small because the channel gains of the users are probabilistically independent. In accordance with an information theory, if a BS has sufficient transmission power and several users are present in a cell, a channel capacity can be maximized by assigning all the channels to a user having the highest channel gain. Multiuser diversity may be divided into three types.

Temporal multiuser diversity is a method for assigning channels to a user having the greatest gain value at each point of time when the channel is changed over time.

Frequency multiuser diversity is a method for assigning subcarriers to a user having the greatest gain in each frequency band in a frequency multiple carriers system, such as OFDM.

If a channel is very slowly changed in a system not using multiple carriers, a user having the highest channel gain may monopolize the channel for a long time. Accordingly, other users are unable to perform communication. In this case, in order to use multiuser diversity, a change of the channel needs to be induced.

Spatial multiuser diversity is a method based on the fact that users have different channel gains according to space. An implementation example of such spatial multiuser diversity may include random beamforming (RBF). RBF is also called “opportunistic beamforming” and is a technology for causing a channel to be changed by performing beamforming based on specific weight using multiple antennas in a transmission stage.

A Multiuser MIMO (MU-MIMO) method using the aforementioned multiuser diversity in a MIMIO antenna method is described below.

In the MU-MIMO method, the number of users and the number of antennas of each user in a transmission/reception stage may have a variety of types of combinations. The MU-MIMO method is described in terms of downlink and uplink.

In the case of downlink, for example, in the extreme case, a single user may receive a signal through a total of NR antennas, and a total of NR users may receive signals using a single antenna. Furthermore, combinations of the aforementioned examples are possible. That is, a specific user may use a single reception antenna, whereas a specific user may use three reception antennas. It is to be noted that a total sum of the number of reception antennas is constant, that is, NR, in either combination. Such a case is commonly called a MIMO Broadcast Channel (BC) or Space Division Multiple Access (SDMA).

In the case of uplink, for example, in the extreme case, a single user may send a signal through a total of NT antennas, and a total of NT users may send signals using a single antenna. Furthermore, middle combinations of the aforementioned examples are possible.

That is, a specific user may use a single transmission antenna, whereas a specific user may use three transmission antennas. It is to be noted that a total sum of the number of transmission antennas is constant in either combination. Such a case is commonly called a MIMO Multiple Access Channel (MAC). Uplink and downlink have a matching relationship, and a scheme used on one side may also be used on the other side.

The number of the rows and columns of a channel matrix H indicative of a channel state is determined by the number of transmission and reception antennas. In the channel matrix H, as described above, the number of rows is equal to the number of reception antennas NR, and the number of columns is equal to the number of transmission antennas NT. That is, the channel matrix H becomes an NR×NT matrix.

In general, the rank of the channel matrix may be defined as a minimum number of the number of independent rows and the number of independent columns. Accordingly, the rank of the channel matrix is not greater than the number of rows or columns. The rank H of the channel matrix H is mathematically limited as follows.

[Equation 24]

rank(H)≦min(N_{T},N_{R})

Furthermore, if the channel matrix is subject to eigen value decomposition, the rank of the channel matrix may be defined as the number of eigen values that belong to eigen value and that are not 0. Likewise, if the channel matrix is subject to Singular Value Decomposition (SVD), the rank of the channel matrix may be defined as the number of singular values other than 0. Accordingly, in the channel matrix, the physical meaning of the rank may be said to be a maximum number capable of sending pieces of different information in a given channel.

In this specification, a “rank” in MIMO transmission indicates the number of paths through which a signal can be independently transmitted in specific frequency resources at a specific point of time. Each of pieces of different information transmitted through the respective paths may be defined as a “layer” or simply “stream.” Accordingly, the “number of layers” denotes the number of pieces of information transmitted through respective paths, and the number of signal streams is not greater than the rank of a channel, that is, a maximum number capable of sending pieces of different information. In this case, a single stream may be transmitted through one or more antennas.

### Carrier Aggregation

A communication environment considered in the embodiments of the present invention includes all multi-carrier environments. That is, a multi-carrier system or a carrier aggregation (CA) system used in the present invention refers to a system for aggregating and utilizing one or more component carriers having a bandwidth smaller than a target bandwidth, for wideband support.

In the present invention, multi-carrier refers to carrier aggregation. Carrier aggregation includes aggregation of contiguous carriers and aggregation of non-contiguous carriers. In addition, the number of component carriers aggregated in downlink and uplink may be differently set. The case where the number and/or bandwidth of downlink component carriers (DL CCs) and the number and bandwidth of uplink component carriers (UL CCs) are the same is referred to as symmetric aggregation and the case where the number and/or bandwidth of downlink component carriers (DL CCs) and the number and bandwidth of uplink component carriers (UL CCs) are different is asymmetric aggregation. Such carrier aggregation is used interchangeable with the terms “carrier aggregation”, “bandwidth aggregation” or “spectrum aggregation”.

Carrier aggregation configured by aggregating two or more CCs aims at support a bandwidth of up to 100 MHz in an LTE-A system. When one or more carriers having a bandwidth smaller than a target bandwidth are aggregated, the bandwidth of the aggregated carriers may be restricted to a bandwidth used in the existing system, for backward compatibility with the existing IMT system. For example, the existing 3GPP LTE system may support bandwidths of 1.4, 3, 5, 10, 15 and 20 MHz and an LTE_Advanced (LTE_A) system evolved from the LTE system may support a bandwidth greater than 20 MHz using only the bandwidths supported by the LTE system. Alternatively, the carrier aggregation system used in the present invention may define a new bandwidth so as to support CA, regardless of the bandwidths used in the existing system.

The above-described carrier aggregation environment may be called a multiple-cell environment. The cell is defined as a combination of downlink resources (DL CCs) and uplink resources (UL CCs), and the uplink resources are not mandatory. Accordingly, the cell may be composed of downlink resources alone or both downlink resources and uplink resources. If a specific UE has one configured serving cell, the UE may have one DL CC and one UL CC. If a specific UE has two or more configured serving cells, the UE may have DL CCs corresponding in number to the number of cells and the number of UL CCs may be equal to or less than the number of DL CCs, and vice versa. If a specific UE has a plurality of configured service cells, a carrier aggregation environment in which the number of DL CCs is greater than the number of UL CCs may also be supported. That is, carrier aggregation may be regarded as aggregation of two or more cells having different carrier frequencies (center frequencies of a cell). If carrier aggregation is supported, linkage between a carrier frequency (or a DL CC) of downlink resources and a carrier frequency (or a UL CC) of uplink resources may be indicated by system information. The DL CC and the UL CC may be referred to as DL cell and UL cell, respectively. The cell described herein should be distinguished from a “cell” as a general region covered by a BS. A cell used in the LTE-A system includes a primary cell (PCell) and a secondary cell (SCell). The PCell and the SCell may be used as service cells. In case of a UE which is in an RRC_connected state but does not set carrier aggregation or supports carrier aggregation, only one serving cell composed of a PCell exists. In contrast, in case of a UE which is in an RRC_CONNECTED state and sets carrier aggregation, one or more serving cells exist. The serving cell includes a PCell and one or more SCell.

A serving cell (PCell and SCell) may be set through an RRC parameter. PhyCellId is a physical layer identifier of a cell and has an integer value from 0 to 503. SCellIndex is a short identifier used to identify an SCell and has an integer value from 1 to 7. A value of 0 is applied to the PCell and SCellIndex is previously given to be applied to the Scell. That is, a cell having a smallest cell ID (or a cell index) in ServCellIndex becomes the PCell.

The PCell refers to a cell operating on a primary frequency (e.g., a primary CC (PCC)).

The PCell is used to perform an initial connection establishment process or a connection re-establishment process at a UE. The PCell may indicate a cell indicated in a handover process. The PCell refers to a cell for performing control-associated communication among serving cells set in a carrier aggregation environment. That is, a UE may receive a PUCCH allocated by a PCell to which the UE belongs and perform transmission and use only the PCell to acquire system information and change a monitoring procedure. In evolved universal terrestrial radio access (E-UTRAN), a UE supporting a carrier aggregation environment may change only the PCell for a handover procedure using an RRCConnectionReconfiguration message of a higher layer including mobilityControllnfo.

The SCell refers to a cell operating on a secondary frequency (e.g., a secondary CC (SCC)). Only one PCell may be allocated to a specific UE and one or more SCells may be allocated to the specific UE. The SCell may be configured after radio resource control (RRC) connection establishment and may be used to provide additional radio resources. A PUCCH is not present in cells except for the PCell among serving cells set in a carrier aggregation environment, that is, the SCells. E-UTRAN may provide all system information associated with the operation of an associated cell in an RRC_CONNECTED state via a dedicated signal when SCells are added to a UE supporting a carrier aggregation environment. Change of system information may be controlled by release and addition of the SCell. At this time, an RRCConnectionReconfiguration message of a higher layer may be used. The E-UTRAN may transmit a dedicated signal having a different parameter to each UE, rather than broadcasting a signal in the associated SCell.

After an initial security activation process begins, an E-UTRAN may configure a network by adding one or more SCells to a PCell initially configured in a connection establishment process. In a carrier aggregation environment, the PCell and the SCell may operate as respective CCs. In the following embodiments, a primary CC (PCC) may be used as the same meaning as the PCell and a secondary CC (SCC) may be used as the meaning as the SCell.

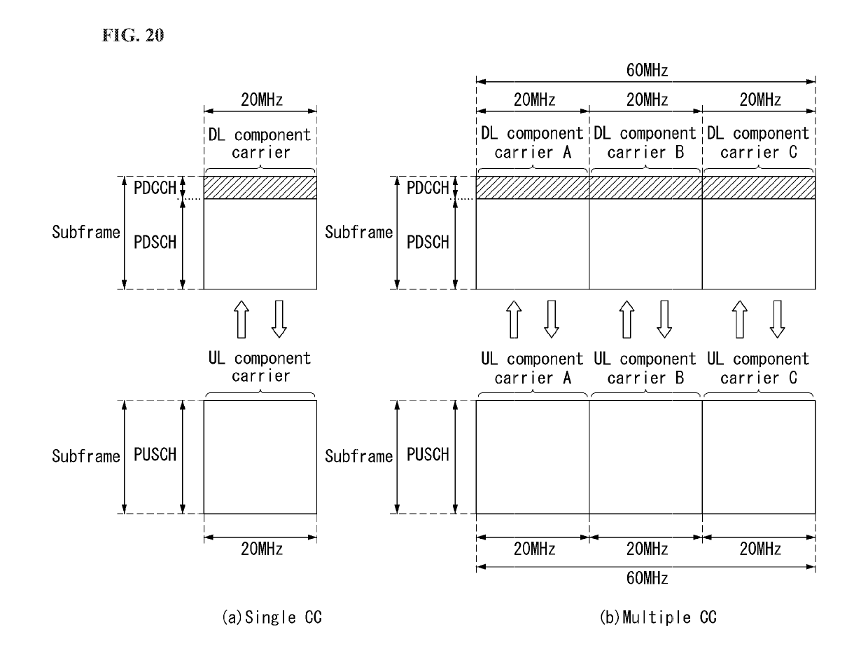

FIG. 20 represents an example of component carrier and carrier aggregation in the wireless communication system to which the present invention can be applied.

FIG. 20 (a) represents a single carrier structure that is used in a LTE system. There are DL CC and UL CC in component carrier. One component carrier may have 20 MHz frequency range.

FIG. 20 (b) represents a carrier aggregation structure that is used in a LTE-A system. FIG. 20 (b) represents a case that three component carriers having 20 MHz frequency are aggregated. There are three DL CCs and UL CCs respectively, but the number of DL CCs and UL CCs are not limited thereto. In case of the carrier aggregation, the UE enables to monitor three CCs at the same time, to receive the DL signal/data, and to transmit the UL signal/data.

If, N DL CCs are managed in a specific cell, the network may allocate M (M≦N) DL CCs. In this case, the UE may monitor the limited M DL CCs only and receive the DL signal. Also, the network may give a priority to L (L≦M≦N) DL CCs and have the prioritized DL CCs allocated to the UE, in this case, the UE should monitor the DL CCs without fail.

This way may be applied for the UL transmission.

The linkage between the DL resource carrier frequency (or DL CC) and the UL resource carrier frequency (or UL CC) may be instructed by a higher layer message like RRC message or system information. For example, the combination of DL resource and UL resource may be configured by the linkage that is defined by system information block type 2 (SIB2). Particularly, the linkage may signify the mapping relationship between the DL CC through which the PDCCH carrying a UL grant is transmitted and the UL CC that uses the UL grant, or signify the mapping relationship between the DL CC (or UL CC) through which the data for HARQ is transmitted and the UL CC (or DL CC) through which the HARQ ACK/NACK signal is transmitted.

### Uplink Resource Allocation Procedure

In 3GPP LTE/LTE-A system, in order to maximize resource utilization, the data transmission and reception method based on scheduling of an eNB is used. This signifies that if there are data to transmit by a UE, the UL resource allocation is preferentially requested to the eNB, and the data may be transmitted using only UL resources allocated by the eNB.

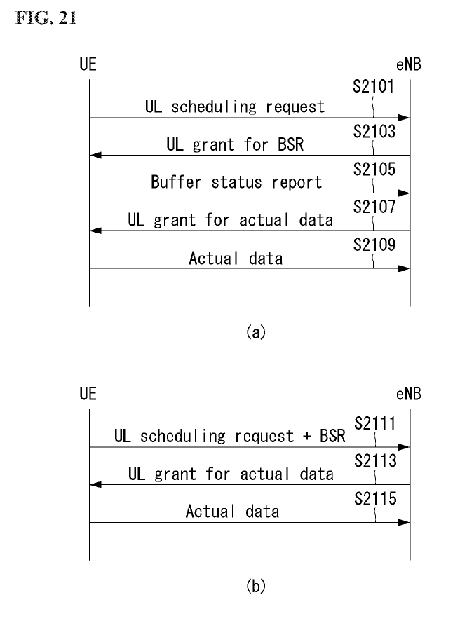

FIG. 21 illustrates a UL resource allocation procedure of a UE in the wireless communication system to which the present application can be applied.

For effective utilization of the UL radio resources, an eNB should know which sorts and what amount of data to be transmitted to the UL for each UE. Accordingly, the UE itself may forward the information of UL data to transmit, and the eNB may allocate the UL resources to the corresponding UE based on this. In this case, the information of the UL data that the UE forwards to the eNB is the quality of UL data stored in its buffer, and this is referred to as a buffer status report (BSR). The BSR is transmitted using a MAC control element in case that the resources on the PUSCH in current TTI are allocated to the UE and the reporting event is triggered.

FIG. 21(a) exemplifies a UL resource allocation procedure for actual data in case that the UL radio resources for the buffer status reporting (BSR) are not allocated to a UE. That is, for a UE that switches a state of active mode in the DRX mode, since there is no data resource allocated beforehand, the resource for UL data should be requested starting from the SR transmission through the PUCCH, in this case, the UL resource allocation procedure of 5 steps is used.

Referring to FIG. 21(a), the case that the PUSCH resource for transmitting the BSR is not allocated to a UE is illustrated, and the UE transmits the scheduling request (SR) to an eNB first in order to be allocated with the PUSCH resources (step, S2101).

The scheduling request (SR) is used to request in order for the UE to be allocated with the PUSCH resource for UL transmission in case that the reporting event is occurred but the radio resource is not scheduled on the PUSCH in current TTI. That is, the UE transmits the SR on the PUCCH when the regular BSR is triggered but does not have the UL radio resource for transmitting the BSR to the eNB. The UE transmits the SR through the PUCCH or starts the random access procedure according to whether the PUCCH resources for the SR are configured. In particular, the PUCCH resources in which the SR can be transmitted may be determined as a combination of the PRB through which the SR is transmitted, the cyclic shift (CS) applied to a basic sequence (e.g., ZC sequence) for spread in frequency domain of the SR and an orthogonal code (OC) for spread in time domain of the SR. Additionally, the SR periodicity and the SR subframe offset information may be included. The PUCCH resources through which the SR can be transmitted may be configured by a higher layer (e.g., the RRC layer) in UE-specific manner.

When a UE receives the UL grant for the PUSCH resources for BSR transmission from an eNB (step, S2103), the UE transmits the triggered BSR through the PUSCH resources which are allocated by the UL grant (step, S2105).

The eNB verifies the quality of data that the UE actually transmit to the UL through the BSR, and transmits the UL grant for the PUSCH resources for actual data transmission to the UE (step, S2107). The UE that receives the UL grant for actual data transmission transmits the actual UL data to the eNB through the PUSCH resources (step, S2109).

FIG. 21(b) exemplifies the UL resource allocation procedure for actual data in case that the UL radio resources for the BSR are allocated to a UE.

Referring to FIG. 21(b), the case that the PUSCH resources for BRS transmission are already allocated to a UE is illustrated. In the case, the UE transmits the BSR through the allocated PUSCH resources, and transmits a scheduling request to an eNB (step, S2111). Subsequently, the eNB verifies the quality of data to be transmitted to the UL by the UE through the BSR, and transmits the UL grant for the PUSCH resources for actual data transmission to the UE (step, S2113). The UE that receives the UL grant for actual data transmission transmits the actual UL data to the eNB through the allocated PUSCH resources (step, S2115).

### Method of Sending Uplink Data Using Segmented Physical Resource Block (SPRB)

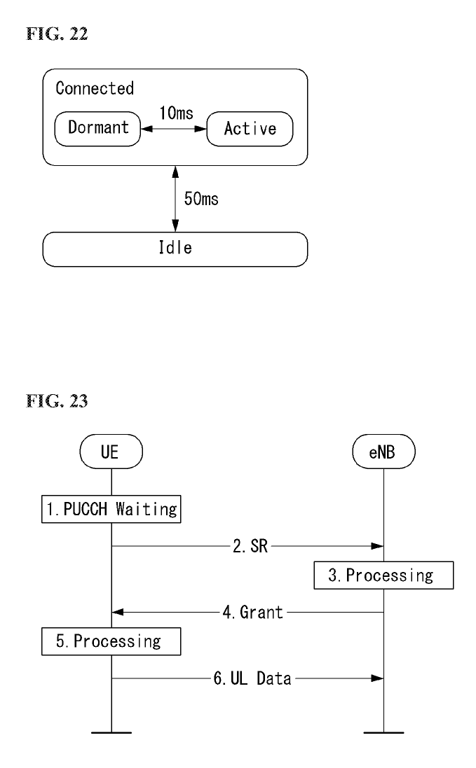

FIG. 22 is a diagram for describing a latency in C-plane required in 3GPP LTE-A to which the present invention can be applied.

Referring to FIG. 22, 3GPP LTE-A requests a transition time from an idle mode (a state that IP address is allocated) to a connected mode to be less than 50 ms. In this time, the transition time includes a configuration time (except latency for transmitting S1) in a user plane (U-plane). In addition, a transition time from a dormant state to an active state in the connection mode is requested to be less than 10 ms.

The transition from the dormant state to the active state may occur in 4 scenarios as follows.
Uplink initiated transition, synchronized
Uplink initiated transition, unsynchronized
Downlink initiated transition, synchronized
Downlink initiated transition, unsynchronized

FIG. 23 is a diagram for describing a transition time from the dormant state to the active state for a synchronized UE required in 3GPP LTE-A to which the present invention can be applied.

In FIG. 23, the UL resource allocation procedure of 3 steps (in case of UL radio resources for the BSR are allocated) described in FIG. 21 above is illustrated. In LTE-A system, the latency is required for UL resource allocation as represented in Table 20 below.

Table 20 represents a transition time from the dormant state to the active state initiated by a UL transmission, in case of a synchronized UE which is required in LTE-A system.

TABLE 20

| Component | Description | Time [ms] |
|---|---|---|
| 1 | Average delay to next SR opportunity | 0.5/2.5 |
| | (1 ms/5 ms PUCCH cycle) | |
| 2 | UE sends Scheduling Request | 1 |
| 3 | eNB decodes Scheduling Request and generates | 3 |
| | the Scheduling Grant | |
| 4 | Transmission of Scheduling Grant | 1 |
| 5 | UE Processing Delay (decoding of scheduling | 3 |
| | grant + L1 encoding of UL data) | |
| 6 | Transmission of UL data | 1 |
| | Total delay | 9.5/11.5 |

Referring to FIG. 23 and Table 20, as an average delay due to a RACH scheduling section that has a RACH cycle of 1 ms/5 ms, 0.5 ms/2.5 ms is required, and 1 ms is required for a

UE to transmit the SR. And 3 ms is required for an eNB to decode the SR and generate the scheduling grant, and 1 ms is required to transmit the scheduling grant. And 3 ms is required for a UE to decode the scheduling grant and encode the UL data in L2 layer, and 1 ms is required to transmit the UL data.

As such, total 9.5/15.5 ms are required for a UE to complete a procedure of transmitting the UL data.

Accordingly, due to system characteristics of transmitting data based on scheduling by an eNB, the problem of increasing the latency even in case of transmitting UL data of a UE. Particularly, in case of an intermittent application (e.g., a health care, a traffic safety, etc.) or an application in which fast transmission is required, such a data transmission method is not proper since it causes the latency inevitably.

In LTE/LTE-A systems, Semi-Persistent Scheduling (SPS) is defined with respect to a Voice over Internet Protocol (VoIP).

SPS is set as a predefined scheduling grant through RRC signaling with respect to UL and/or DL data. If SPS is set as described above, UE may send and receive UL/DL traffic on a predefined occasion without a separate scheduling grant.

In the case of SPS supported in current LTE/LTE-A systems as described above, the transmission of data only in predetermined resources based on the predefined grant of a BS is permitted, but a method for sending small data that may occur aperiodically is not separately defined. Accordingly, although small data is intermittently generated, data needs to be transmitted through 5-step UL resource assignment. SPS is not suitable in an application that intermittently generates data or an application that requires fast transmission because such 5-step UL resource assignment inevitably generates latency. In the future, a variety of applications (e.g., health care, traffic safety, telepresence, and remote machine control) are developed. Accordingly, a data transmission method may need to be diversified suitably for such various applications.

Accordingly, in an embodiment of the present invention, in a 5 Generation (5G) broadband wireless communication system, the occupancy of UL resource assignment for UE based on a contention is proposed in order to minimize delay in the procedure of UE. In other words, a contention-based PUSCH zone is proposed in order to minimize latency in the control plane of UE, such as the transmission of an SR and the reception of an UL grant, and to minimize the latency of an initial access procedure.

UE placed in a cell in which the zone proposed by the present invention has been set may send UL data that requires low latency to a BS using the corresponding zone without the scheduling of the BS if it has the UL data.

The zone proposed by the present invention may be limited to a cell in which service is provided by a specific BS and may be used with respect to UL data transmitted by UE that belongs to the corresponding cell. Furthermore, the present invention is not limited to the above example, and the zone may be limitedly used with respect to UL data to be transmitted by specific UE or within a specific service or specific procedure. For example, the zone may be limitedly used with respect to UL data to be transmitted by M2M UE that does not frequently send data, but needs to rapidly send data when the data is generated or UE used in health care. Furthermore, in 3GPP LTE/LTE-A, UE is divided into a plurality of categories depending on UE capabilities, such as a maximum peak data rate and a multi-input multi-output (MIMO) transmission capability (refer to 3GPP TS 36.306). A contention-based PUSCH zone in accordance with an embodiment of the present invention may be used in only UE that belongs to a specific category. Furthermore, the zone may be limitedly used in a service that requires fast data transmission, such an emergency call, or a specific service that needs to be seamlessly provided. Furthermore, the zone may be limitedly used with respect to UL data transmitted within a specific procedure, such as an RRC/NAS request message in a random access procedure or a BSR message in an UL resource assignment procedure.

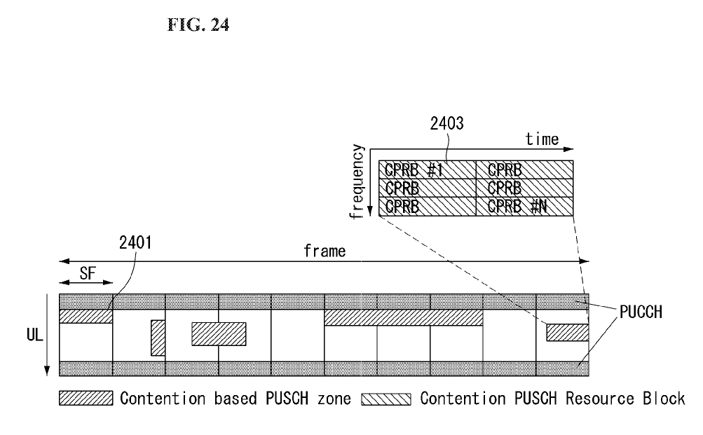

FIG. 24 is a diagram illustrating an example in which contention-based radio resources are configured in accordance with an embodiment of the present invention.

In the present invention, a contention-based PUSCH zone (hereinafter called a “CP zone”) 2401 means a resource region in which assigned contention-based UL data may be transmitted in one or more subframes. That is, the CP zone means a zone in which pieces of UE may competitively send UL data without the UL resource assignment scheduling of a BS with respect to the UL data transmission of the pieces of UE. The CP zone 2401 is set in a specific resource region on a PUSCH region in which UL data may be transmitted. The CP zone 2401 may be set to have the same pattern in n (n←1) subframes (or m (m←1) radio frames). Furthermore, the CP zone 2401 may be set only in some UL subframes by taking resource utilization into consideration.

The set one CP zone 2401 may include N contention-based PUSCH Resource Blocks (hereinafter called “CPRBs”) 2403 that may be occupied by one or more pieces of UE(s). The CPRB 2403 means an UL resource region that may be occupied (i.e., used) by each of pieces of UE for a specific procedure within the CP zone. Each of the CPRBs that form the CP zone has a unique index (e.g., a CPRB #1 or a CPRB #2). The CPRB index may be set in ascending/descending order in a time domain or may be set ascending/descending order in a frequency domain. Furthermore, the CPRB index may be set by combining ascending/descending order in the time domain and ascending/descending order in the frequency domain. For example, a CPRB index may be assigned in the time domain in the lowest frequency domain of the CP zone and CPRB indices may be assigned in the time domain in the next lowest frequency domain of the CP zone. Such CPRB index information may be included in a Master Information Block (MIB) or System Information Block (SIB) and transmitted to UE. Furthermore, indices may be assigned according to a rule predefined between a BS and UE, and the UE may be implicitly aware of the index of each CPRB.

In using CPRBs, UE may use one or more CPRBs 2403 depending on the amount of UL data to be transmitted by the UE, a procedure while the UE tries to send UL data, and a service being used by the UE that tries to send UL data. In this case, a different number of CPRB may be used by UE. For example, if N CPRBs form a CP zone, each of pieces of UE may use a single CPRB, for example, UE 1 may use a CPRB #1, UE 2 may use a CPRB #2, UE 3 may use a CPRB #3. For another example, a piece of UE may use a plurality of CPRBs, for example, the UE 1 may use the CPRB #1 and the CPRB #2 and the

UE 2 may use the CPRB #3. The number of CPRBs used by UE may be different. Furthermore, the same CPRB 2403 may be shared and used by different pieces of UE, for example, both the UE 1 and the UE 2 use the CPRB #1.

Each of pieces of UE may competitively use CPRBs. Furthermore, if a BS assigns CPRBs to each of pieces of UE or UE receives information related to the CPRB of a CP zone from a BS, each of pieces of UE may request a BS to assign a desired CPRB thereto. When a BS assigns CPRBs to each of pieces of UE, in the case of a small cell in which the number of pieces of UE (or the number of users) that may be accommodated by the small cell is limited, the BS may map UE that has entered the small cell and a CPRB in a one-to-one manner. For example, if a maximum number of pieces of UE that may be accommodated by a small cell is N, the BS (or secondary BS) of the small cell may previously assign a CP zone for the N UE and not permit UE other than the N UE to enter the small cell so that the pieces of UE and CPRBs are mapped in a one-to-one manner in the small cell. Furthermore, if a macro BS including the coverage of a small cell exchanges pieces of information with the BS of the small cell through a backhaul interface and UE having connectivity with the macro BS adds connectivity with the BS of the small cell through dual connectivity, the macro BS may previously assign CPRBs that are available in the small cell to the UE. In this case, the dual connectivity means an operation in which the UE uses radio resources provided by at least two different network points (e.g., the macro BS and the secondary BS) connected by non-ideal backhaul.

Furthermore, the CP zone 2401 may be divided according to each procedure and set. The CP zones 2401 for different procedures may be set as different regions within a subframe or as the same or different regions between subframes. For example, a CP zone for an RACH (i.e., an UL contention zone for an RACH) and a CP zone for other procedures other than the RACH (i.e., an UL contention zone for other procedures) may be set as different regions. If a CP zone is divided and set for each procedure as described above, the location of the region set for each procedure, the size of the region, or the form of the region may be differently set.

In this specification, “contention-based radio resources” mean a concept that includes all the aforementioned CP zone and CPRB.

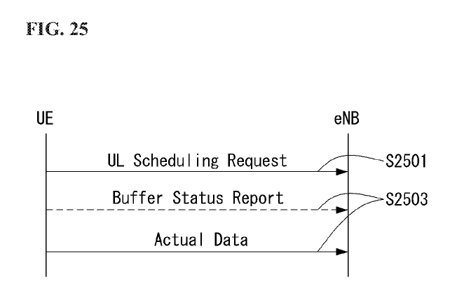

A procedure for sending, by UE, UL data using contention-based radio resources is described below with reference to FIG. 25.

FIG. 25 is a diagram illustrating a method for sending UL data in accordance with an embodiment of the present invention.

Referring to FIG. 25, UE sends an UL Scheduling Request (SR) for UL data and/or a BSR through PUCCH resources at step S2501 and sends actual UL data (actual data) and/or a BSR (if necessary), together with the UL SR, through a Contention-based PUSCH Resource Block (CPRB) in the same one TTI at step S2503.

That is, the UE may send the UL SR and the UL data in the one TTI. Furthermore, the UE may send the UL SR, the UL data, and the BSR in the one TTI. Furthermore, the UE may send the UL SR and the BSR in the one TTI.

A PUCCH resource index is set by UE-specific high layer signaling. The PUCCH resource index is mapped to a combination of a Physical Resource Block (PRB), a Cyclic Shift (CS) applied to a frequency domain sequence, and an Orthogonal Cover Code (OCC) for time domain spreading. That is, the PUCCH resource index specifies a different combination of a PRB, a CS, and an OCC.

Any one of one or more CPRBs belonging to a Contention-based PUSCH zone (CP zone) that has been set in the same TTI as that of PUCCH resources in which an uplink SR has been transmitted may be determined as a CPRB. For example, a CPRB may be mapped to the index of a PUCCH resource in which UE sends an uplink SR.

If UL data is transmitted through the existing 5-step UL resource assignment process in order to send small data that may be intermittently generated as described above, delay in the process may be generated.

Furthermore, in existing LTE/LTE-A frame structures, uplink resources are assigned for each PRB. However, in order to send small data, for example, data of several tens or several hundreds of bits, if one PRB is assigned to each of pieces of UE, waste in the process is inevitably generated.

In order to solve such a problem, an embodiment of the present invention proposes a method for segmenting contention-based PUSCH resources (i.e., CPRBs) into Segmented PRBs (SPRBs) and sending UL data through the SPRBs. That is, there is proposed a resource assignment method for data transmission of low latency and a low rate based on SPRBs.

In general, a transmission stage sends a reference signal that is known to both the transmitter and a receiver, together with data, to the receiver for channel estimation in the receiver. Such a reference signal functions to allow a receiver to perform a data demodulation process by notifying the receiver of a modulation scheme in addition to channel estimation. As described above, in LTE/LTE-A systems, a DMRS is defined as an UL reference signal. An embodiment of the present invention proposes a method of securing the orthogonality of a DMRS related to each SPRB in order for a BS to smoothly perform channel estimation on each of data transmitted in SPRBs. In this case, a basic CPRB may be assigned so that a sequence length having the same size can be assigned. It is hereinafter assumed that single CPRB pair is segmented into a plurality of SPRBs and assigned to different pieces of UE or different layers (or different streams), for convenience of description, but the present invention is not limited thereto.

Furthermore, it is hereinafter assumed that a subframe is formed by a normal CP, for convenience of description, but the present invention is not limited thereto. The present invention may be identically applied to a subframe formed by an extended CP.

Furthermore, it is hereinafter assumed that each of pieces of UE sends a single stream based on a rank 1 in uplink, for convenience of description.

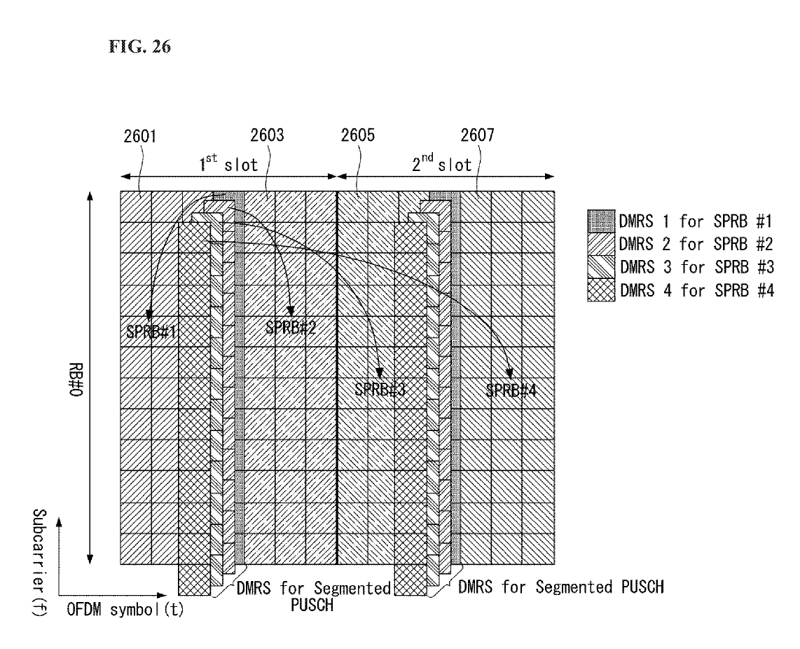

FIG. 26 is a diagram illustrating SPRBs in accordance with an embodiment of the present invention. FIG. 26 illustrates a case where a pair of CPRBs is segmented into a total of four SPRBs.

Referring to FIG. 26, in a first slot, first to third symbols may be defined as an SPRB #1 2601, and fifth to seventh symbols may be defined as an SPRB #2 2603. Furthermore, in a second slot, first to third symbols may be defined as an SPRB #3 2605, and fifth to seventh symbols may be defined as an SPRB #4 2607.

Demodulation Reference Signals (DMRSs) for the channel estimation and compensation of the respective SPRBs may be multiplexed for each subframe.

A DMRS 1 for the demodulation of UL data transmitted in the SPRB #1 2601, a DMRS 2 for the demodulation of UL data transmitted in the SPRB #2 2603, a DMRS 3 for the demodulation of UL data transmitted in the SPRB #3 2605, and a DMRS 4 for the demodulation of UL data transmitted in the SPRB #4 2607 may be multiplexed in symbols placed at the centers of the slots in a time axis and transmitted.

In UE (or a UE group formed of one or more pieces of UE), one or more available SPRBs may be previously set as contention-based radio resources through RRC. In this case, if the UE needs to send UL data of low latency or a low rate, the UE may send the UL data to a BS using the one or more available SPRBs set through RRC without UL resource assignment (or an UL grant).

For example, if the UE has been configured by RRC signaling to send UL data through the SPRB #1 2601 and needs to send UL data of low latency or a low rate, the UE may send the DMRS 1 for the demodulation of the corresponding UL data while sending the UL data through the predetermined SPRB #1 2601.

A BS demodulates UL data transmitted in a corresponding SPRB using a channel value estimated through each DMRS. For example, the BS may demodulate the UL data transmitted in the SPRB #1 2601 using a channel value estimated through the DMRS 1. Furthermore, the BS may demodulate the UL data transmitted in the SPRB #2 2603 using a channel value estimated through the DMRS 2. Furthermore, the BS may demodulate the UL data transmitted in the SPRB #3 2605 using a channel value estimated through the DMRS 3. Furthermore, the BS may demodulate UL data transmitted in the SPRB #4 2607 using a channel value estimated through the DMRS 4.

The DMRSs of the respective SPRBs use the same base ZC sequence and may maintain mutual orthogonality because a different Cyclic Shift (CS) value α_{λ} or n_{cs,λ} is applied to the DMRSs (refer to Equations 11 and 12).

Referring back to Equations 11 and 12, the value n_{cs,λ} is determined through operation of n_{DMRS}⁽¹⁾, n_{DMRS,λ}⁽²⁾, and n_{PN} (nₛ). Furthermore, the value α_{λ} value is determined through operation of n_{csλ}. In this case, the value n_{DMRS}⁽¹⁾ is transmitted to UE through a high layer message, and RRC n_{PN} (nₛ) is a cell-specific value.

In this case, the value n_{DMRS,80} ⁽²⁾ (i.e., the DMRS field value) is determined by a cyclic shift of a 3-bit DMRS field (hereinafter called as a “DMRS field”) within uplink DCI (i.e., an UL grant) for a transport block related to the transmission of a corresponding PDCCH (refer to Table 17). Furthermore, UE calculates a CS value using the value n_{DMRS,λ}⁽²⁾ determined by a “DMRS field” value transmitted through an UL grant and applies the CS value to a DMRS for a PUSCH.

In an embodiment of the present invention, since UL data is transmitted through contention-based radio resources (i.e., CPRBs), UE does not receive a DMRS field value from a BS. Accordingly, the CS value α_{λ} or n_{cs,λ} to the DMRS field value needs to be previously set between the UE and the BS.

A method of setting the CS value α_{λ} or n_{cs,λ} to the DMRS field value is described below.

More specifically, a different CS value n_{cs,λ} may be set for each DMRS using the index of an SPRB.

For example, the CS value of each DMRS may be determined based on a value obtained through {SPRB index mod 12}. In this case, the CS value of the DMRS 1 for the SPRB #1 2601 may be determined to be 1, the CS value of the DMRS 2 for the SPRB #2 2603 may be determined to be 2, the CS value of the DMRS 3 for the SPRB #3 2605 may be determined to be 3, and the CS value of the DMRS 4 for the SPRB #4 2607 may be determined to be 4.

In this case, an SPRB index may be used along with a CPRB index. For example, the CS value of each DMRS may be determined based on a value obtained through {(CPRB index+SPRB index) mod 12} or {(CPRB index×SPRB index) mod 12}.

Furthermore, a different CS value α_{λ} or n_{cs,λ} may be applied to each DMRS because a different 3-bit DMRS field value is set for each DMRS using the index of an SPRB.

For example, the DMRS field value of each DMRS may be determined to be a value obtained through {SPRB index mod 8}. In this case, the DMRS field value of the DMRS 1 for the SPRB #1 2601 may be determined to be 1 (i.e., 001), the CS value of the DMRS 2 for the SPRB #2 2603 may be determined to be 2 (i.e., 010), the CS value of the DMRS 3 for the SPRB #3 2605 may be determined to be 3 (i.e., 011), and the CS value of the DMRS 4 for the SPRB #4 2607 may be determined to be 4 (i.e., 100).

In this case, an SPRB index may be used along with a CPRB index. For example, the DMRS field value of each DMRS may be determined to be a value obtained through {(CPRB index+SPRB index) mod 8} or {(CPRB index×SPRB index) mod 8}.

Furthermore, a different CS value α_{λ} or n_{cs,λ} may be previously set for each DMRS regardless of the index of a CPRB or the index of an SPRB. In this case, the CS value α_{λ} or n_{cs,λ} of each DMRS may be previously set using a specific pattern (e.g., an increase of a specific number). In this case, information about a predetermined CS value or the pattern of the CS value may be transmitted to UE through RRC signaling.

For example, the CS value α_{λ} of the DMRS 1 for the SPRB #1 2601 may be previously set to 0, the CS value α_{λ} of the DMRS 2 for the SPRB #2 2603 may be previously set to 6π/12, the CS value α_{λ} of the DMRS 3 for the SPRB #3 2605 may be previously set to 12π/12, and the CS value α_{λ} of the DMRS 4 for the SPRB #4 2607 may be previously set to 18π/12.

For another example, the CS value n_{cs,λ} of the DMRS 1 for the SPRB #1 2601 may be previously set to 0, the CS value n_{cs,λ} of the DMRS 2 for the SPRB #2 2603 may be previously set to 3, the CS value n_{cs,λ} of the DMRS 3 for the SPRB #3 2605 may be previously set to 6, and the CS value n_{cs,λ} of the DMRS 4 for the SPRB #4 2607 may be previously set 9.

Furthermore, a different CS value α_{λ} or n_{cs,λ} may be applied to each DMRS because a different 3-bit DMRS field value is previously set for each DMRS regardless of the index of a CPRB or the index of an SPRB. In this case, the DMRS field value of each DMRS may be previously set using a specific pattern (e.g., an increase of a specific number). In this case, information about a predetermined DMRS field value or the pattern of the DMRS field value may be transmitted to UE through RRC signaling.

For example, the DMRS field value of the DMRS 1 for the SPRB #1 2601 may be previously set to 000, the DMRS field value of the DMRS 2 for the SPRB #2 2603 may be previously set to 010, the DMRS field value of the DMRS 3 for the SPRB #3 2605 may be previously set to 100, and the DMRS field value of the DMRS 4 for the SPRB #4 2607 may be previously set to 110.

As described above, since two DMRSs for one SPRB are transmitted in each slot within one subframe, the reception side (i.e., a BS) obtains a channel estimation value by interpolating each channel estimation value estimated through the two DMRSs, thereby being capable of increasing the accuracy of channel estimation.

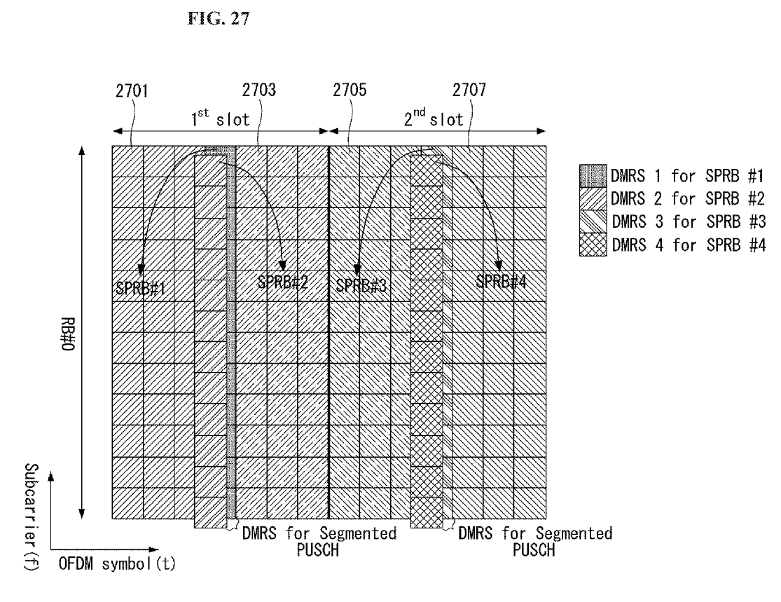

FIG. 27 is a diagram illustrating SPRBs in accordance with an embodiment of the present invention.

FIG. 27 illustrates a case where a pair of CPRBs is segmented into a total of four SPRB. Referring to FIG. 27, in a first slot, first to third symbols may be defined as an SPRB #1 2701, and fifth to seventh symbols may be defined as an SPRB #2 2703. Furthermore, in a second slot, first to third symbols may be defined as an SPRB #3 2705, and fifth to seventh symbols may be defined as an SPRB #4 2707.

Furthermore, a DMRS for the channel estimation and compensation of each SPRB may be multiplexed for each slot.

In this case, in the example of FIG. 27, unlike in the example of FIG. 26, the DMRS 1 for the demodulation of UL data transmitted in the SPRB #1 2701 and the DMRS 2 for the demodulation of UL data transmitted in the SPRB #2 2703 may be multiplexed in a symbol placed at the center of the first slot in a time axis and transmitted. Furthermore, the DMRS 3 for the demodulation of UL data transmitted in the SPRB #3 2705 and the DMRS 4 for the demodulation of UL data transmitted in the SPRB #4 2707 may be multiplexed in a symbol placed at the center of the second slot in a time axis and transmitted.

In UE (or a UE group formed of one or more pieces of UE), one or more available SPRBs may be previously set as contention-based radio resources through RRC. In this case, if the UE needs to send UL data of low latency or a low rate, the UE may send the UL data to a BS using the one or more available SPRBs set through RRC without UL resource assignment (or an UL grant).

For example, if the UE has been configured by RRC signaling to send UL data through the SPRB #1 2701 and needs to send UL data of low latency or a low rate, the UE may send the DMRS 1 for the demodulation of the corresponding UL data while sending the UL data through the predetermined SPRB #1 2701.

A BS demodulates UL data transmitted in a corresponding SPRB using a channel value estimated through each DMRS. For example, the BS may demodulate the UL data transmitted in the SPRB #1 2701 using a channel value estimated through the DMRS 1.

Furthermore, the BS may demodulate the UL data transmitted in the SPRB #2 2703 using a channel value estimated through the DMRS 2. Furthermore, the BS may demodulate the UL data transmitted in the SPRB #3 2705 using a channel value estimated through the DMRS 3. Furthermore, the BS may demodulate UL data transmitted in the SPRB #4 2707 using a channel value estimated through the DMRS 4.

DMRSs transmitted in the same slot use the same base ZC sequence, but may maintain mutual orthogonality because a different Cyclic Shift (CS) value α_{λ} or n_{cs,λ} is applied to the DMRSs (refer to Equations 11 and 12).

More specifically, a different CS value n_{cs,λ} may be set using the index of an SPRB for each DMRS transmitted in the same slot.

For example, the CS value of each DMRS transmitted in the same slot may be determined to be a value obtained through {SPRB index mod 12}. In this case, the CS value of the DMRS 1 for the SPRB #1 2701 transmitted in the first slot may be determined to be 1, and the CS value of the DMRS 2 for the SPRB #2 2703 transmitted in the first slot may be determined to be 2. Furthermore, the CS value of the DMRS 3 for the SPRB #3 2705 transmitted in the second slot may be determined to be 3, and the CS value of the DMRS 4 for the SPRB #4 2707 transmitted in the second slot may be determined to be 4.

In this case, the same CS value may be set in DMRSs transmitted in other slots because a DMRS is used to demodulate an SPRB transmitted in a specific slot.

For example, it is assumed that the SPRB index values of the SPRB #3 2705 and the SPRB #4 2707 are set to 1 and 2. In this case, the CS value of the DMRS 3 for the SPRB #3 2705 may be determined to be 1, and the CS value of the DMRS 4 for the SPRB #4 2707 may be determined to be 2.

In this case, an SPRB index may be used along with a CPRB index. For example, the CS value of each DMRS may be determined to be a value obtained through {(CPRB index+SPRB index) mod 12} or {(CPRB index×SPRB index) mod 12}.

Furthermore, a different CS value α_{λ} or n_{cs,λ} may be applied to each of DMRSs transmitted in the same slot because a different 3-bit DMRS field value is set in each of DMRSs transmitted in the same slot using the index of an SPRB.

For example, the DMRS field value of each of DMRSs transmitted in the same slot may be determined to be a value obtained through {SPRB index mod 8}. In this case, the DMRS field value of the DMRS 1 for the SPRB #1 2701 transmitted in the first slot may be determined to be 1 (i.e., 001), and the CS value of the DMRS 2 for the SPRB #2 2703 transmitted in the first slot may be determined to be 2 (i.e., 010). Furthermore, the CS value of the DMRS 3 for the SPRB #3 2705 transmitted in the second slot may be determined to be 3 (i.e., 011), and the CS value of the DMRS 4 for the SPRB #4 2707 transmitted in the second slot may be determined to be 4 (i.e., 100).

Even in this case, the same CS value may be set in the DMRS field values of DRMSs transmitted in different slots. For example, it is assumed that the SPRB index values of the SPRB #3 2705 and the SPRB #4 2707 are set to 1 and 2. In this case, the DMRS field value of the DMRS 3 for the SPRB #3 2705 may be determined to be 1, and the DMRS field value of the DMRS 4 for the SPRB #4 2707 may be determined to be 2.

In this case, an SPRB index may be used along with a CPRB index. For example, the DMRS field value of each DMRS may be determined to be a value obtained through 1 (CPRB index+SPRB index) mod 81 or 1 (CPRB index×SPRB index) mod 81.

Furthermore, a different CS value α_{λ} or n_{cs,λ} may be previously set in each of DMRSs transmitted in the same slot regardless of the index of a CPRB or the index of an SPRB.

In this case, the CS value α_{λ} or n_{cs,λ} of each of the DMRSs transmitted in the same slot may be previously set using a specific pattern, for example, an increase of a specific number. In this case, information about a predetermined CS value or the pattern of the CS value may be transmitted to UE through RRC signaling.

For example, the CS value α_{λ} of the DMRS 1 for the SPRB #1 2701 transmitted in the first slot may be previously set to 0, and the CS value α_{λ} of the DMRS 2 for the SPRB #2 2703 transmitted in the first slot may be previously set to 12π/12. Furthermore, the CS value α_{λ} of the DMRS 3 for the SPRB #3 2705 transmitted in the second slot may be previously set 0, and the CS value α_{λ} of the DMRS 4 for the SPRB #4 2707 transmitted in the second slot may be previously set 12π/12. In this case, the CS value α_{λ} of the DMRS 3 for the SPRB #3 2705 and the CS value α_{λ} of the DMRS 4 for the SPRB #4 2707 which are transmitted in the second slot may be set to 67π/12 and 18π/12, which are different from the CS values of the DMRSs transmitted in the first slot.

For another example, the CS value n_{cs,λ} of the DMRS 1 for the SPRB #1 2701 transmitted in the first slot may be previously set to 0, and the CS value n_{cs,λ} of the DMRS 2 for the SPRB #2 2703 transmitted in the first slot may be previously set to 6. Furthermore, the CS value n_{cs,λ} of the DMRS 3 for the SPRB #3 2705 transmitted in the second slot may be previously set to 0, and the CS value n_{cs,λ} of the DMRS 4 for the SPRB #4 2707 transmitted in the first slot may be previously set to 6. In this case, the CS value n_{cs,λ} of the DMRS 3 for the SPRB #3 2705 transmitted in the second slot and the CS value n_{cs,λ} of the DMRS 4 for the SPRB #4 2707 may be set to 3 and 9, which are different from the CS values of the DMRSs transmitted in the first slot.

Furthermore, a different CS value α_{λ} or n_{cs,λ} may be applied to each of DMRSs transmitted in the same slot because a different 3-bit DMRS field value is previously set in each of the DMRSs transmitted in the same slot regardless of the index of a CPRB or the index of an SPRB. In this case, the DMRS field value of each of the DMRSs transmitted in the same slot may be previously set using a specific pattern, for example, an increase of a specific number. In this case, information about a predetermined CS value or the pattern of the CS value may be transmitted to UE through RRC signaling.

For example, the DMRS field value of the DMRS 1 for the SPRB #1 2701 transmitted in the first slot may be previously set to 000, and the DMRS field value of the DMRS 2 for the SPRB #2 2703 transmitted in the first slot may be previously set to 100. Furthermore, the DMRS field value of the DMRS 3 for the SPRB #3 2705 transmitted in the second slot may be previously set to 000, and the DMRS field value of the DMRS 4 for the SPRB #4 2707 transmitted in the second slot may be previously set to 100. In this case, the DMRS field value of the DMRS 3 for the SPRB #3 2705 and the DMRS field value of the DMRS 4 for the SPRB #4 2707 which are transmitted in the second slot may be set to 010 and 110, which are different from the DMRS field values of the DMRSs transmitted in the first slot.

As described above, interference between DMRSs transmitted in the same slot is reduced because only two DMRS are redundantly transmitted in a single symbol for each slot.

One CPRB pair may be segmented into a total of 2 SPRBs, which is described with reference to the following drawings.

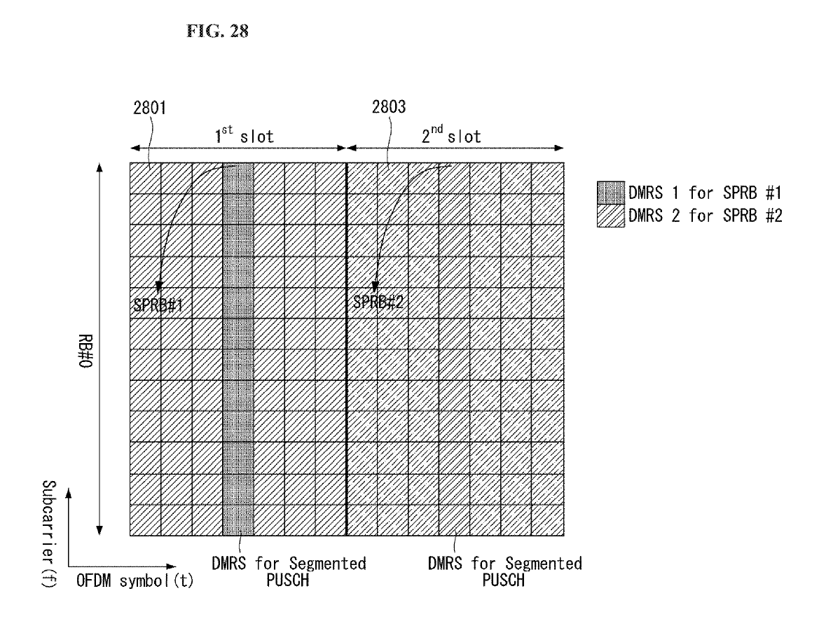

FIG. 28 is a diagram illustrating SPRBs in accordance with an embodiment of the present invention.

FIG. 28 illustrates a case where a pair of CPRBs is segmented into a total of 2 SPRBs.

Referring to FIG. 28, a first slot may be defined as an SPRB #1 2801, and a second slot may be defined as an SPRB #2 2803.

A DMRS for the channel estimation and compensation for each SPRB may be transmitted in a corresponding SPRB.

That is, a DMRS 1 for the demodulation of UL data transmitted in the SPRB #1 2801 may be transmitted in a symbol placed at the center of the first slot in a time axis, and a DMRS 2 for the demodulation of UL data transmitted in the SPRB #2 2803 may be transmitted in a symbol placed at the center of the second slot in the time axis.

In UE (or a UE group formed of one or more pieces of UE), one or more available SPRBs may be previously set as contention-based radio resources through RRC. In this case, if the UE needs to send UL data of low latency or a low rate, the UE may send the UL data to a BS using the one or more available SPRBs set through RRC without UL resource assignment (or an UL grant).

For example, if UE has been configured to have contention-based radio resources in which the SPRB #1 2801 is available through RRC signaling and needs to send UL data of low latency or a low rate, the UE sends the DMRS #1 for demodulating the corresponding UL data while sending the UL data through the predetermined SPRB #1 2801.

A BS demodulates UL data transmitted in a corresponding SPRB using a channel value estimated through each DMRS. For example, the BS may demodulate UL data transmitted in the SPRB #1 2801 using a channel value estimated through the DMRS 1.

Furthermore, the BS may demodulate UL data transmitted in the SPRB #2 2803 using a channel value estimated through the DMRS 2.

Unlike in the examples of FIGS. 26 and 27, a different base ZC sequence may be used because only one DMRS is transmitted in one slot.

Furthermore, the same Cyclic Shift (CS) value α_{λ} or n_{cs,λ} may be applied. That is, the same CS value α_{λ} or n_{cs,λ} (e.g., 0) may be fixed and previously set in both the DMRS 1 for the SPRB #1 2801 and the DMRS 2 for the SPRB #2 2803 regardless of the index of the SPRB. In this case, a predetermined CS value may be transmitted to UE through RRC signaling.

Furthermore, the same DMRS field value of 3 bits (e.g., 000) may be set in both the DMRS 1 for the SPRB #1 2801 and the DMRS 2 for the SPRB #2 2803, and thus the same CS value α_{λ} or n_{cs,λ} may be applied to each of the DMRSs. In this case, a predetermined DMRS field value may be transmitted to UE through RRC signaling.

In contrast, as in the examples of FIGS. 25 and 27, mutual orthogonality may be maintained because different CS values α_{λ} or n_{csλ} are applied to the DMRS 1 for the SPRB #1 2801 and the DMRS 2 for the SPRB #2 2803 (refer to Equations 11 and 12).

More specifically, a different CS value n_{cs,λ} may be set in each DMRS using the index of an SPRB.

For example, the CS value of each DMRS may be determined to be a value obtained through {SPRB index mod 12}. In this case, the CS value of the DMRS 1 for the SPRB #1 2801 may be determined to be 1, and the CS value of the DMRS 2 for the SPRB #2 2803 may be determined to be 2.

In this case, an SPRB index may be used along with a CPRB index. For example, the CS value of each DMRS may be determined to be a value obtained through {(CPRB index+SPRB index) mod 12} or {(CPRB index×SPRB index) mod 12}.

Furthermore, since a different 3-bit DMRS field value is set in each DMRS using the index of an SPRB, a different CS value α_{λ} or n_{cs,λ} may be applied to each DMRS.

For example, the DMRS field value of each DMRS may be determined to be a value obtained through {SPRB index mod 8}. In this case, the DMRS field value of the DMRS 1 for the SPRB #1 2801 may be determined to be 1 (i.e., 001), and the CS field value of the DMRS 2 for the SPRB #2 2803 may be determined to be 2 (i.e., 010).

In this case, an SPRB index may be used along with a CPRB index. For example, the DMRS field value of each DMRS may be determined to be a value obtained through {(CPRB index+SPRB index) mod 8} or {(CPRB index×SPRB index) mod 8}.

Furthermore, a different CS value α_{λ} or n_{cs,λ} may be previously set in each DMRS regardless of the index of a CPRB or the index of an SPRB. In this case, a predetermined CS value may be transmitted to UE through RRC signaling.

For example, the CS value α_{λ} of the DMRS 1 for the SPRB #1 2801 may be previously set to 0, and the CS value α_{λ} of the DMRS 2 for the SPRB #2 2803 may be previously set to 12π/12.

For another example, the CS value n_{cs,λ} of the DMRS 1 for the SPRB #1 2801 may be previously set to 0, and the CS value n_{cs,λ} of the DMRS 2 for the SPRB #2 2803 may be previously set to 6.

Furthermore, since a different 3-bit DMRS field value is previously set in each DMRS regardless of the index of a CPRB or the index of an SPRB, different CS value α_{λ} or n_{cs,λ} may be applied to each DMRS. In this case, a predetermined DMRS field value may be transmitted to UE through RRC signaling.

For example, the DMRS field value of the DMRS 1 for the SPRB #1 2801 may be previously set to 000, and the DMRS field value of the DMRS 2 for the SPRB #2 2803 may be previously set to 100.

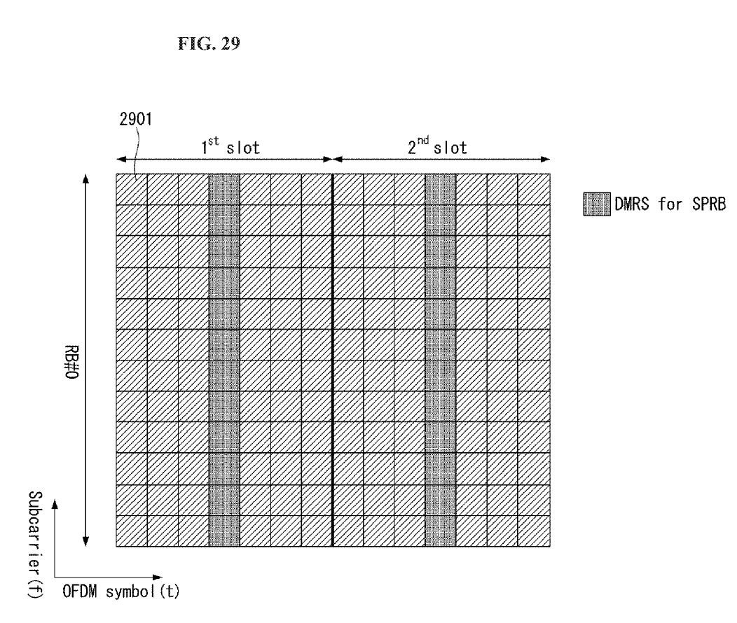

Unlike in the examples of FIGS. 26 to 28, a pair of CPRBs unit may correspond to one SPRB. This is described below with reference to FIG. 29.

FIG. 29 is a diagram illustrating SPRBs in accordance with an embodiment of the present invention.

Referring to FIG. 29, a pair of CPRBs corresponds to one SPRB. That is, UE may use a pair of CPRBs for UL data transmission of low latency or a low rate.

In this case, orthogonality between DMRSs is not a problem because each slot belonging to an SPRB uses a single DMRS. Furthermore, as described above, since UE does not receive an UL grant and sends UL data through an SPRB, a 3-bit DMRS field or a Cyclic Shift (CS) may be previously set.

More specifically, the DMRS CS value α_{λ} or n_{cs,λ} of an SPRB may be previously set using a CPRB index value corresponding to the SPRB. For example, the CS value of a DMRS for an SPRB may be determined to be a value obtained through {CPRB index mod 12}.

Furthermore, the DMRS CS value α_{λ} or n_{cs,λ} of an SPRB may be fixed to and set as the same value regardless of the index of a CPRB corresponding to the SPRB. In this case, a predetermined CS value may be transmitted to UE through RRC signaling. For example, the CS value of a DMRS for an SPRB may be identically set to 0 regardless of CPRB indices, such as a CPRB #1, a CPRB #2, and a CPRB #3.

Furthermore, the DMRS CS value α_{λ} or n_{cs,λ} of an SPRB may be previously set as a predetermined pattern regardless of the index of a CPRB corresponding to the SPRB. In this case, information about a predetermined CS value or the pattern of the CS value may be transmitted to UE through RRC signaling. For example, the DMRS CS value of the CPRB #1 may be set to 0, the DMRS CS value of the CPRB #2 may be set to 9, and the DMRS CS value of the CPRB #3 may be set to 3.

The 3-bit DMRS field value of an SPRB may be previously set using the index value of a CPRB corresponding to an SPRB. For example, the DMRS field value of a DMRS for an SPRB may be determined to be a value obtained through {CPRB index mod 8}.

Furthermore, the DMRS field value of an SPRB may be fixed to and set as the same value regardless of the index of a CPRB corresponding to the SPRB. In this case, a predetermined DMRS field value may be transmitted to UE through RRC signaling. For example, the DMRS field value of a DMRS for an SPRB may be identically set to 000 regardless of CPRB indices, such as the CPRB #1, the CPRB #2, and the CPRB #3.

Furthermore, the 3-bit DMRS field value of an SPRB may be previously set based on a predetermined pattern. In this case, like a DMRS CS, information about a predetermined DMRS field value or a predetermined pattern may be transmitted to UE through RRC signaling. For example, the DMRS field value of a DMRS for the CPRB #1 may be set to 000, the DMRS field value of a DMRS for the CPRB #2 may be set to 010, and the DMRS field value of a DMRS for the CPRB #3 may be set to 100.

ACK/NACK information about a PUSCH is transmitted to UE through a PHICH.

PHICH resources are identified by an index pair (n_{PHICH}^{group}, n_{PHICH}^{seq}), n_{PHICH}^{group} denotes a PHICH group number, and n_{PHIVH}^{seq} denotes an orthogonal sequence index within the corresponding PHICH group. n_{PHICH}^{group} n_{PHICH}^{seq} are defined by Equation 25 below.

[Equation 25]

n_{PHICH}^{group})=(I_{PRB}_{_}_{RA}+n_{DMRS}) mod N_{PHICH}^{group}+I_{PHICH}N_{PHICH}^{group}

n_{PHICH}^{seq}=(└I_{PRB}_{_}_{RA}/N_{PHICH}^{group}┘+n_{DMRS}) mod 2N_{SF}^{PHICH}

In Equation 25, “mod” denotes modulo operation.

n_{DMRS} is mapped from a cyclic shift for a DMRS field (i.e., a “DMRS field”) in the most recent PDCCH having an uplink DCI format for a transport block related to the transmission of a corresponding PUSCH. In contrast, if there is no PDCCH having an uplink DCI format for the same transport block, when an initial PUSCH for the same transport block is semi-persistently scheduled or scheduled by a random access response grant, n_{DMRS} is set to 0.

N_{SF}^{PHICH} denotes the size of a spreading factor used for PHICH modulation. I_{PRB}_{_}_{RA} is the same as I_{PRB}_{_}_{RA}^{lowest}^{_}^{index} in the case of the first transport block of a PUSCH related to a PDCCH or if there is no related PDCCH when the number of transport blocks indicated in the most recent PDCCH related to a corresponding PUSCH is not the same as the number of transport blocks of NACK. In contrast, in the case of the second transport block of a PUSCH related to a PDCCH, I_{PRB}_{_}_{RA} is the same as I_{PRB}_{_}_{RA}^{lowest}^{_}^{index}+1. In this case, I_{PRB}_{_}_{RA}^{lowest} ^{_}^{index} means the lowest PRB index of the first slot for sending a corresponding PUSCH.

N_{PHICH}^{group} denotes the number of a PHICH group set by a high layer.

I_{PHICH} is 1 if a PUSCH is transmitted in a subframe index 4 or 9 in the UL/DL configuration 0 of a TDD system and 0 if a PUSCH is not transmitted in the subframe index 4 or 9 in the UL/DL configuration 0 of the TDD system.

That is, PHICH resources corresponding to a PUSCH is defined using the lowest Physical Resource Block (PRB) index I_{PRB}_{_}_{RA}^{lowest}^{_}^{index} of resources used in a PUSCH and the cyclic shift parameter n_{DMRS} of a DMRS.

A cyclic shift parameter n_{DMRS}, as described above, is determined by a “DMRS field” transmitted to UE through DCI (i.e., an UL grant) on a PDCCH for an uplink transmission block.

Table 21 illustrates a mapping relationship between a cyclic shift for a DMRS field (i.e., a DMRS field) within a PDCCH that carries an uplink DCI format and the cyclic shift parameter n_{DMRS}.

TABLE 21

| Cyclic shift for DMRS field in PDCCH | |
|---|---|
| with uplink DCI format | n_{DMRS} |
| 000 | 0 |
| 001 | 1 |
| 010 | 2 |
| 011 | 3 |
| 100 | 4 |
| 101 | 5 |
| 110 | 6 |
| 111 | 7 |

An ambiguity may occur in the assignment of PHICH resources because UE sends UL data through a contention-based PUSCH without an UL grant in a first step and information about a DMRS field of 3 bits is not present. That is, a collision may occur between ACK/NACK resources.

In particular, if an SPRB is segmented and defined in a pair of CPRBs in a time domain, the cyclic shift parameter n_{DMRS} for assigning PHICH resources should not overlap with each other because SPRBs may have the same lowest PRB index.

Accordingly, an embodiment of the present invention proposes a method in which a collision is not generated between DMRS cyclic shift parameters corresponding to an SPRB resource assignment region in order to perform assignment without an UL grant DM-RS.

In this specification, the cyclic shift parameter n_{DMRS} and the DMRS field are collectively called a “DMRS field” because they may be mapped in a one-to-one manner as in Table 21.

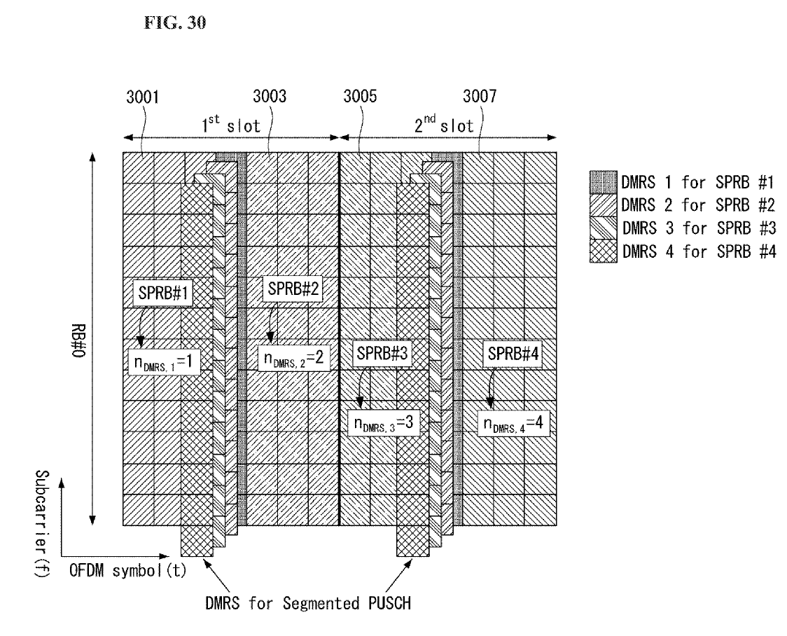

FIG. 30 is a diagram illustrating SPRBs in accordance with an embodiment of the present invention.

FIG. 30 illustrates a case where a pair of CPRBs is segmented into a total of four SPRBs. Referring to FIG. 30, in a first slot, first to third symbols may be defined as an SPRB #1 3001, and fifth to seventh symbols may be defined as an SPRB #2 3003. Furthermore, in a second slot, first to third symbols may be defined as an SPRB #3 3005, and fifth to seventh symbols may be defined as an SPRB #4 3007.

DMRSs for the channel estimation and compensation of the respective SPRBs may be multiplexed for each subframe.

A DMRS 1 for the demodulation of UL data transmitted in the SPRB #1 3001, a DMRS 2 for the demodulation of UL data transmitted in the SPRB #2 3003, a DMRS 3 for the demodulation of UL data transmitted in the SPRB #3 3005, and a DMRS 4 for the demodulation of UL data transmitted in the SPRB #4 3007 may be multiplexed in a symbol placed at the center of each slot in a time axis and transmitted.

If a contention-based PUSCH not having an UL grant is transmitted as described above, a DMRS field n_{DMRS} for a PHICH is set as the resource region index of an SPRB.

For example, the DMRS field of a PHICH for the SPRB #1 3001 may be previously set to 1, the DMRS field of a PHICH for the SPRB #2 3003 may be previously set to 2, the DMRS field of a PHICH for the SPRB #3 3005 may be previously set to 3, and the DMRS field of a PHICH for the SPRB #4 3007 may be previously set to 4.

A different CS value α_{λ} or n_{cs,λ} may be defined for the DMRS of each SPRB using a predetermined DMRS field value as described above (refer to Equations 11 and 12). In this case, the DMRS sequences of the respective SPRBs may use the same base ZC sequence in order to maintain orthogonality.

One or more available SPRBs may be previously set in UE (or a UE group formed of one or more pieces of UE) as contention-based radio resources through RRC. In this case, if the UE needs to send UL data of low latency or a low rate, the UE may send the UL data to a BS without UL resource assignment (or an UL grant) using one or more available SPRBs set by RRC.

Furthermore, the UE sends a DMRS for the demodulation of the UL data transmitted through the SPRB to the BS along with the UL data. In this case, a CS value applied to a DMRS may be determined using a DMRS field value predetermined based on the index of each SPRB.

A BS demodulates UL data transmitted in a corresponding SPRB using a channel value estimated through each DMRS. Furthermore, the BS sends ACK/NACK information about whether the decoding of UL data transmitted through each SPRB has been successfully performed to each of pieces of UE through a PHICH.

In this case, as described above, the BS determines the PHICH resources of each SPRB using the DMRS field value of a PHICH predetermined based on the index of each SPRB. Furthermore, ACK/NACK information is transmitted to each piece of UE through the determined PHICH resources.

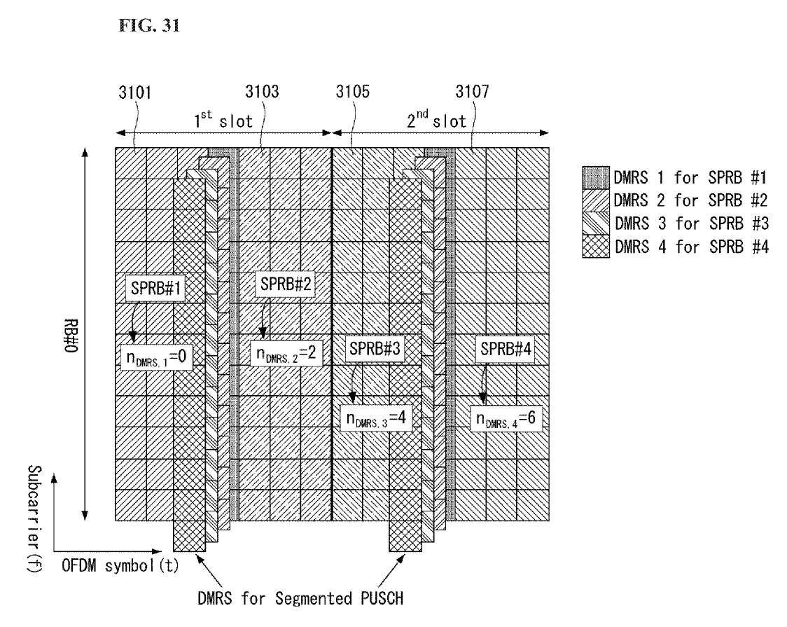

FIG. 31 is a diagram illustrating SPRBs in accordance with an embodiment of the present invention.

FIG. 31 illustrates a case where a pair of CPRBs is segmented into a total of four SPRBs. Referring to FIG. 31, in a first slot, first to third symbols may be defined as an SPRB #1 3101, and fifth to seventh symbols may be defined as an SPRB #2 3103. Furthermore, in a second slot, first to third symbols may be defined as an SPRB #3 3105, and fifth to seventh symbols may be defined as an SPRB #4 3107.

DMRSs for the channel estimation and compensation of the respective SPRBs may be multiplexed for each subframe.

A DMRS 1 for the demodulation of UL data transmitted in the SPRB #1 3101, a DMRS 2 for the demodulation of UL data transmitted in the SPRB #2 3103, a DMRS 3 for the demodulation of UL data transmitted in the SPRB #3 3105, and a DMRS 4 for the demodulation of UL data transmitted in the SPRB #4 3107 may be multiplexed in a symbol placed at the center of each slot in a time axis and transmitted.

If a contention-based PUSCH not having an UL grant is transmitted as described above, the DMRS field n_{DMRS} of a PHICH is set as a value predetermined for each SPRB region. For example, the DMRS field of a PHICH for the SPRB #1 3101 may be previously set to 0, the DMRS field of a PHICH for the SPRB #2 3103 may be previously set to 2, the DMRS field of a PHICH for the SPRB #3 3105 may be previously set to 4, and the DMRS field of a PHICH for the SPRB #4 3107 may be previously set to 6.

As described above, a different CS value α_{λ} or n_{cs,λ} may be determined for the DMRS of each SPRB using a predetermined DMRS field value (refer to Equations 11 and 12). In this case, the DMRS sequences of the respective SPRBs may use the same base ZC sequence in order to maintain orthogonality.

One or more available SPRBs may be previously set in UE (or a UE group formed of one or more pieces of UE) as contention-based radio resources through RRC. In this case, if the UE needs to send UL data of low latency or a low rate, the UE may send the UL data to a BS without UL resource assignment (or an UL grant) using one or more available SPRBs set by RRC.

Furthermore, the UE sends a DMRS for the demodulation of the UL data transmitted through the SPRB to the BS along with the UL data. In this case, a CS value applied to a DMRS may be previously set for each SPRB.

A BS demodulates UL data transmitted in a corresponding SPRB using a channel value estimated through each DMRS. Furthermore, the BS sends ACK/NACK information about whether the decoding of UL data transmitted through each SPRB has been successfully performed to each of pieces of UE through a PHICH.

In this case, as described above, the BS determines the PHICH resources of each SPRB using the DMRS field value of a PHICH predetermined for each SPRB. Furthermore, ACK/NACK information is transmitted to each piece of UE through the determined PHICH resources.

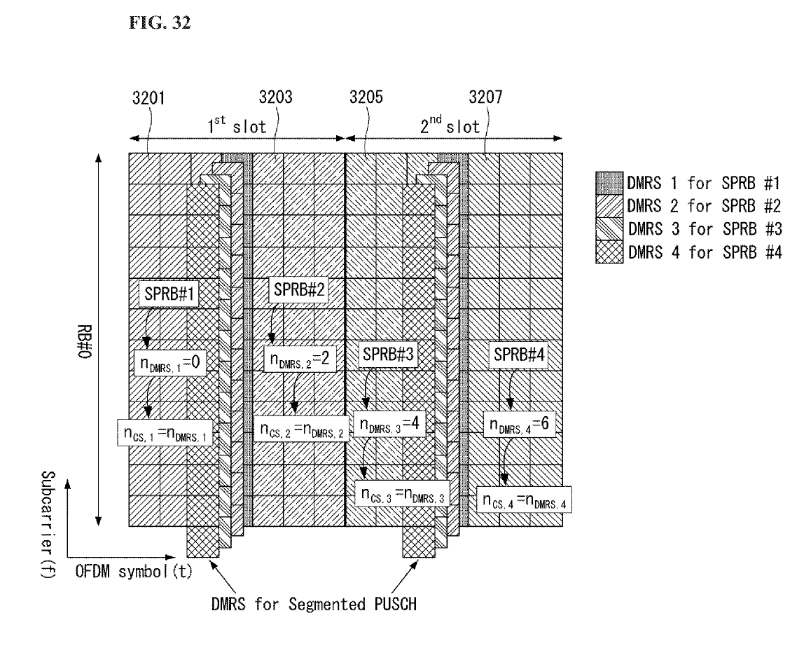

FIG. 32 is a diagram illustrating SPRBs in accordance with an embodiment of the present invention.

FIG. 32 illustrates a case where a pair of CPRBs is segmented into a total of four SPRBs. Referring to FIG. 32, in a first slot, first to third symbols may be defined as an SPRB #1 3201, and fifth to seventh symbols may be defined as an SPRB #2 3203. Furthermore, in a second slot, first to third symbols may be defined as an SPRB #3 3205, and fifth to seventh symbols may be defined as an SPRB #4 3207.

DMRSs for the channel estimation and compensation of the respective SPRBs may be multiplexed for each subframe.

A DMRS 1 for the demodulation of UL data transmitted in the SPRB #1 3201, a DMRS 2 for the demodulation of UL data transmitted in the SPRB #2 3203, a DMRS 3 for the demodulation of UL data transmitted in the SPRB #3 3205, and a DMRS 4 for the demodulation of UL data transmitted in the SPRB #4 3207 may be multiplexed in a symbol placed at the center of each slot in a time axis and transmitted.

If a contention-based PUSCH not having an UL grant is transmitted as described above, a DMRS field n_{DMRS} for a PHICH is set as a predetermined value for each SPRB region. For example, the DMRS field of a PHICH for the SPRB #1 3201 may be previously set to 0, the DMRS field of a PHICH for the SPRB #2 3203 may be previously set to 2, the DMRS field of a PHICH for the SPRB #3 3205 may be previously set to 4, and the DMRS field of a PHICH for the SPRB #4 3207 may be previously set to 6.

As described above, the CS value n_{cs,λ} of a DMRS may be set like a predetermined DMRS field value.

For example, the CS value of a DMRS for the SPRB #1 3201 may be set to 0, the CS value of a DMRS for the SPRB #2 3203 may be set to 2, the CS value of a DMRS for the SPRB #3 3205 may be set to 4, and the CS value of a DMRS for the SPRB #4 3207 may be set to 6.

One or more available SPRBs may be previously set in UE (or a UE group formed of one or more pieces of UE) as contention-based radio resources through RRC. In this case, if the UE needs to send UL data of low latency or a low rate, the UE may send the UL data to a BS without UL resource assignment (or an UL grant) using one or more available SPRBs set by RRC.

Furthermore, the UE sends a DMRS for the demodulation of the UL data transmitted through the SPRB to the BS along with the UL data. In this case, a CS value applied to a DMRS may be previously set for each SPRB.

A BS demodulates UL data transmitted in a corresponding SPRB using a channel value estimated through each DMRS. Furthermore, the BS sends ACK/NACK information about whether the decoding of UL data transmitted through each SPRB has been successfully performed to each of pieces of UE through a PHICH.

In this case, as described above, the BS determines the PHICH resources of each SPRB using the DMRS field value of a PHICH predetermined for each SPRB. Furthermore, ACK/NACK information is transmitted to each piece of UE through the determined PHICH resources.

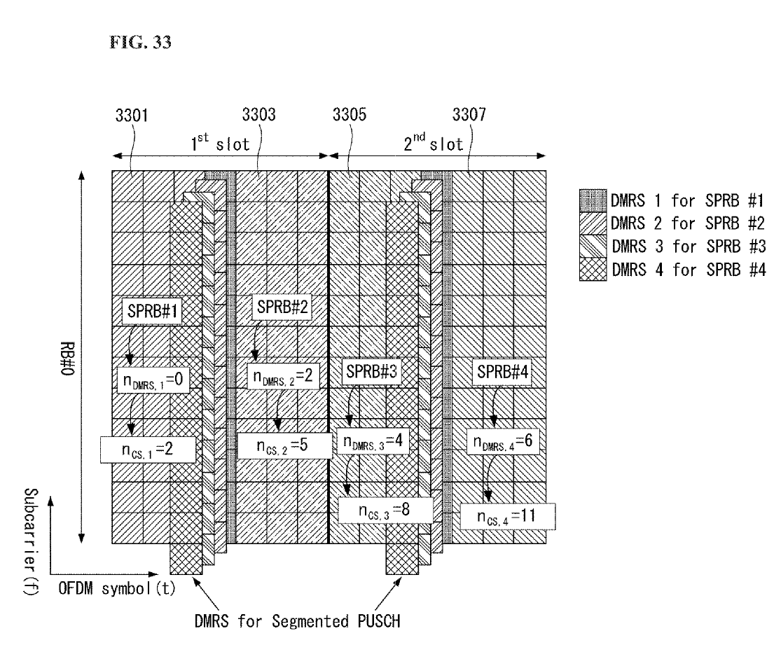

FIG. 33 is a diagram illustrating SPRBs in accordance with an embodiment of the present invention.

FIG. 33 illustrates a case where a pair of CPRBs is segmented into a total of four SPRBs. Referring to FIG. 33, in a first slot, first to third symbols may be defined as an SPRB #1 3301, and fifth to seventh symbols may be defined as an SPRB #2 3303. Furthermore, in a second slot, first to third symbols may be defined as an SPRB #3 3305, and fifth to seventh symbols may be defined as an SPRB #4 3307.

DMRSs for the channel estimation and compensation of the respective SPRBs may be multiplexed for each subframe.

A DMRS 1 for the demodulation of UL data transmitted in the SPRB #1 3301, a DMRS 2 for the demodulation of UL data transmitted in the SPRB #2 3303, a DMRS 3 for the demodulation of UL data transmitted in the SPRB #3 3305, and a DMRS 4 for the demodulation of UL data transmitted in the SPRB #4 3307 may be multiplexed in a symbol placed at the center of each slot in a time axis and transmitted.

If a contention-based PUSCH not having an UL grant is transmitted as described above, the DMRS field n_{DMRS} of a PHICH is set as a value predetermined for each SPRB region. For example, the DMRS field of a PHICH for the SPRB #1 3301 may be previously set to 0, the DMRS field of a PHICH for the SPRB #2 3303 may be previously set to 2, the DMRS field of a PHICH for the SPRB #3 3305 may be previously set to 4, and the DMRS field of a PHICH for the SPRB #4 3307 may be previously set to 6.

The CS value n_{cs,λ} of each DMRS may be previously set differently for each SPRB regardless of the value of a DMRS field. In this case, the CS value of each DMRS may be set with a specific pattern.

For example, the CS value of a DMRS for the SPRB #1 3301 may be set to 2, the CS value of a DMRS for the SPRB #2 3303 may be set to 5, the CS value of a DMRS for the SPRB #3 3305 may be set to 8, and the CS value of a DMRS for the SPRB #4 3307 may be set to 11.

One or more available SPRBs may be previously set in UE (or a UE group formed of one or more pieces of UE) as contention-based radio resources through RRC. In this case, if the UE needs to send UL data of low latency or a low rate, the UE may send the UL data to a BS without UL resource assignment (or an UL grant) using one or more available SPRBs set by RRC.

Furthermore, the UE sends a DMRS for the demodulation of the UL data transmitted through the SPRB to the BS along with the UL data. In this case, a CS value applied to a DMRS may be previously set for each SPRB.

A BS demodulates UL data transmitted in a corresponding SPRB using a channel value estimated through each DMRS. Furthermore, the BS sends ACK/NACK information about whether the decoding of UL data transmitted through each SPRB has been successfully performed to each of pieces of UE through a PHICH.

In this case, as described above, the BS determines the PHICH resources of each SPRB using the DMRS field value of a PHICH predetermined for each SPRB. Furthermore, ACK/NACK information is transmitted to each piece of UE through the determined PHICH resources.

FIGS. 30 to 33 have illustrated the cases where the DMRSs of all the SPRBs are multiplexed in each slot of a pair of CPRBs in which an SPRB is set and transmitted. A scheme for setting a DMRS field for allocating PHICH resources may be identically applied to the embodiments of FIGS. 27 to 29.

Furthermore, in FIGS. 26 to 33, a single stream based on the rank 1 has been illustrated as being transmitted through one uplink for each of pieces of UE, but each of pieces of UE may send a plurality of streams (or layers) in uplink. That is, pieces of UE may send the same information through different SPRBs in spatial multiplexing mode using such a method. Furthermore, pieces of UE may send different pieces of information through different SPRBs in spatial diversity mode.

For example, in the case of the example of FIG. 26, UE may send the DMRS 1 for an antenna port 0 while sending UL data in the SPRB #1 through the antenna port 0, may send the DMRS 2 for an antenna port 1 while sending UL data in the SPRB #2 through the antenna port 1, may send the DMRS 3 for an antenna port 2 while sending UL data in the SPRB #3 through the antenna port 2, and may send the DMRS 4 for an antenna port 3 while sending UL data in the SPRB #4 through the antenna port 3.

Even in this case, in accordance with an embodiment of the present invention, since a DMRS CS value or a DMRS field value is set for each DMRS, orthogonality between DMRSs transmitted through respective antenna ports can be maintained. Furthermore, the PHICH resources of UL data transmitted through each SPRB may be set.

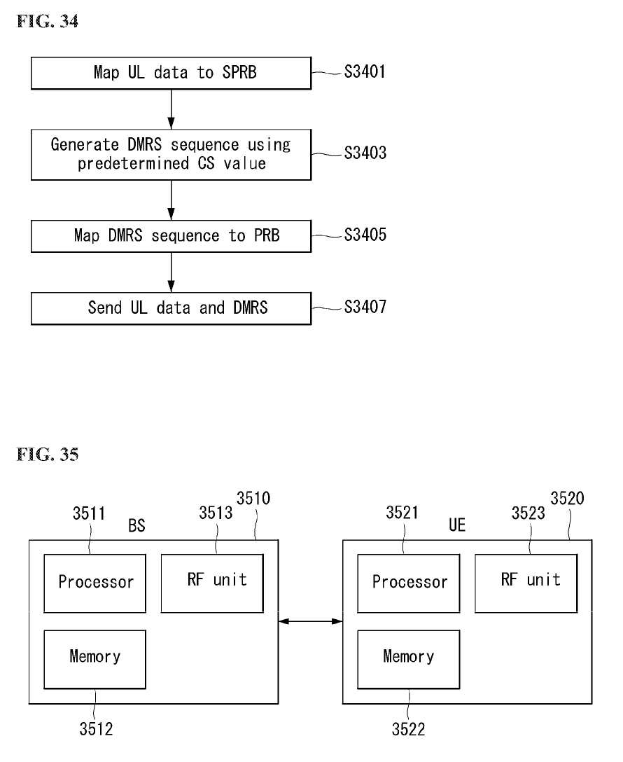

FIG. 34 is a diagram illustrating a method for sending UL data in accordance with an embodiment of the present invention.

Referring to FIG. 34, UE maps UL data to an SPRB at step S3401.

As in the examples of FIGS. 26 to 33, one, two, or four SPRBs may be defined in a pair of PRBs.

If the UE needs to send UL data of low latency or a low rate, the UE map the UL data to one or more available SPRBs configured through an RRC message.

The UE generates a DMRS using a predetermined cyclic shift value at step S3403.

That is, the UE generates the DMRS related to UL data transmitted through an SPRB.

The CS value of the UL data transmitted through the SPRB by the UE may be previously set based on an SPRB index to which the UL data is mapped or may be previously set according to a predetermined pattern. Furthermore, the CS value may be determined because a DMRS field value is previously set based on the SPRB index or previously set according to a predetermined pattern, as in the examples of FIGS. 26 to 33. That is, The CS value of the UL data transmitted through the SPRB is predetermined corresponding to the SPRB.

The UE maps the generated DMRS to a PRB to which the SPRB belongs at step S3405. As in the examples of FIGS. 26 to 33, the DMRS may be mapped to the PRB to which the SPRB belongs. In a subframe configured in the case of a normal CP, a DMRS sequence may be mapped to the fourth symbol of a first slot and/or the fourth symbol of a second slot. Furthermore, in a subframe configured by an extended CP, a DMRS sequence may be mapped to the third symbol of a first slot and/or the third symbol of a second slot.

The UE transmits the UL data and the DMRS to a eNB at step S3407.

That is, the UE sends the UL data, mapped to the SPRB at step S3401, the DMRS, mapped to the PRB to which the SPRB belongs at step S3405, to the eNB.

### Apparatus for Implementing the Present Invention

FIG. 35 is a block diagram of a wireless communication apparatus according to an embodiment of the present invention.

Referring to FIG. 35, a wireless communication system includes an eNB 3510 and a plurality of UEs 3520 belonging to the eNB 3510.

The eNB 3510 includes a processor 3511, a memory 3512, a radio frequency (RF) unit 3513. The processor 3511 may be configured to implement the functions, procedures and/or methods proposed by the present invention as described in FIGS. 1-34. Layers of a wireless interface protocol may be implemented by the processor 3511. The memory 3512 is connected to the processor 3511 and stores various types of information for operating the processor 3511. The RF unit 3513 is connected to the processor 3511, transmits and/or receives an RF signal.

The UE 3520 includes a processor 3521, a memory 3522, and an RF unit 3523. The processor 3521 may be configured to implement the functions, procedures and/or methods proposed by the present invention as described in FIGS. 1-34. Layers of a wireless interface protocol may be implemented by the processor 3521. The memory 3522 is connected to the processor 3511 and stores information related to operations of the processor 3522. The RF unit 3523 is connected to the processor 3511, transmits and/or receives an RF signal.

The memories 3512 and 3522 may be located inside or outside the processors 3511 and 3521 and may be connected to the processors 3511 and 3521 through various well-known means. The eNB 3510 and/or UE 3520 may include a single antenna or multiple antennas. The aforementioned embodiments are achieved by combination of structural elements and features of the present invention in a predetermined manner. Each of the structural elements or features should be considered selectively unless specified separately. Each of the structural elements or features may be carried out without being combined with other structural elements or features. Also, some structural elements and/or features may be combined with one another to constitute the embodiments of the present invention. The order of operations described in the embodiments of the present invention may be changed. Some structural elements or features of one embodiment may be included in another embodiment, or may be replaced with corresponding structural elements or features of another embodiment. Moreover, it will be apparent that some claims referring to specific claims may be combined with another claims referring to the other claims other than the specific claims to constitute the embodiment or add new claims by means of amendment after the application is filed.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

### INDUSTRIAL APPLICABILITY

Although the method for transmitting UL data in the wireless communication system of the present invention is described mainly for the example applied to 3GPP LTE/LTE-A system, it is also possible to be applied to various wireless communication system as well as 3GPP LTE/LTE-A system.

1. A method of transmitting uplink data in a wireless communication system, comprising:
mapping, by user equipment (UE), uplink data to a Segmented Physical Resource Block (SPRB);
mapping, by the UE, a Demodulation Reference Signal (DMRS) related to the SPRB to a Physical Resource Block (PRB) to which the SPRB belongs; and
transmitting, by the UE, the uplink data and the DMRS to a eNB,
wherein the SPRB is defined as a set of resource elements segmented from a pair of the PRBs in a time domain, wherein the DMRS is generated using a cyclic shift value predetermined corresponding to the SPRB.

2. The method of claim 1, wherein the PRB comprises a Contention-based Physical Resource Block (CPRB) in which the UE is able to transmit the uplink data without an uplink grant of the eNB.

3. The method of claim 1, wherein the DMRS is multiplexed in a symbol identical with a symbol of a DMRS related to another SPRB belonging to the pair of PRBs.

4. The method of claim 1, wherein the cyclic shift value is set identically with an index of the SPRB.

5. The method of claim 1, wherein the cyclic shift value is set according to a predetermined pattern.

6. The method of claim 1, wherein:
a DMRS field value of the DMRS is set identically with an index of the SPRB, and
the cyclic shift value is determined based on the DMRS field value.

7. The method of claim 1, wherein:
a DMRS field value of the DMRS is set according to a predetermined pattern, and
the cyclic shift value is determined based on the DMRS field value.

8. The method of claim 1, further comprising receiving, by the UE, acknowledge (ACK) or non-acknowledge (NACK) information about the uplink data from the eNB through a physical HARQ indicator channel (PHICH).

9. The method of claim 8, wherein:
a DMRS field value of the DMRS is set identically with an index of the SPRB, and
the PHICH resource is determined based on the DMRS field value.

10. The method of claim 8, wherein:
a DMRS field value of the DMRS is set according to a predetermined pattern, and
the cyclic shift value is determined based on the DMRS field value.

11. User equipment requesting scheduling for transmitting uplink data in a wireless communication system, comprising:
a Radio Frequency (RF) unit for transmitting and receiving radio signals; and
a processor,
wherein the processor is configured to map uplink data to a Segmented Physical Resource Block (SPRB), map a Demodulation Reference Signal (DMRS) related to the SPRB to a Physical Resource Block (PRB) to which the SPRB belongs, and transmit the uplink data and the DMRS to a eNB,
wherein the SPRB is defined as a set of resource elements segmented from a pair of the PRBs in a time domain, and
wherein the DMRS is generated using a cyclic shift value predetermined corresponding to the SPRB.
